(19) United States
(12) Patent Application Publication
(10) Pub. No.: US 2025/0128304 A1
(43) Pub. Date: Apr. 24, 2025

(54) Systems and Methods for Vitrification Process Control

(71) Applicant: Veolia Nuclear Solutions, Inc., Lafayette, CO (US)

(72) Inventors: Brett E. Campbell, Richland, WA (US); Keith Witwer, Kennewick, WA (US)

(21) Appl. No.: 18/683,209

(22) PCT Filed: Aug. 12, 2022
(86) PCT No.: PCT/US2022/074945

§ 371 Date: Feb. 12, 2024

Related U.S. Application Data
(60) Provisional application No. 63/260,267, filed on Aug. 13, 2021.

(51) Int. Cl. B09B 3/29; B09B 101/35

(52) U.S. Cl. CPC B09B 3/29; B09B 2101/35

(57) ABSTRACT

Disclosed herein are systems and methods for a waste processing system. The system comprises a container preparation area wherein containers are prepared for in-container vitrification processes, a feed area where spent media, recycled waste, and one or more of glass frit, silica sand, or glass formers, are blended to form blended waste. The blended waste is metered into a prepared container from the container preparation area as electricity is applied to electrodes placed in the waste within the container, thereby creating heat sufficient to melt the contents of the container. This results in a container containing vitrified glass product with entrained contaminants. The system includes a container cooling area where the processed container may be cooled, and a container disposition area where the processed container may be surveyed, decontaminated, sealed, shielded, and/or prepared for storage.

### TECHNICAL FIELD

This disclosure relates generally to systems and methods for multistep Vitrification Process Control. More specifically, the disclosure relates to nuclear waste remediation and remediating other forms of non-nuclear waste such as asbestos, and systems and methods related to process automation and maximizing material throughput for waste processing and further preparation for waste storage.

### BACKGROUND

Safeguarding human health and minimizing the environmental impact of waste produced from nuclear power, asbestos decommissioning, or other waste from other toxic industrial processes must be carefully managed in detail. In the case of nuclear waste, this requires isolating or diluting the waste such that the exposure or concentration of any radionuclides is rendered as harmless as possible. To achieve this, radioactive waste is usually enclosed and managed, with some waste requiring deep and permanent burial.

Safe methods for the final disposal of toxic radioactive waste are scientifically proven, and the general international consensus is that disposal deep within the ground is the best option. However, conventional toxic waste storage containers can leak over time, whether stored above ground or below ground.

The process of toxic waste vitrification is known to entrain radionuclides in a glass matrix by using glass formers, electricity, and high heat to melt the waste material, thereby capturing hazardous contaminants in a permanent solid glass configuration with no chance of liquid or sludge leaking out. Generally, the entire vitrification process, from melter preparation to vitrification to preparation of the vitrified product for final storage, can be labor intensive and inefficient for massive-scale operations. What is needed in the art is a specific industrial-scale vitrification technique for systems and methods of process control, automation, and maximizing throughput in the safest and most cost-effective manner for large scale environmental endeavors, such as post-disaster nuclear power plant cleanup, or industrial-scale asbestos remediation. The present disclosure addresses this need.

### GENERAL DESCRIPTION

Vitrification is used to destroy or immobilize hazardous waste by exposure to high temperatures that result in the contaminants being eliminated or entrained within a glass matrix. The present disclosure relates to systems and methods that reduce or eliminate pre-treatment requirements, increase waste load capacity, and reduce maintenance costs as compared to other vitrification or hazardous waste processing and storage methods. Some hazardous waste processing and storage methods are only suitable for a single waste type or classification whereas the present Vitrification Process Control disclosure can be applied to a wider range of hazardous materials. In some embodiments, vitrified glass has a high waste loading capacity and is considered stable.

In some embodiments, a waste processing system, includes any combination of one or more of the following: a sorption vessel process area wherein sorption vessels containing spent media are accessed and the spent media is removed; a container preparation area wherein a container is prepared for in container vitrification processes; a feed area wherein one or more of spent media from the sorption vessel process area, recycled waste from one or more system areas, and one or more of glass frit, silica sand, and glass formers, are blended to form blended waste; a melt area wherein blended waste is metered into a prepared container from the container preparation area as power is applied to two or more electrodes resulting in a processed container containing vitrified glass product with entrained contaminants; a container cooling area wherein the processed container is cooled; a container disposition area wherein the processed container is one or more of surveyed, decontaminated, sealed, shielded, and prepared for storage; a container release area wherein the processed container is prepared for transport to storage; an off-gas treatment system area wherein off-gases from one or more system areas is processed; and a waste water treatment area wherein waste water from one or more system areas is processed.

In some embodiments, the waste processing system includes a control room wherein the control room is operable for one or more of controlling operations in the waste processing system and monitoring operations in the waste processing system. In some embodiments, the waste processing system includes a human machine interface. In some embodiments, the sorption vessel process area includes one or more of vessel access tooling, a dry waste retrieval system, and a wet waste retrieval system.

In some embodiments, the vessel access tooling includes one or more of a shearing tool and a gripper. In some embodiments, the dry waste retrieval system includes a vacuum wand with edges to aid in removal of spent media. In some embodiments, the waste processing system includes one or more sensors. In some embodiments, the one or more sensors include one or more of contact sensors, non-contact sensors, capacitive sensors, inductive sensors, 3D imager, fiber optic cable, camera, thermal imager, thermometer, pressure sensor, accelerometer, inertial measurement unit (IMU), rotary encoder, radiation detector, LIDAR, and strain sensors. In some embodiments, the fiber optic cable is placed in the prepared container with the blended waste and uses Raleigh backscatter to determine at least one of temperatures of a melt, depth of melt activity, or progress of melt activity.

In some embodiments, the container preparation area is operably configured to perform any combination of one or more of: install one or more of a silica sand layer and a refractory base to the container; install refractory side panels to the container; install a starter path in the container; install one or more of two or more electrodes, one or more thermocouples, one or more sensors, and a lid to the container; and stage the container for the melt area.

In some embodiments, a waste processing system includes any combination of one or more of the following: a container preparation area wherein a container is prepared for in container vitrification processes; a feed receipt and blending area wherein one or more of asbestos or recycled waste from one or more system areas, and one or more of glass frit, silica sand, and glass formers, are blended to form blended waste; a melt area wherein blended waste is metered into a prepared container as power is applied to two or more electrodes resulting in a processed container containing vitrified glass product with entrained contaminants; a container cooling area wherein the processed container is cooled, and wherein lid openings are sealed using one or more of a permanent disposal cover or one or more process port covers; a container disposition area wherein the processed container is one or more of surveyed, decontaminated, shielded, and prepared for storage; a container release area wherein the processed container is prepared for transport to storage; an off-gas treatment system area wherein off-gases and secondary wastes from one or more system areas is processed; and a water treatment area wherein water from one or more treatment system areas is processed.

In some embodiments, the blended waste includes asbestos waste and the asbestos waste is at least one of ground, milled, or shredded. In some embodiments, the waste processing system includes one or more remote manipulators for performing operations in the one or more system areas remotely. In some embodiments, the waste processing system includes a control room wherein the control room is operable for one or more of controlling operations in the waste processing system and monitoring operations in the waste processing system. In some embodiments, the waste processing system includes a human machine interface.

In some embodiments, the container preparation area is operably configured to perform any combination of one or more of: install one or more of a silica sand layer or a cast refractory layer, resulting in a refractory lined container; install a starter path in the refractory lined container; install one or more of two or more electrodes, one or more thermocouples, one or more sensors, or a lid to the container; and stage the container for the melt area.

In some embodiments, the waste processing system includes one or more sensors. In some embodiments, the one or more sensors include one or more of contact sensors, non-contact sensors, capacitive sensors, inductive sensors, 3D imager, fiber optic cable, camera, thermal imager, thermometer, pressure sensor, accelerometer, inertial measurement unit (IMU), rotary encoder, radiation detector, LIDAR, or strain sensors. In some embodiments, the camera is an IR camera, and wherein the IR camera includes one or more of heat or radiation shielding. In some embodiments, the fiber optic cable is placed in the prepared container with the blended waste and uses Raleigh backscatter to determine at least one of temperatures of a melt, depth of melt activity, or progress of melt activity.

The general description is provided to give a general introduction to the described subject matter as well as a synopsis of some of the technological improvements and/or advantages it provides. The general description and background are not intended to identify essential aspects of the described subject matter, nor should they be used to constrict or limit the scope of the claims. For example, the scope of the claims should not be limited based on whether the recited subject matter includes any or all aspects noted in the general description and/or addresses any of the issues noted in the background.

### DESCRIPTION OF DRAWINGS

A more complete understanding of the systems, methods, processes, and apparatuses disclosed herein may be derived by referring to the detailed description when considered in connection with the accompanying illustrative figures. In the figures, like-reference numbers refer to like-elements or acts throughout the figures.

FIG. 1 depicts a process functional diagram overview of an embodiment of the inputs and outputs of a Vitrification Process Control (VPC) system and/or method.

FIG. 2 depicts an overview process functional diagram for an exemplary VPC system and/or method.

FIG. 3 depicts a process functional diagram for an embodiment of In-Container Vitrification (ICV™) Container Preparation Area systems and processes.

FIG. 4 depicts a process functional diagram for an embodiment of Sorption Vessel Process Area systems and processes.

FIG. 5 depicts a process functional diagram for an embodiment of Waste Water Treatment Area systems and processes.

FIG. 6 depicts a process functional diagram for an embodiment of Feed Area systems and processes.

FIG. 7 depicts a process functional diagram for an embodiment of ICV Melt Area systems and processes.

FIG. 8 depicts a process functional diagram for an embodiment of ICV Container Cooling Area systems and processes.

FIG. 9 depicts a process functional diagram for an embodiment of ICV Container Disposition Area systems and processes.

FIG. 10 depicts a process functional diagram for an embodiment of ICV Container Release Area systems and processes.

FIG. 11 depicts a process functional diagram for an embodiment of Off-Gas Treatment System (OGTS) Area systems and processes.

FIG. 12 depicts a process flow diagram for an exemplary vitrification process.

FIG. 13 depicts a process flow diagram for an embodiment of an ICV Container Preparation Area.

FIG. 14 depicts a process flow diagram for an embodiment of an ICV Melt/Feed/OGTS Area.

FIG. 15 depicts a process flow diagram for an embodiment of a Waste Water Treatment Area.

FIG. 16 depicts a flow diagram for an embodiment of a Sorption Vessel Process Area.

FIG. 17A depicts a top-down layout of an embodiment of a VPC facility.

FIG. 17B depicts a top-down layout of FIG. 17A embodiment of a VPC facility showing more detail.

FIG. 18 depicts an isometric overview of an embodiment of a VPC system layout.

FIG. 19 depicts an embodiment of an ICV container preparation area.

FIG. 20 depicts an embodiment of an ICV Feed/OGTS/Waste Water Treatment/Melt Area.

FIG. 21A depicts an isometric view of an embodiment of a melt station.

FIG. 21B depicts Melt Area Section C-C of FIG. 20.

FIG. 21C depicts Section D-D of FIG. 21B.

FIG. 21D depicts Section E-E of FIG. 21B.

FIG. 21E depicts Section F-F of FIG. 21B.

FIG. 22A depicts a cross-section of an embodiment of a Sorption Vessel Process Area.

FIG. 22B depicts Section E-E of FIG. 22A.

FIG. 22C depicts Section F-F of FIG. 22A.

FIG. 22D depicts an embodiment of vessel retrieval cross section comprising port plug storage and vessel.

FIG. 22E depicts an embodiment of ISM vessel retrieval cross section comprising an ISM vessel.

FIG. 23 depicts an embodiment of an ICV Container Release Area and Truck-Lock.

FIG. 24 through FIG. 27 depict exemplary process steps in the ICV Container Preparation Area.

FIGS. 28 through 30 depict exemplary process steps for the one or more melt stations.

FIGS. 31 through 34 depict exemplary process steps in the Melt Area.

FIGS. 35 through 37 depict exemplary process steps in the ICV Container Release Area and Truck-Lock.

FIGS. 38 through 44 depict exemplary process steps in the Sorption Vessel Process Area.

FIG. 45 depicts an exemplary process step in the Feed Area.

FIG. 46 depicts an isometric view of the modified ICV with mounted removable shield panels.

FIG. 47 depicts an embodiment of an ICV processing system modified for non-nuclear and other waste types where in the waste is not supplied in sorption vessels.

FIG. 48 depicts a facility view of an ICV processing system modified for non-nuclear and other waste types where in the waste is not supplied in sorption vessels.

FIG. 49 depicts an embodiment of a large-scale in-situ vitrification (ISV™) process.

FIG. 50 depicts an embodiment of subsurface planar vitrification.

FIG. 51 depicts an embodiment of an off-gas treatment system for an in-situ vitrification process.

Elements and acts in the figures are illustrated for simplicity and have not necessarily been rendered according to any particular sequence or embodiment.

### DETAILED DESCRIPTION OF EMBODIMENTS

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways. It should be noted that there are many different and alternative configurations, devices, and technologies to which the disclosed embodiments may be applied. The full scope of the embodiments is not limited to the examples that are described below.

In the following examples of the illustrated embodiments, references are made to the accompanying drawings which form a part hereof, and in which is shown by way of illustration various embodiments in which the systems, methods, processes, and/or apparatuses disclosed herein may be practiced. It is to be understood that other embodiments may be utilized, and that structural and functional changes may be made without departing from the scope of the present invention.

### Overview

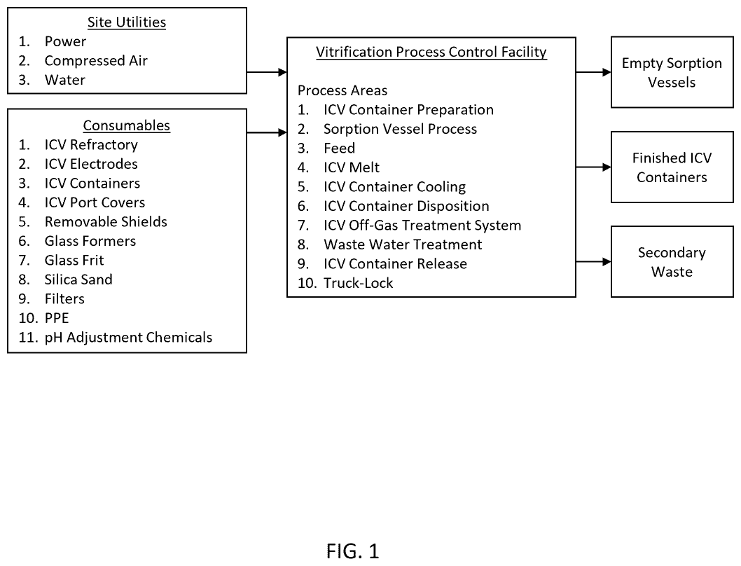

FIG. 1 depicts an overview of an embodiment of the inputs and outputs of an in-container vitrification process. Vitrification processes entail processing retrieved waste to produce a stable glass waste form suitable for permanent disposal. Waste may come in many different forms and be retrieved in many ways. For example, it may be steel drums of waste that get shredded and fed to the melter, or sodium containing shapes, contaminated soil, spent sorption media, processed or unprocessed asbestos waste (wherein the asbestos waste is ground, milled, shredded, or left in original form), plenum tips, liquid raffinate, or a multitude of other waste sources.

Plenum tips are generated during spent fuel chopping operations. The metallic fuel rod is encased in stainless steel cladding and bonded to the cladding with sodium. Headspace above the sodium and fuel, known as the plenum, allows for fission gases to accumulate. The plenum tips contain sodium and potential fission products, in some embodiments.

In some embodiments, the system can be used to process liquid wastes such as liquid raffinate and waste water. In some embodiments, the liquid raffinate may be acidic. In some embodiments, the liquid raffinate may range in pH from pH 1 to 3M nitric acid. In some embodiments, the liquid raffinate may contain surrogate or tracer fission products such as one or more or zirconium (Zr), cesium (Cs), strontium (Sr), etc. In some embodiments, the liquid raffinate may comprise one or more actinide species such as uranium (U), plutonium (Pu), neptunium (Np), and americium (Am). In some embodiments, the liquid raffinate may comprise one or more metal impurities comprising iron (Fe), aluminum (Al), molybdenum (Mo), chromium (Cr), nickel (Ni), and others. In some embodiments, the waste water may comprise waste water from other processes or from the VERSYWET process (described in more detail below). In embodiments wherein liquid waste is processed, the system may further comprise a spill containment system. In some embodiments, the spill containment system may comprise a spill containment basin. The spill containment basin may be located beneath the ICV container during processing, in some embodiments. In some embodiments, liquid captured by the spill containment system may be rerouted through the system, sent to other waste processing systems, stored, or released to the environment (when the liquid meets release standards).

In the embodiment depicted in FIG. 1, a Vitrification Process Control (VPC) Waste Treatment Facility comprises one or more of the following process areas: In-Container Vitrification (ICV™) Container Preparation, Sorption Vessel Processing, Feed, ICV Melting, ICV Container Cooling, ICV Container Disposition, ICV Off-Gas Treatment System (OGTS), Waste Water Treatment, ICV Container Release, and Truck-Lock. The VPC Waste Treatment Facility may use one or more site utilities including power, compressed air, and water. Additional consumables may include one or more of ICV refractory, ICV electrodes, ICV containers, ICV port covers, removable shields, glass formers, glass frit, silica sand, filters, personal protective equipment (PPE), and pH adjustment chemicals. Outputs of the process may comprise one or more of empty sorption vessels, finished ICV containers, and/or secondary waste.

ICV treatment is similar to conventional vitrification methods. It differs in that the entire vitrification process and subsequent storage of the vitrification process product can occur within the same container thus reducing equipment and steps required in final processing. The container used in the vitrification process may be a sealed electric arc furnace, joule heated melter, other type of sealed furnace or melter, three cubic meter box, four cubic meter box, metal drum, copper canisters, industrial drum containers, a custom design, a square shaped box, a rectangular shaped box, a cylinder, or any known in the art container rated for heat levels required for ICV vitrification of materials. In some embodiments, the ICV container is composed at least partially of steel. In some embodiments, the ICV container may be comprised of one or more of steel, lead, concrete, or ceramic. The ICV container(s) may vary in size depending on required throughput and facility size, among other factors. In some embodiments, a container without shielding has outer dimensions of 2.23 m long by 2.23 m wide by 2.59 m high and weighs 30 tonnes. In some embodiments, a fully shielded ICV container has outer dimensions of 2.52 m long by 2.52 m wide by 2.85 m high and weighs 65 tonnes. Other example ICV capacities comprise 4 MT, 10 MT, 30 MT, and 50 MT. In some embodiments, other container sizes and dimensions are possible.

Some embodiments may utilize two electrodes. Any possible container size may utilize differing numbers of electrodes. For example, in an embodiment, the 10 MT container may utilize four electrodes, or it may use two electrodes. In some embodiments, other quantities of electrodes are possible, besides two or four. In some embodiments, electrodes remain within the glass product at the completion of the melt. In some embodiments, the ICV container may be designed for one or more of seismically stable stacking during final storage, compatibility with permanent and/or modular storage shielding configuration, and to accommodate lifting by forklift or overhead crane.

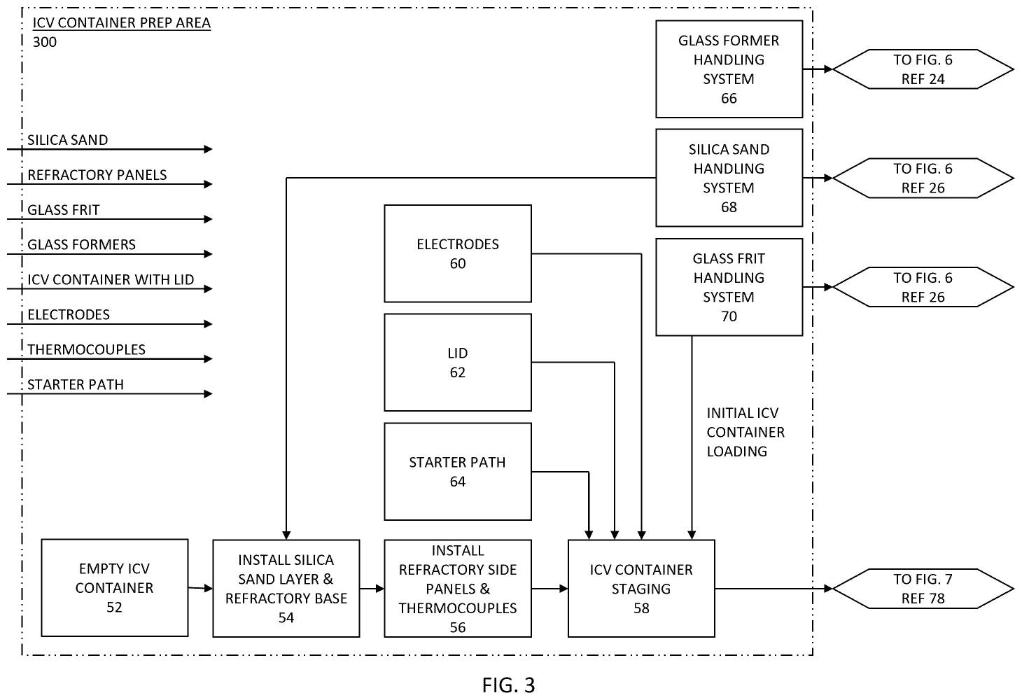

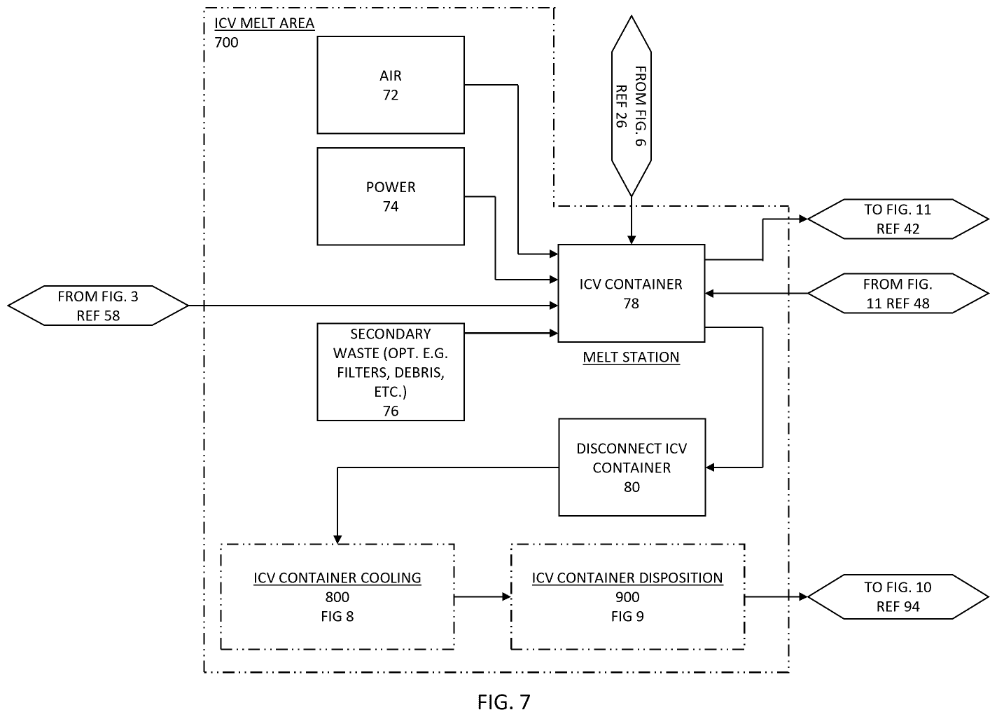

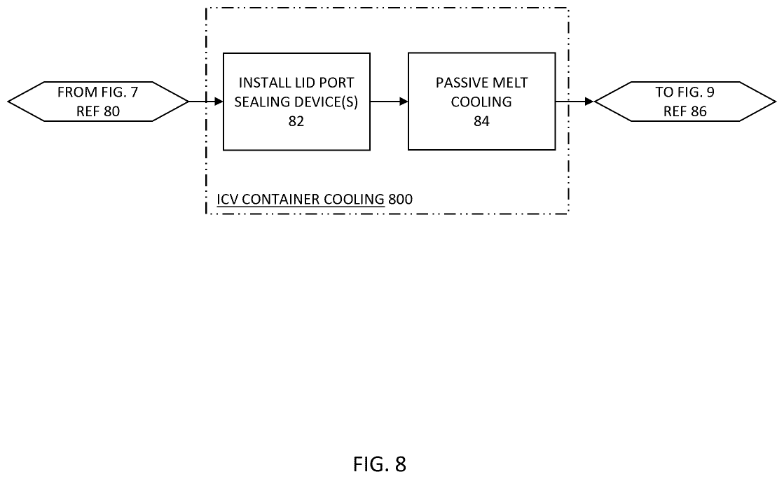

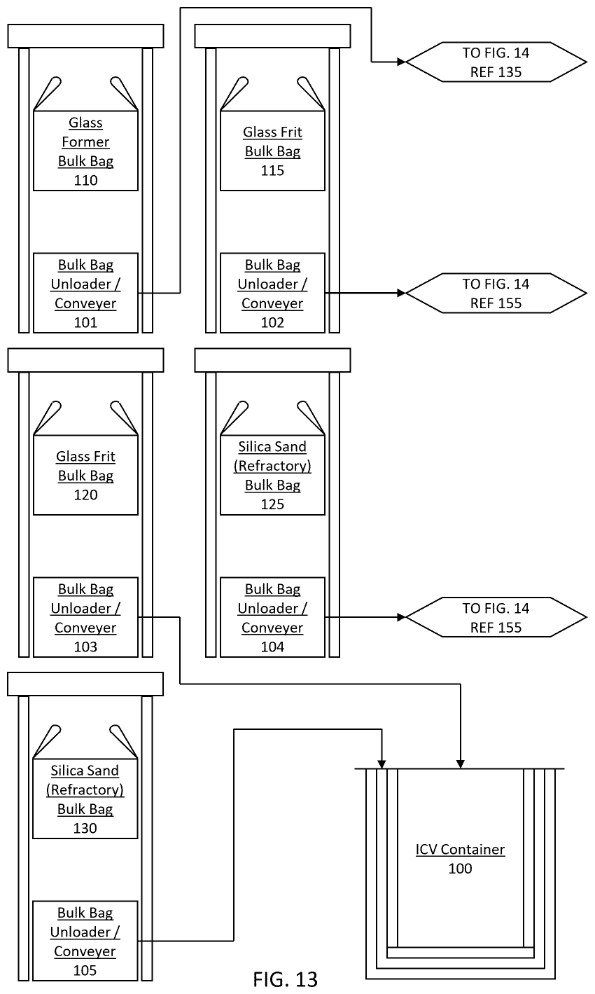

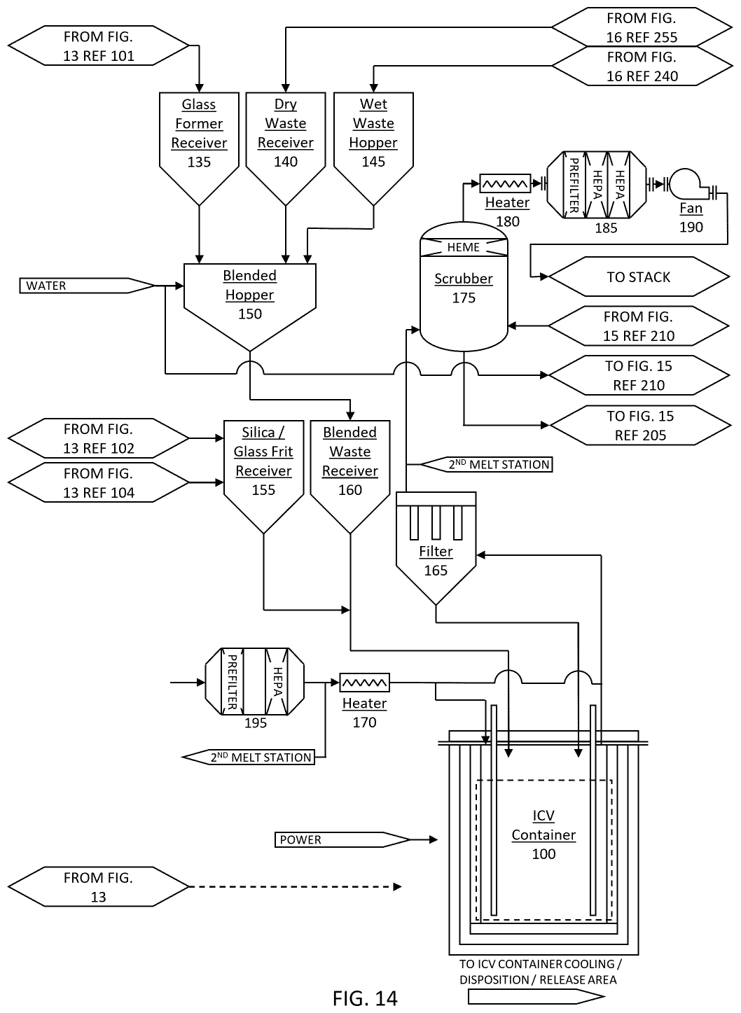

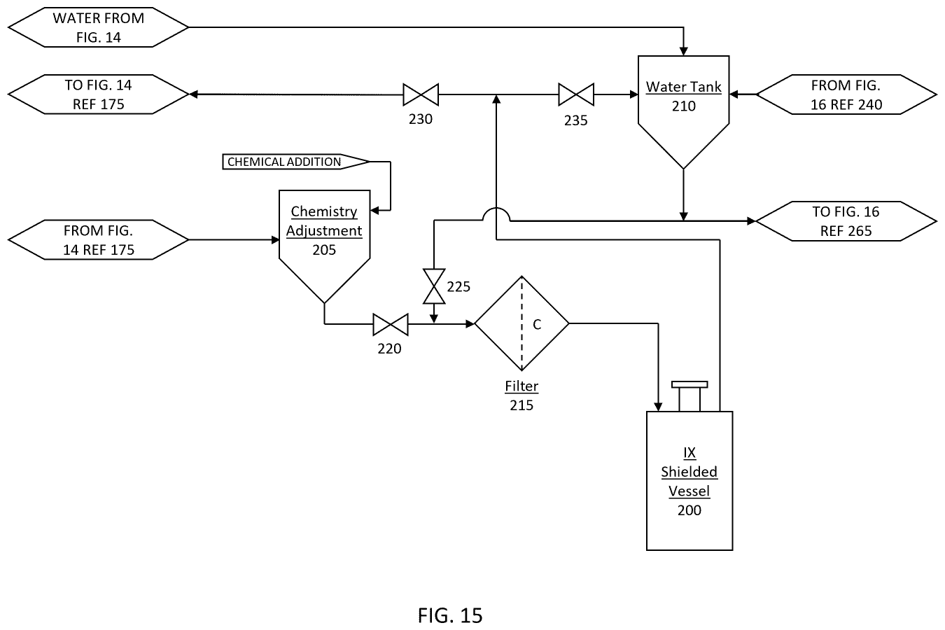

The ICV container is prepared for the vitrification process in the ICV Container Preparation Area 300 (FIGS. 3 and 13). In some embodiments of a bottom-up melt preparation process, silica sand is added to the base of the ICV container first followed by the insertion of a refractory tub. Silica sand and temperature sensors are then added around the perimeter of the refractory tub. A starter path, which enables initial joule heating of the waste material, may then be added inside the refractory tub. Finally, the container lid and two or more electrodes may be installed. The prepared container then proceeds to the ICV Melt Area 700 (FIGS. 7 and 14).

In some embodiments, top-down melting may be used and involves placement of the starter path and frit above the waste mixture that has been loaded within the refractory tub (or sand lined container). Vitrification then proceeds downward until all the staged material, any other waste material added during processing, has been treated.

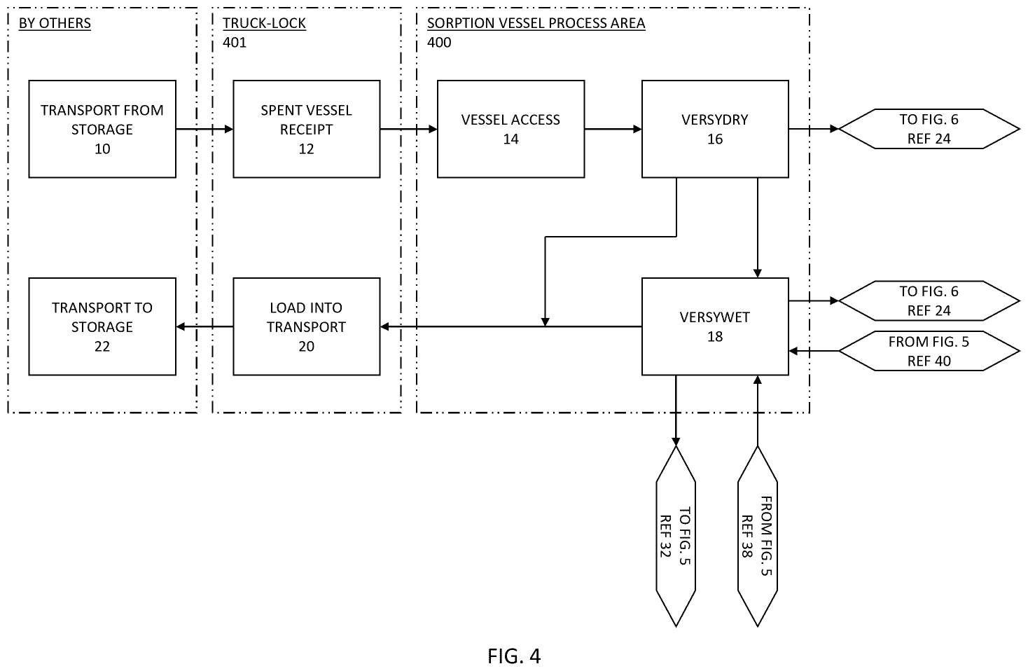

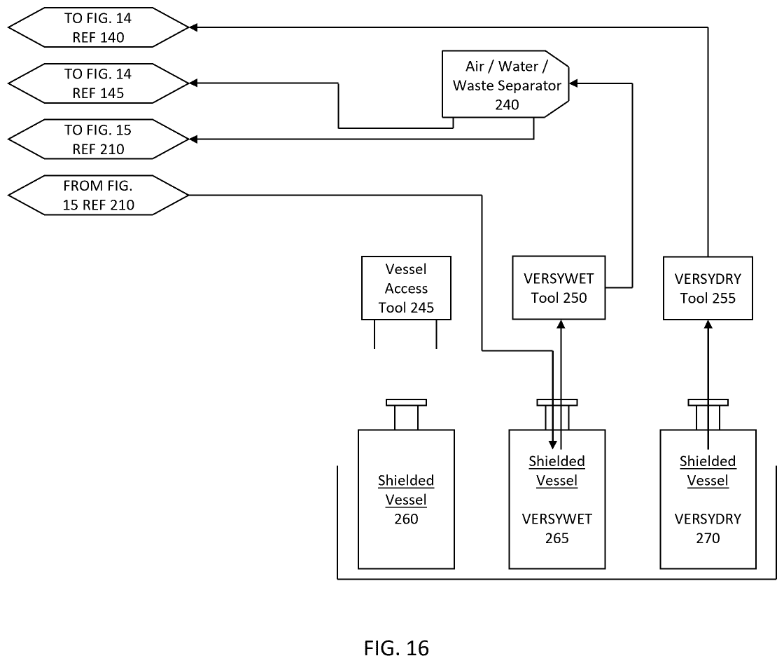

In the Sorption Vessel Process Area 400 (FIGS. 4 and 16), spent vessels (i.e., sorption vessels that contain spent ion exchange media) are accessed and spent media is removed using one or more access and/or retrieval tools and systems. This waste is sent to the feed area where it is conditioned and may be mixed with one or more of glass formers, glass frit, silica sand, and water in preparation for the vitrification process. The prepared waste is transferred to the prepared ICV container in the ICV Melt Area 700 (FIGS. 7 and 14) for vitrification. Wastes may be added incrementally during the melt to compensate for natural densification and volume reduction and thereby ensure the ICV container volume is maximized for efficient disposal, in some embodiments. In some embodiments, toward the end of a melt, additional glass frit may be added to ensure the waste-bearing feed is fully incorporated. In some embodiments, silica sand may be added to the top of the melt if needed to meet minimum disposal volume fill requirements.

In some embodiments, for waste types such as asbestos or other non-nuclear waste, the Waste Water Treatment step and the Sorption Vessel Processing step may be skipped. In these embodiments, the waste may be brought directly in without requiring waste specific pre-processing areas. In some embodiments, rather than using a waste specific pre-processing area, a temporary storage area may be used for the waste prior to processing or waste may be brought in as needed.

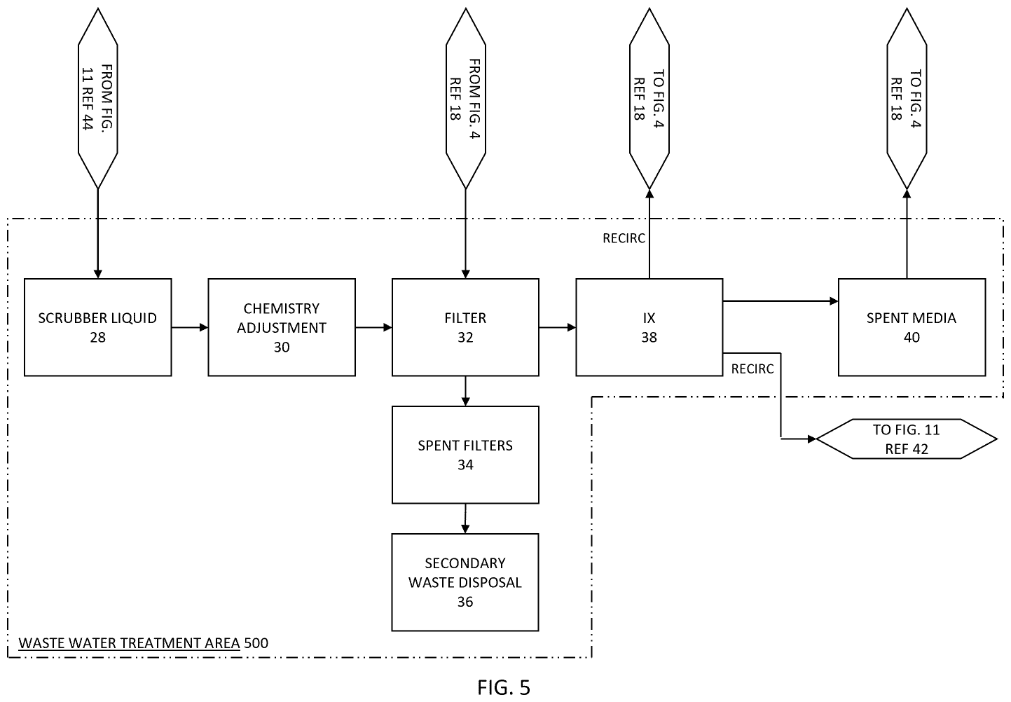

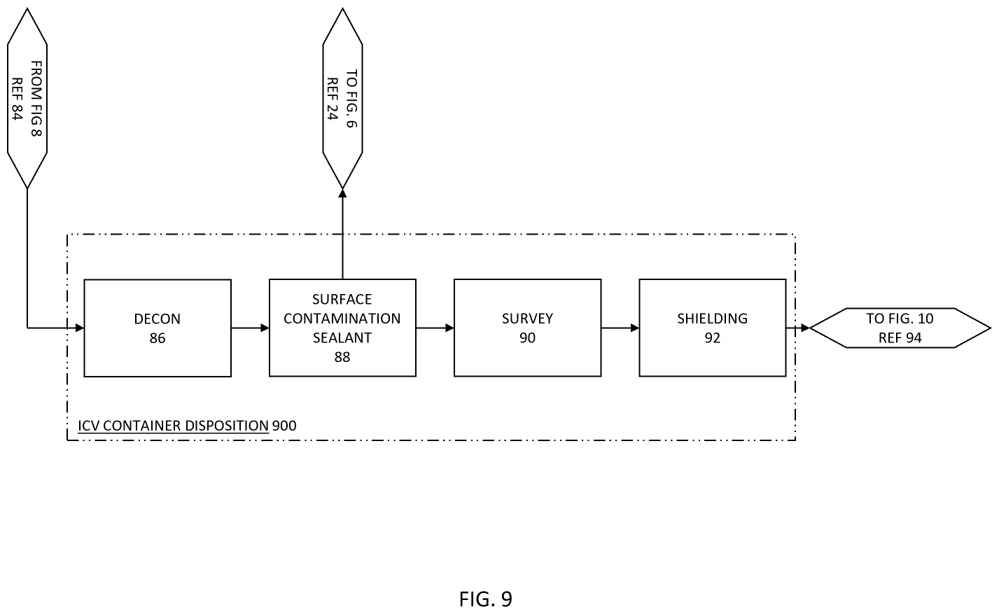

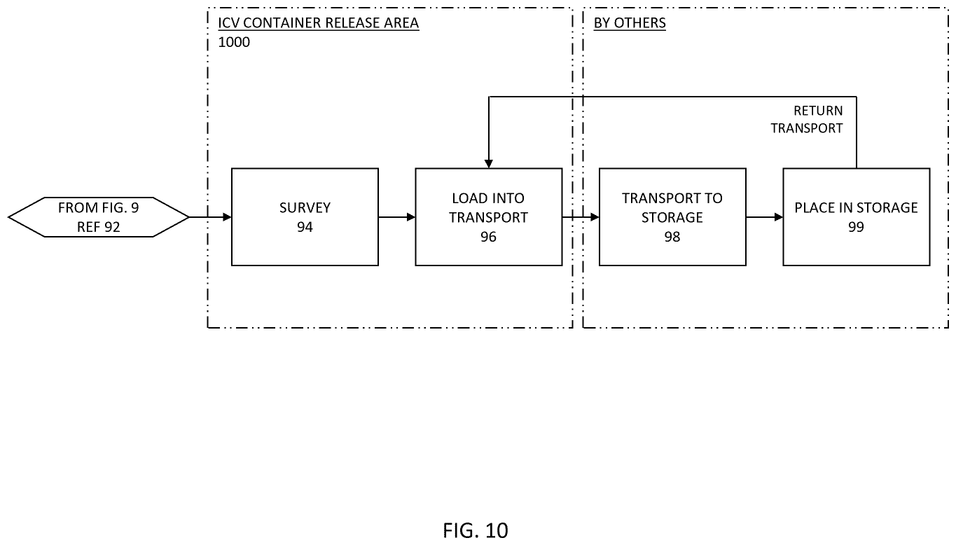

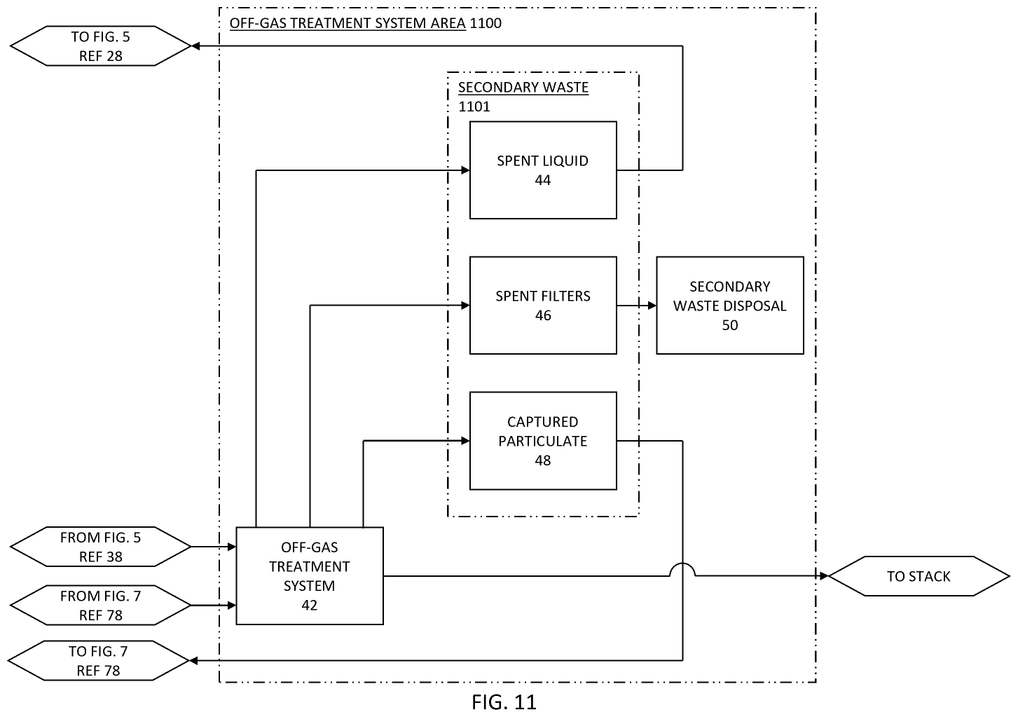

During the vitrification process, hazardous gasses, vapors, and particulates are emitted from the ICV container and, are captured and processed in an Off-Gas Treatment Area 1100 (FIGS. 11 and 14). When the melt is complete the ICV container containing the molten glass proceeds to ICV Container Cooling 800 (FIG. 8) until it is cooled and solidified. After sufficient cooling, it is then transferred to the ICV Container Disposition 900 (FIG. 9) and Release 1000 (FIG. 10) Area for final disposition. Waste water generated by one or more processes or areas, such as the Sorption Vessel Process Area 400 (FIGS. 4 and 16) or off-gas scrubbing system is treated in the Waste Water Treatment Area 500 (FIGS. 5 and 15).

In some embodiments, one or more of the water filters and the ion exchange media used to remove radionuclides may be recycled into subsequent melts, removing the majority of secondary wastes from the process. In some embodiments, the first stage off-gas treatment is a self-cleaning filter that recycles 99.97% of off-gas particulate and semi-volatile radionuclides, such as ¹³⁷Cs, back into the melter for containment within the glass disposal product.

Various embodiments of each of these systems, processes, and areas are depicted and described in more detail in the following sections.

### Process Functional Diagrams

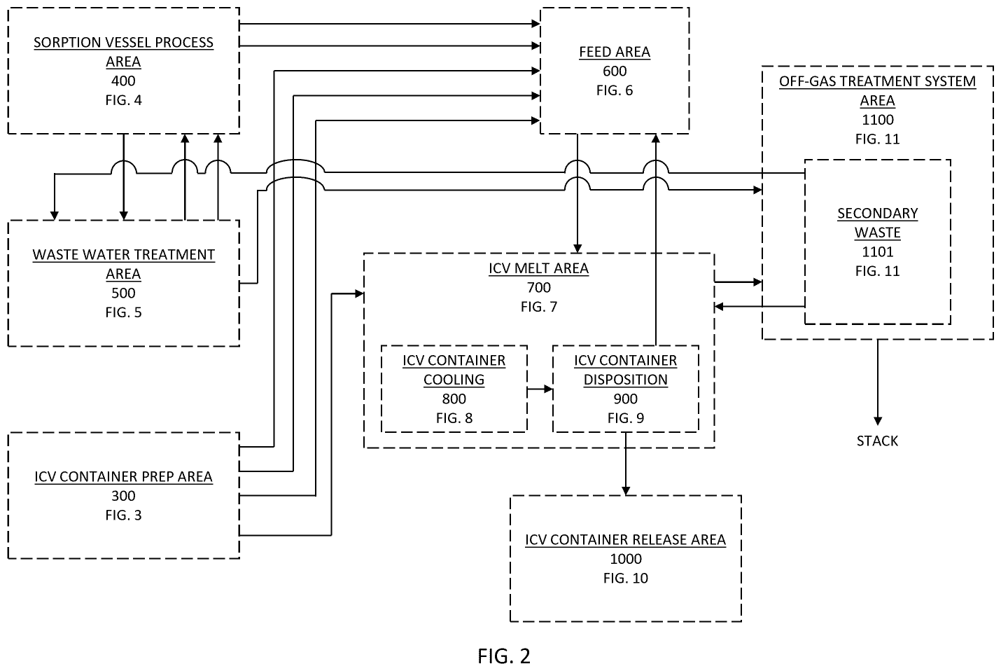

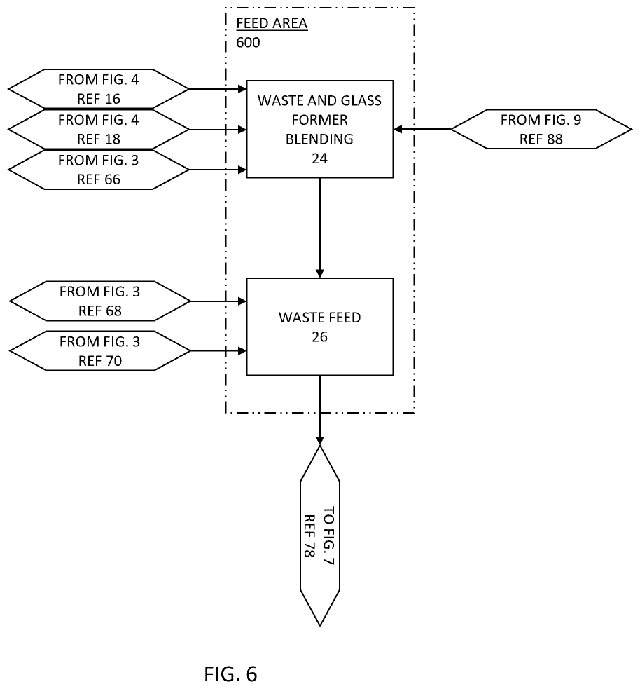

FIG. 2 depicts an overview process functional diagram for an exemplary vitrification process. The depicted embodiment comprises ICV Container Preparation Area 300 (FIG. 3), Sorption Vessel Process Area 400 (FIG. 4), Waste Water Treatment Area 500 (FIG. 5), Feed Area 600 (FIG. 6), ICV Melt Area 700 (FIG. 7), ICV Container Cooling 800 (FIG. 8), ICV Container Disposition 900 (FIG. 9), ICV Container Release Area 1000 (FIG. 10), Off-Gas Treatment System (OGTS) Area 1100 (FIG. 11), and Secondary Waste 1101 (FIG. 11).

FIG. 3 depicts a process functional diagram for an embodiment of ICV Container Preparation Area 300 systems and processes. In the depicted embodiment, the ICV Container Preparation Area 300 has one or more inputs including silica sand, refractory panels, glass frit, glass formers (an oxide blend that can readily form a glass), ICV container with lid, two or more electrodes, one or more thermocouples, and starter path. Bag unloaders/conveyors and/or hoppers (FIGS. 13 and 14) may be used to facilitate input of the various materials such as silica sand, glass frit, and glass formers. The depicted process begins with an empty ICV container 52. A silica sand layer and refractory base are then installed 54 in the ICV container. The silica sand comes from the silica sand handling system 68 which also provides silica sand to the Feed Area 600 (FIG. 6) waste feed 26. Next, refractory side panels and silica sand thermocouples are installed 56 in the ICV container. In the ICV container staging area 58 electrodes 60, lid 62, glass frit from the glass frit handling system 70 and starter path 64 are installed. Following ICV staging 58, the ICV container 78 (FIG. 7) is sent to the Melt Station ICV Melt Area 700 (FIG. 7). The glass frit handling system 70 further sends glass frit to the Feed Area 600 (FIG. 6) waste feed 26. The glass former handling system 66 sends glass formers to the Feed Area 600 (FIG. 6) waste and glass former blending 24. In some embodiments, the use of glass formers (examples, silicon dioxide and aluminum oxide) may be substituted with contaminated soil or other contaminated waste material that inherently contains glass forming oxides.

FIG. 4 depicts a process functional diagram for an embodiment of Sorption Vessel Process Area 400 systems and processes. Generally, the Sorption Vessel Process Area is where sorption vessels containing spent ion exchange media (and otherwise referred to herein as “spent vessels”) are received and accessed. The spent media is removed from the vessels and sent to further processing. The systems and processes in the depicted embodiment begin with transportation of spent vessels from storage 10. The spent ICV vessels are received 12 at the Truck-Lock Area 401 where they are then sent to the Sorption Vessel Process Area 400. The vessels are then accessed 14. First, dry waste is removed in the vessel waste retrieval system dry, or VERSYDRY™, 16. The removed dry waste proceeds to the Feed Area 600 (FIG. 6) waste and glass former blending 24. If waste remains in the spent vessel, the spent vessel is further cleaned using the vessel retrieval system wet, or VERSYWET™, 18. The removed wet waste proceeds to the Feed Area 600 (FIG. 6) waste and glass former blending 24.

Contaminated water proceeds from VERSYWET 18 to the Waste Water Treatment Area 500 (FIG. 5) filter 32 for further processing. Processed water is recirculated from the Waste Water Treatment Area 500 (FIG. 5) ion exchange 38 to VERSYWET 18. Spent ion exchange media 40 containers from the Waste Water Treatment Area 500 (FIG. 5) are sent to VERSYWET 18 for processing. Cleaned sorption vessels proceed from the dry waste 16 and wet waste retrieval 18 systems. Cleaned sorption vessels are prepared for transport 20 in the truck-lock area and then transported for storage 22 or reuse.

FIG. 5 depicts a process functional diagram for an embodiment of Waste Water Treatment Area 500 systems and processes. Secondary waste spent liquid 44 from OGTS 1100 (FIG. 11) augments scrubber liquid 28. The liquid proceeds to chemistry adjustment 30 and then to filter 32. Contaminated water proceeds to filter 32 from the Sorption Vessel Process Area 400 (FIG. 4) VERSYWET 18. Filtered water then proceeds to ion exchange 38. Processed water from ion exchange 38 is recirculated to the Sorption Vessel Process Area 400 (FIG. 4) VERSYWET 18. Water treated during the ion exchange process proceeds to the OGTS Area 1100 (FIG. 11) OGTS 42 for further use. Spent media 40 proceeds to the Sorption Vessel Process Area 400 (FIG. 4) VERSYWET 18 for processing and subsequent vitrification. Spent filters 34 proceed to secondary waste disposal 36, such as direct recycle to the facility vitrification process.

FIG. 6 depicts a process functional diagram for an embodiment of Feed Area systems and processes. Waste and glass former blending 24 receives glass formers from the ICV Container Preparation Area 300 (FIG. 3) glass former handling system 66 (FIG. 3), silica sand from the ICV Container Preparation Area 300 (FIG. 3) silica sand handling system 68 (FIG. 3), dry waste from Sorption Vessel Process Area 400 (FIG. 4) VERSYDRY 16 (FIG. 4), wet waste from Sorption Vessel Process Area 400 (FIG. 4) VERSYWET 18 (FIG. 4), and surface contamination sealant 88 (FIG. 9) from ICV Container Disposition 900 (FIG. 9). Wastes from the waste and glass former blending 24 will proceed to waste feed 26. Waste feed 26 receives silica sand from the silica sand handling system 68 (FIG. 3) and glass frit from the glass frit handling system 70 (FIG. 3) in the ICV Container Preparation Area 300 (FIG. 3). Wastes then proceed to the ICV Melt Area 700 (FIG. 7) ICV container 78 (FIG. 7) for vitrification.

FIG. 7 depicts a process functional diagram for an embodiment of ICV Melt Area systems and processes. The prepared ICV container 78 enters the ICV Melt Area 700 from ICV Container Preparation Area 300 (FIG. 3). Air 72, power 74, secondary waste (optional, e.g., filters, debris, etc.) 76, wastes from Feed Area 600 (FIG. 6) waste feed 26, and captured particulate 48 from secondary waste in OGTS Area 1100 (FIG. 11) feed the ICV container vitrification process. In some embodiments, an average of 2.54 cm (1-inch) per hour of glass production is normal for the VPC system. Other glass production quantity/time ratios are possible. In some embodiments, larger ICV containers may be more efficient than smaller ICV containers due to the higher volume to surface area ratio and lower unit heat loss. This combined with cold cap management, described below, is expected to yield faster processing rates when using a larger ICV container.

Off-gasses from the ICV container 78 proceed to the OGTS Area 1100 (FIG. 11) OGTS 42. When the melt is complete and a period of initial cooling and post-melt off-gas treatment has taken place, the ICV container is remotely disconnected 80 from off-gas, power and instrumentation systems. The ICV container then proceeds to ICV Container Cooling 800 (FIG. 8) then ICV Container Disposition 900 (FIG. 9) and finally to the ICV Container Release Area 1000 (FIG. 10). Some embodiments may comprise two or more parallel ICV Melt Areas. In some embodiments with two or more ICV Melt Areas, only one ICV Melt Area may have an active melt at a time, but operations may be staggered to maximize melt throughput. In some embodiments, operations in this area may be performed remotely including but not limited to plenum camera control, electrode power and feed, temperature monitoring, waste metering and blending, filter backpulsing, and attachment and detachment of process connections. In some embodiments, additional compliant glass or non-compactible non-hazardous fill material (e.g., sand) may be added to the top of the melt to meet minimum fill requirements.

FIG. 8 depicts a process functional diagram for an embodiment of ICV Container Cooling Area 800 systems and processes. The ICV container with the glass product proceeds to the ICV Container Cooling Area 800 after disconnection 80 (FIG. 7). Lid openings are sealed using one or more sealing devices 82 and extended passive container cooling 84 takes place. In some embodiments, the Cooling Area 800 comprises a container sealing area wherein one or more of a permanent disposal cover or one or more process port covers are installed. In some embodiments, port plug sealing may be installed using a remote manipulator. Remote manipulator movement may be automated and/or manual. The remote manipulator may have specific end effector tooling for retrieving the port covers from the delivery rack and installing them onto the ICV container ports, in some embodiments. After such time that the molten glass has solidified and the container has sufficiently cooled to permit safe handling, it then proceeds to decontamination 86 in the ICV Container Disposition Area 900 (FIG. 9). One or more ICV containers may be processed in the ICV Container Cooling Area 800 at one time to accommodate one or more parallel melting stations.

FIG. 9 depicts a process functional diagram for an embodiment of ICV Container Disposition Area 900 systems and processes. The cooled ICV container and melt proceed from passive melt cooling 84 in the ICV Container Cooling Area 800 (FIG. 8) to decontamination 86. In some embodiments, in the decontamination 86 step, the lid of the ICV container is vacuumed or otherwise decontaminated and then remotely sampled for surface contamination. In some embodiments, when a vacuum decontamination system and method is used, the vacuum may share the pneumatic conveyance system of VERSYDRY 255 and 270 (FIG. 16). In some embodiments, decontamination and surface sampling tools may be operated remotely. Surface contamination sealant 88 may be applied and waste from the process proceeds to the Feed Area 600 (FIG. 6) waste feed 26. In some embodiments, surface contamination sealant 88 may be applied using one or more nozzles which may be affixed to a remotely actuated system such as the decontamination tool. Then the sealed ICV container and melt proceed to survey 90 and shielding 92. The survey 90 and shielding 92 steps ensure that the ICV container and melt are properly characterized and contained. In some embodiments, the survey 90 step is performed automatically using a scanner as the ICV container passes through. The survey 90 step may output a dose map and estimate the total activity captured in the melt, in some embodiments. The ICV container then proceeds to the ICV Container Release Area 1000 (FIG. 10).

In some embodiments, the ICV container is sized such that after melt completion, it may fit in its entirety in a large drum such as a 55-gallon drum. In some embodiments, the lid and inlet and exhaust flanges may be integral to the ICV container and disposed of with the ICV container in the drum. In embodiments wherein liquid waste is processed, the system may further comprise a spill containment system. In some embodiments, the spill containment system may comprise a spill containment basin. The spill containment basin may be located beneath the ICV container during processing, in some embodiments. In some embodiments, liquid captured by the spill containment system may be rerouted through the system, sent to other waste processing systems, stored, or released to the environment (when the liquid meets release standards).

FIG. 10 depicts a process functional diagram for an embodiment of ICV Container Release Area 1000 systems and processes. From the ICV Container Disposition Area 900 (FIG. 9), the container may again be surveyed after shield panels have been installed and swipe sampled for surface contamination prior to export from the treatment facility 94. Surface dose and other factors may be checked during the survey 94 process. The completed melt and container are then loaded onto transport 96 and transported 98 and placed 99 in storage. In some embodiments, the transport means is also surveyed 94. Both the ICV container and the transport means may be subject to decontamination processes if surface contamination is above limits. In some embodiments, the transport vehicle will return to transport the next ICV container. The transport vehicle may also return with shield panels that were removed at the storage facility, which can then be reused for shielding and transport of the next ICV container 96. Transportation means may also be surveyed and decontaminated as needed.

FIG. 11 depicts a process functional diagram for an embodiment of Off-Gas Treatment System (OGTS) Area 1100 systems and processes. The OGTS 42 receives recycled scrubber liquid from the ion exchange process 38 in the Waste Water Treatment Area 500 (FIG. 5) and off gasses from the ICV container 78 in the ICV Melt Area (FIG. 7). Captured particulate 48, spent filters 46, and spent liquid 44 proceed from the OGTS 42 to secondary waste processing. Processed gases, containing no contaminants above release limits, may be vented to the environment through the discharge stack. Captured particulate 48 within the first stage particulate filter may be back-pulsed and gravity discharged to the ICV container 78 in the ICV Melt Area 700 (FIG. 7) to be incorporated with the waste in the glass product. Spent filters 46 may stored and placed into a subsequent ICV container for processing, eliminating this secondary waste stream 50. Spent liquid 44 may proceed to the Waste Water Treatment Area 500 (FIG. 5) ion exchange 38 step for processing, and the ion exchange media may sent for subsequent vitrification at the end of its useful life, eliminating this secondary waste stream.

The Off-Gas Treatment System (OGTS) 1100 filters, scrubs, tempers, and monitors the process off-gases prior to release to the environment. Typical constituents of concern (COCs) for removal from the off-gas to meet environmental requirements may include one or more of volatile iodine (I-131), semi-volatile cesium-134 (Cs-134), cesium-137 (Cs-137), technetium (Tc-99), and much less volatile strontium-90 (Sr-90), in some embodiments.

In some embodiments, off-gas treatment begins above the ICV container with a sintered metal filter (SMF) where the majority of off-gas particulate (99.97%) may be removed, and cool air may be blended with relatively low flow hot off-gas exhaust for further downstream processes. In some, embodiments, the SMF contains an array of filter candles that may be independently backpulsed upon high differential pressure. When only a few of the filter candles are backpulsed simultaneously, the filter can remain online during cleaning cycles. In some embodiment, the SMF may also designed with water spray nozzles to remove residual material from filter candles and internal housing that is not completely removed by backpulsing. In some embodiments, the backpulsed particulate and cleaning water can then be recycled directly downward onto the feed pile within the ICV container below. In some embodiments, each melt station has its own SMF. In some embodiments, particulates from the one or more filters may be captured and recycled to the ICV container to be incorporated into the melt. In some embodiments, particulates from the one or more filters may be recycled to waste feed and/or blend hoppers to be combined with the waste for processing.

After passing through the SMF(s), off-gas combines and enters a wet scrubber (e.g., packed bed scrubber) where minor organics and other dissolved solids may be captured and treated, in some embodiments. After leaving the wet scrubber, the off-gas may be heated using an inline heater to prevent condensation, prior to entering a final HEPA filter treatment stage. In some embodiments, the final HEPA filter step removes 99.97% of any remaining particulate before entering the OGTS Fan and exiting via the off-gas stack to atmosphere. In some embodiments, beginning with HEPA inlet filters located upstream of the ICV plenum, the OGTS Fan maintains negative pressure within the ICV container and throughout the OGTS all the way to the fan inlet, where the air has been fully treated. This induced-draft ventilation design eliminates the possibility of contamination spread from any potential leak path in the system.

### Process Flow Diagrams

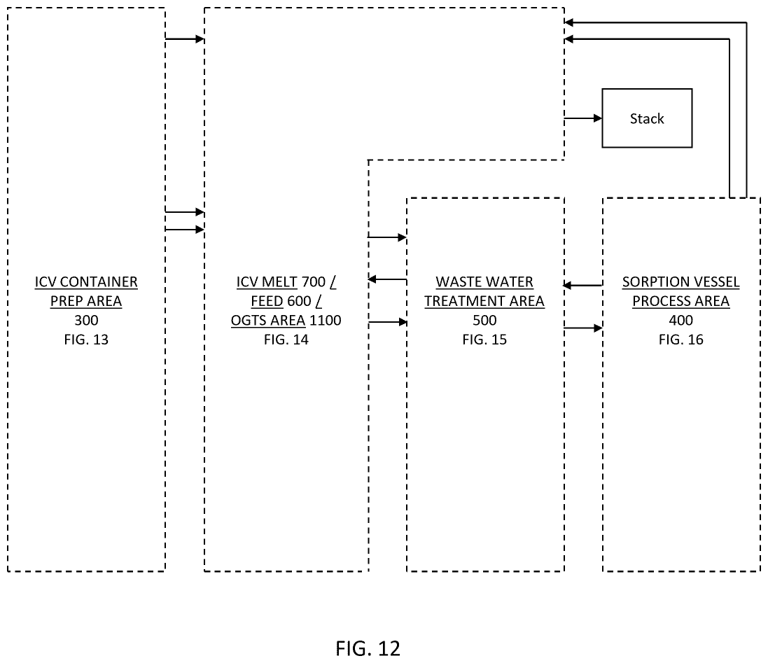

FIG. 12 depicts a process flow diagram for an exemplary vitrification process.

Glass formers, silica sand, and glass frit proceed from the ICV Container Preparation Area 300 (FIG. 13) to the ICV Melt 700/Feed 600/OGTS Area 1100 (FIG. 14). Water proceeds from the ICV Melt 700/Feed 600/OGTS Area 1100 (FIG. 14) to the Waste Water Treatment Area 500 (FIG. 15). Water is exchanged between the Sorption Vessel Process Area 400 (FIG. 16) and the Waste Water Treatment Area 500 (FIG. 15). Wastes from the Sorption Vessel Process Area 400 (FIG. 16) proceed to the ICV Melt 700/Feed 600/OGTS Area 1100 (FIG. 14). Gases that are cleared of contaminants or contain contaminants below release requirements may be vented to the environment from the ICV Melt 700/Feed 600/OGTS Area 1100 (FIG. 14) to the stack.

FIG. 13 depicts a process flow diagram for an embodiment of an ICV Container Preparation Area. In some embodiments, the ICV Container Preparation Area is physically isolated from the rest of the facility so that no radioactive dose or contamination is present or likely to occur in this area. Glass formers from the glass former bulk bag 110 is distributed through bulk bag unloader/conveyer 101 to the ICV Melt 700/Feed 600/OGTS Area 1100 (FIG. 14) glass former receiver 135. Glass frit from the glass frit bulk bag 115 is distributed through bulk bag unloader/conveyer 102 to the ICV Melt 700/Feed 600/OGTS Area 1100 (FIG. 14) silica/glass frit receiver 155. Silica sand (refractory) from the silica sand (refractory) bulk bag 125 is distributed through bulk bag unloader/conveyer 104 to the ICV Melt 700/Feed 600/OGTS Area 1100 (FIG. 14) silica/glass frit receiver 155. Glass frit from the glass frit bulk bag 120 is distributed through the bulk bag unloader/conveyer 103 to the ICV container 100. Silica sand (refractory) from the silica sand (refractory) bulk bag 130 is distributed through bulk bag unloader/conveyer 105 to the ICV container 100 lining. In some embodiments, an ICV container may be assembled while a second ICV container that is ready to be moved directly to the melter station is staged.

FIG. 14 depicts a process flow diagram for an embodiment of an ICV Melt 700/Feed 600/OGTS Area 1100. Glass formers from bulk bag unloader/conveyor 101 (FIG. 13) are loaded into glass former receiver 135, dry waste from VERSYDRY tool 255 (FIG. 16) is loaded into dry waste receiver 140, and wet waste from air/water/waste separator 240 (FIG. 16) is loaded into wet waste hopper 145. From receiver/hoppers 135, 140, and 145, glass formers, dry waste, and wet waste are blended in blended waste hopper 150. Water may additionally be supplied to water tank 210 (FIG. 15). In some embodiments, water may be added to increase moisture content of the blended constituents to 20±10 wt % water. Blended waste exits the blended waste hopper 150 and enters the blended waste receiver 160. Silica and glass frit from bulk bag unloader/conveyors 102 (FIG. 13) and 104 (FIG. 13) enters silica/glass frit receiver 155 and then joins the blended waste exiting blended waste receiver 160 on its way into the central area of the ICV container 100. In some embodiments, the blended waste feed may be metered at a rate as required by the melt operations. In some embodiments, metering may be accomplished using a rotary gate valve system. In some embodiments, the feed system is remotely operated and/or monitored. In some embodiments, constituents may be weighed at one or more points in the process.

In some embodiments, water removal and addition systems may be included to further condition the waste prior to feeding into the ICV container 100, in some embodiments. Any moisture content may be accommodated by the process, and waste handling equipment will be specified according to the waste type and moisture content.

Air enters through one or more particulate filters 195. In the depicted embodiment the air enters through a prefilter and a HEPA filter. Cool air exits the filter(s) 195 and, in some embodiments, some of the air proceeds to the second melt station and some air proceeds to heater 170. When some of the air is diverted to the second melt station it may be used for cooling. In some embodiments, all of the air exiting filter(s) 195 proceeds to heater 170. The heated air may be used as air sweep in the ICV container 100 and a portion of the air may join off-gases from the ICV container 100 and proceed to filter 165. In some embodiments, filter 165 may be a sintered metal filter (SMF). In some embodiments, dust from the SMF may be recycled directly into the ICV container. Air used in the second melt station, in embodiments where a second melt station is implemented, may rejoin off-gases exiting filter 165 on the way to the scrubber 175.

Scrubber 175 receives water from water tank 210 (FIG. 15). The scrubber serves to remove contaminants, such as minor organics and other dissolved solids in some embodiments, from the off gases released in the ICV container 100 during melting. Contaminated water exiting the scrubber 175 proceeds to chemistry adjustment 205 (FIG. 15). In some embodiments, scrubbed gases may optionally proceed through a condenser, such as a High Efficiency Mist Eliminator (HEME) in the depicted embodiment, in the scrubber 175 before proceeding to heater 180. The heater 180 is used to prevent condensation of the gases prior to final filtration, in some embodiments. After being heated with the heater 180, the scrubbed gases proceed through one or more filters 185. In the depicted embodiment, the one or more filters 185 comprise a prefilter and two HEPA filters. After being filtered by the one or more filters 185, the cleaned gases proceed through fan 190 and then to the stack for release if they meet emission standards. In some embodiments, secondary wastes from the OGTS system are recycled to the ICV container to the maximum extent possible.

FIG. 15 depicts a process flow diagram for an embodiment of a Waste Water Treatment Area 500. Water containing contaminants from the off-gas scrubber 175 (FIG. 14) proceeds to chemistry adjustment where one or more chemicals may be added to adjust the chemistry. From there, it proceeds through valve 220 and may be joined by additional water from water tank 210 through valve 225. The chemically adjusted scrubber water may then proceed through filter 215 to the ion exchange (IX) shielded vessel 200 where contaminants are removed and retained within ion exchange media in the vessel 200. Clean water may proceed through valve 235 into water tank 210. Water from FIG. 14 and air/water/waste separator 240 (FIG. 16) supplement water in water tank 210. Water from water tank 210 may proceed to VERSYWET 265 (FIG. 16).

FIG. 16 depicts a flow diagram for an embodiment of a Sorption Vessel Process Area 400. In this area spent sorption vessels 200 may be cleaned using wet and/or dry waste removal systems. One or more of the tools in this area may be remotely operated. One or more operations in this area may be remotely monitored. A vessel access tool 245 may be used to remove covers, lids, flanges, and/or ancillary features to provide access to the spent vessels. Additional vessel access tools 245 may comprise one or more of a port plug placing tool to seal vessel ports after media removal, a shear tool to cut tubing interferences from the vessel for waste access, and a gripper tool for removing cut tubing. Should the process be interrupted, sorption vessels may be temporarily closed to reduce potential spread of contamination and dose rate. It should be clear that other tools may be utilized and that each of the disclosed tools may be operable to perform functions other than the examples provided.

The content of spent sorption vessels 200 may optionally be dewatered, dried, and/or characterized prior to processing in the Sorption Vessel Process Area 400. The condition of the waste within spent sorption vessels may vary. Typically, dry waste removal will be implemented first and, if any waste remains that cannot be removed using dry removal tools and methods, the wet waste removal system may be implemented. The purpose of this is to reduce or minimize secondary waste water generation. For VERSYDRY 270 dry waste is removed using VERSYDRY tool 255 (a suction wand, for example) and the waste is routed through dry waste receiver 140 (FIG. 14). The waste may be routed using a pneumatic conveyance system which may also provide the motive vacuum force for the VERSYDRY tool 255, in some embodiments. Dust and contaminant control may be implemented in and around these processes. Water from water tank 210 (FIG. 15) may proceed into VERSYWET 265 for sluicing in the shielded vessel. A VERSYWET tool 250 may be used to remove waste where it may then proceed to air/water/waste separator 240. From air/water/waste separator 240, waste may proceed to wet waste hopper 145 (FIG. 14) and water may proceed to water tank 210 (FIG. 15). In some embodiments, the waste may be conveyed using a conveyor such as a chain drag conveyer. Some embodiments may further comprise a lead shot removal wand for the removal of lead shot from the vessel. In some embodiments, waste retrieved through the wet waste removal process may proceed through a dewatering step prior to being transferred to downstream processes. In some embodiments, dewatering may occur to 20±10 wt % water content.

In some embodiments, the dry and/or wet waste removal systems may be operated remotely. Such embodiments may comprise one or more remotely operated tools, imaging systems to guide retrieval, and one or more sensors.

In some embodiments, the removal tools used in wet and dry removal may be hollow rigid tubes with radiation tolerant lighted remote imaging systems to aid in positioning. In some embodiments, the dry waste removal tool may comprise one or more of end features to enable dislodging of waste through direct contact and a confinement barrier for dust control. In some embodiments, the wet waste removal tool may comprise one or more of end features with sluice nozzles to enable dislodging of waste that can be reached by the spray and a confinement barrier for water droplet control.

### Facilities

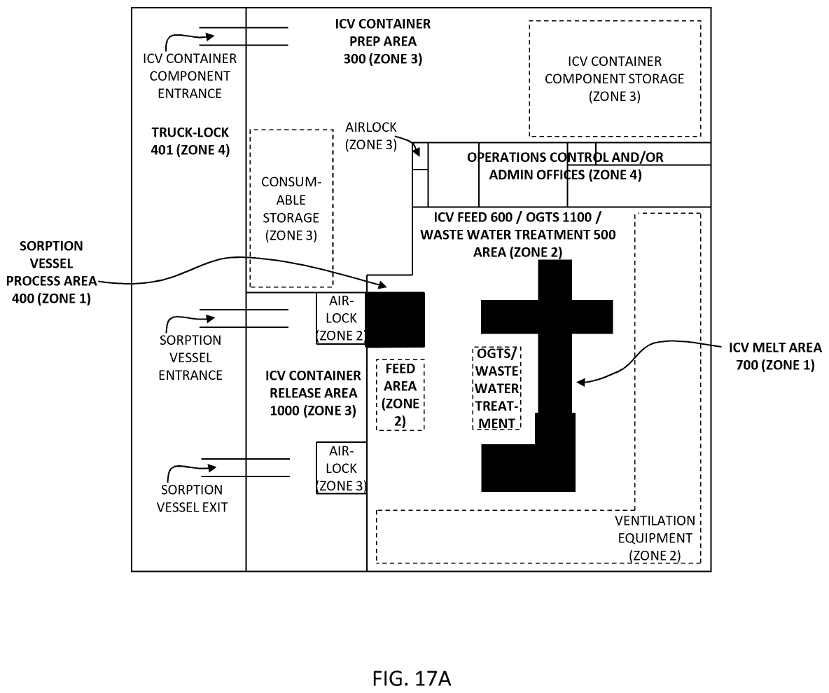

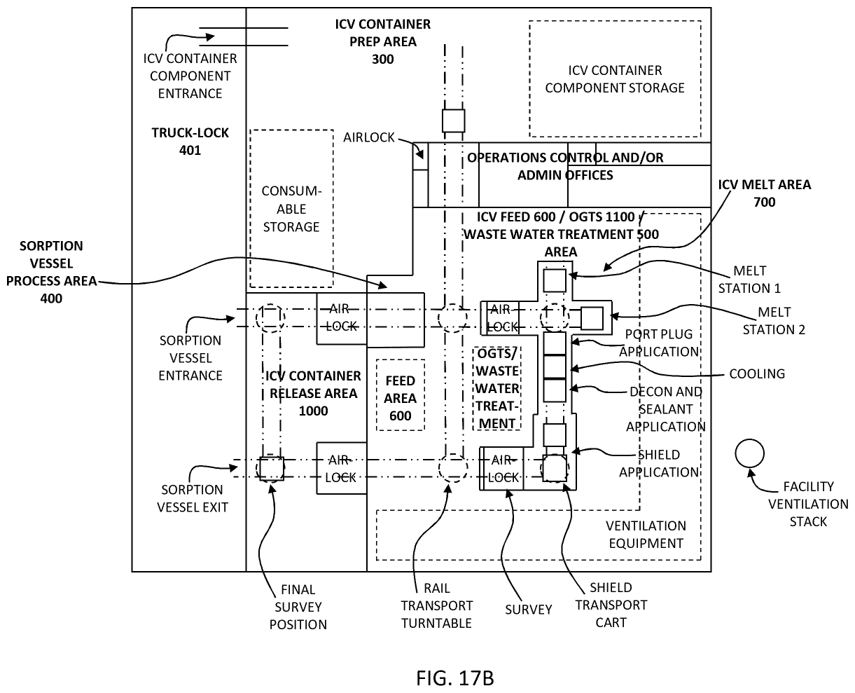

FIG. 17A depicts a top-down layout of an embodiment of a VPC processing facility. The depicted embodiment is just one example configuration and is not intended to be limiting. In the depicted embodiment, each area in the facility is zoned based on the expected radiation levels. The zones are:
Zone 1, Contamination Potential: High, Radiation Level: High
Zone 2, Contamination Potential: Medium, Radiation Level: Potentially Elevated Locations
Zone 3, Contamination Potential: Low, Radiation Level: Low or Background
Zone 4, Contamination Potential: Clean, Radiation Level: Low or Background

Areas where waste is being processed, such as the Sorption Vessel Process Area 400 and the ICV Melt Area 700 are Zone 1. Zone 1 areas are monitored for radiation and contamination, and there is a high potential for both since blended waste is handled in these areas. All activities in these areas may be performed remotely, controlled by automatic sequences, or from a Facility Control Room using a closed-circuit video system, in some embodiments. Other control embodiments are possible. Areas around the processing areas where waste water and off-gases are treated and materials are fed like the ICV Feed 600/OGTS 1100/Waste Water Treatment 500 Area are Zone 2. In Zone 2 there is lower risk than in Zone 1. Zone 2 also includes an airlock and ventilation equipment in the depicted embodiment. Zone 2 areas are designated Zone 2 because shielded and contained waste traverses, but is not directly handled, in those areas. The ICV Container Preparation Area 300 and the ICV Container Release Area 1000 are in Zone 3. Zone 3 designates that the area may be monitored for radiation and contamination, but there is low potential for contamination or radioactive dose since little or no handling of radioactive materials occurs. Zone 3 also includes ICV Container Component Storage, one or more airlocks, and Consumable Storage. Zone 4 is the lowest radiation risk and includes areas like Truck-Lock 401 and Operations Control and/or Administrative Offices. In some embodiments the Operations Control and/or the Administrative Office areas are on the second floor. It is advantageous to position the Operations Control Area at a higher elevation so that the processing area is easier to view and monitor.

FIG. 17B depicts a top-down layout of the FIG. 17A embodiment of a VPC processing facility showing more detail. ICV Containers and their components enter through the Truck-Lock Area 401 into the ICV Container Prep Area 300. Within this area is ICV Container Component Storage and Consumable Storage, in the depicted embodiment. Consumables such as pre-made refractory tubs, silica sand, glass frit, graphite flake, thermocouples, etc. are stored and used for preparation of the ICV container. Sorption vessels enter through the Sorption Vessel Entrance through an Airlock into the Sorption Vessel Process Area 400. In some embodiments, all activities in this area may be completed remotely, controlled by automatic sequences, or from a Facility Control Room using a closed-circuit video system. Other control embodiments are possible.

Prepared ICV containers enter the ICV Feed 600/OGTS 1100 Waste Water Treatment 500 Area. In the ICV Melt Area 700 there are two melt areas, in some embodiments: Melt Station 1 and Melt Station 2. The prepared and filled ICV container will first move through an airlock then into one of the Melt Stations. Waste materials retrieved from sorption vessels in the Sorption Vessel Process Area 400 are fed into one of the prepared containers at one of the Melt Stations, where the contents will be vitrified. In some embodiments, the ICV container remains at the melt station for a predetermined period after power is terminated to ensure residual off-gas is fully treated and to allow active off-gas-treated cooling. The predetermined period may vary based on various factors including the size and geometry of the container. In some embodiments, the predetermined period may be 24 hours. Process connections (feed, off-gas, instrumentation, etc.) may then be remotely disconnected.

The ICV container will then proceed to Port Plug Application where the process openings may be sealed with tight fitting plugs, Cooling, Decontamination and Sealant Application, and Shield Application. In the Decontamination and Sealant Application step, loose contamination may be removed with a vacuum wand, or other appropriate tool, and a contamination sealing fixative spray may be applied, in some embodiments. In some embodiments, the ICV container then moves into the survey step without being shielded. In some embodiments, shields are brought to the Shield Application area via a Shield Transport Cart. Shields may be applied, in some embodiments, to reduce external dose to an acceptable level. An acceptable surface dose may be predetermined based on a number of factors including regulatory requirements, storage requirements, and dosage requirements, among others.

In some embodiments, the shields may be removable shield panels. Alternately, steel encased lead shield panels, which are approximately half the thickness of the steel panels, can be used to provide the same protection. The shield panels may be installed prior to leaving the Treatment Facility and remain installed until reaching the final storage location. The panels can be removed at the storage facility and returned to the VPC Facility for reuse, in some embodiments. In some embodiments, the shield panels may continue to be in use at the final storage location.

Once the ICV container is cooled and shielded it can proceed to an airlock where it is surveyed, then moved to rail transport turntable, and through another airlock to the ICV Container Release Area 1000. In the ICV Container Release Area 1000 the container is surveyed in the Final Survey Position before being released. Ventilation Equipment is used to safely ventilate processing areas. In some embodiments, Operations Control and/or Administrative Offices may be located near the processing area in a separate Zone. In some embodiments, Operations Control and/or Administrative Offices may be located on a second floor or at a higher elevation relative to the processing area.

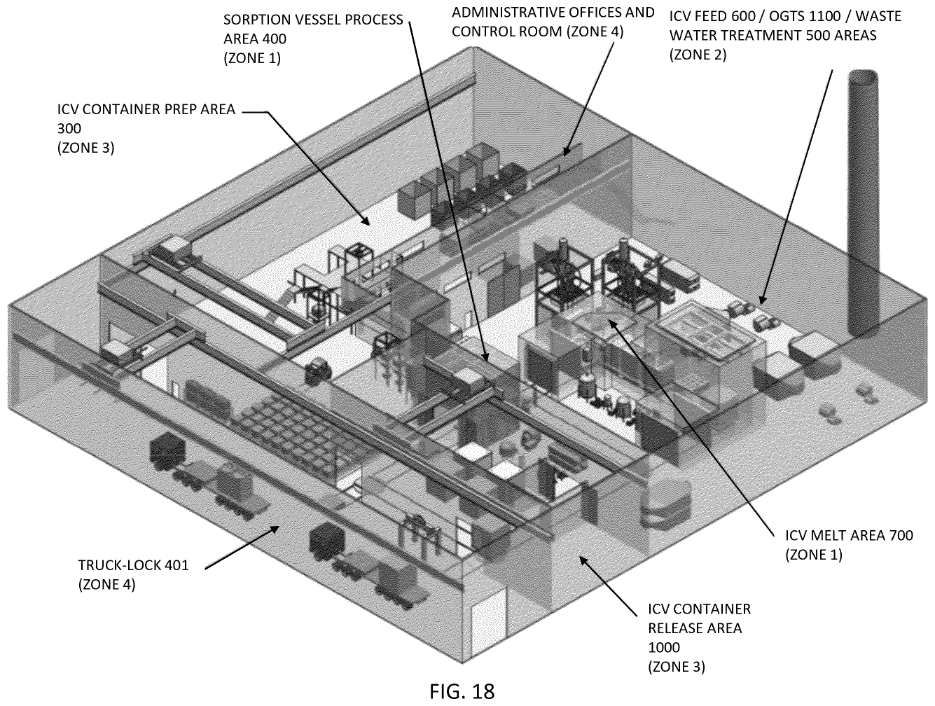

FIG. 18 depicts an isometric overview of FIGS. 17A and 17B. The ICV Melt Area 700 and Sorption Vessel Process Area 400 are Zone 1, the ICV Feed 600/OGTS 1100 Waste Water Treatment 500 Area is Zone 2, The ICV Container Preparation Area 300 and the ICV Container Release Area 1000 are Zone 3, and the Truck-Lock Area 401 and Administrative Offices and Control Room are Zone 4. The separation of defined zones isolates highly radioactive processing areas from the surrounding environment and the people working in it. Airlocks are located between Zones to prevent radioactive contamination between Zones.

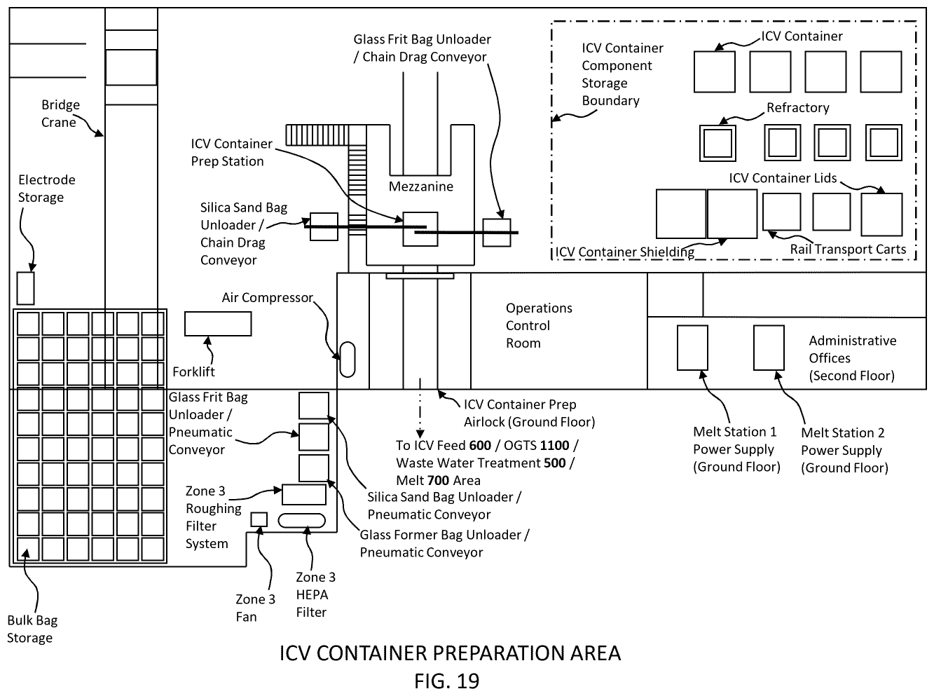

FIG. 19 depicts an embodiment of an ICV container preparation area 300. The depicted embodiment comprises electrode storage, bulk bag storage, bridge crane, ICV container preparation station, silica sand bag unloader/chain drag conveyor, glass frit bag unloader/chain drag conveyor, forklift, air compressor, glass frit bag unloader/pneumatic conveyor, zone 3 roughing filter system, zone 3 fan, zone 3 HEPA filter, glass former bag unloader/pneumatic conveyor, silica sand bag unloader/pneumatic conveyor, ICV container prep airlock, ICV containers, refractory, ICV container lids, rail transport carts, and ICV container shielding. In the depicted embodiment, there is an operation control room and administrative offices, one or both of which may be on a separate floor elevated above the ground floor. In the depicted embodiment, melt station 1 power supply and melt station 2 power supply may be on the ground floor beneath the administrative offices.

In the depicted embodiment, the ICV container(s), refractory, ICV container lid(s), ICV container shielding, and rail transport cart(s) are stored within an ICV container component storage boundary. ICV containers are prepared in the ICV Container Preparation Station where silica sand and glass frit are unloaded from the silica sand bag unloader/chain drag conveyor and the glass frit bag unloader/chain drag conveyor. Silica sand, glass frit, glass formers, and/or any other components needed for the process are stored in the bulk bag storage area. Electrodes are stored in the electrode storage area. One or more bridge cranes, conveyors, forklifts, and unloaders may be used to transport components to where they are needed. Once ICV containers are prepared, they proceed through the ICV container preparation airlock to the ICV Feed 600/OGTS 1100/Waste Water Treatment 500/Melt 700 Area. The ventilation system in the depicted embodiment comprises a roughing filter system, fan, and HEPA filter. Other quantities and types of filters are possible and may be adjusted based on the application. In the depicted embodiment, the ventilation system is Zone 3 rated.

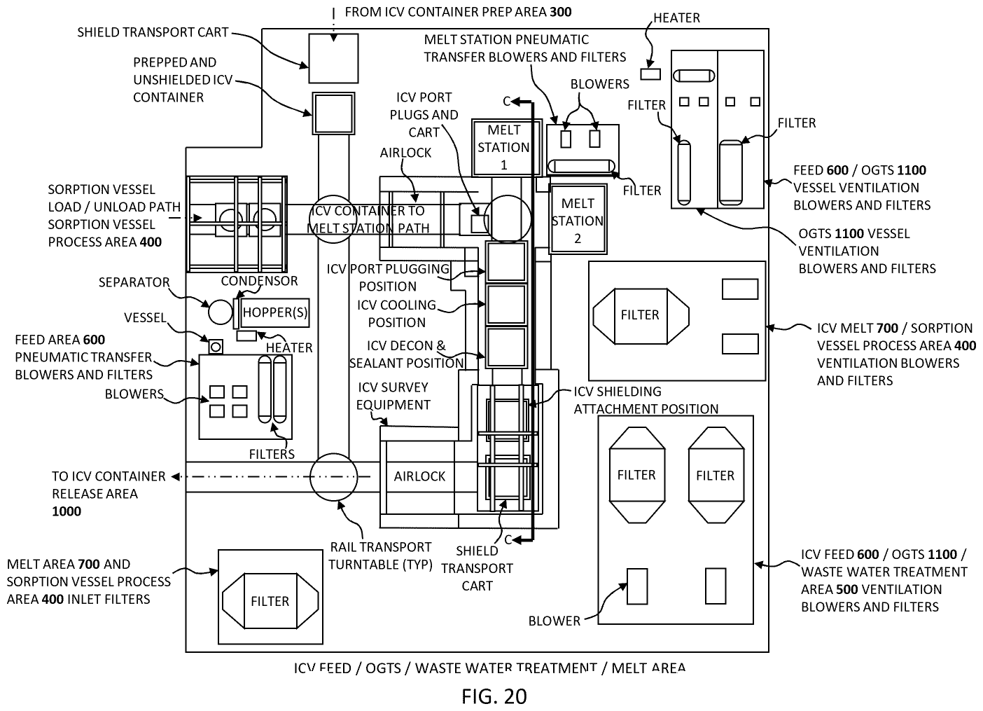

FIG. 20 depicts an embodiment of an ICV Feed 600/OGTS 1100/Waste Water Treatment 500/Melt 700 Area. Prepared ICV containers enter from the ICV Container Preparation Area 300. The prepared ICV containers may proceed down to a rail transport turntable to ICV container to melt station path, into an airlock, and to another rail turntable where they may either go to melt station 1 or melt station 2 for the melt. The sorption vessel load/unload path leads from the Sorption Vessel Process Area 400 to the ICV Feed 600/OGTS 1100/Waste Water Treatment 500/Melt 700 Area. The Melt Area 700 in the depicted embodiment comprises ICV port plugs and cart, ICV port plugging position, ICV cooling position, ICV decontamination and sealant position, ICV shielding attachment position, and ICV survey equipment which the container proceeds through after the melt has taken place. The ICV container then proceeds through an airlock along rails to rail transport turntable out to the ICV Container Release Area 1000. One or more shield transport carts may be used to transport ICV container shielding throughout the area. One or more of the ventilations systems may be included in the area such as the Feed 600/OGTS 1100 vessel ventilation blowers and filters, OGTS 1100 vessel ventilation blowers and filters, ICV Melt 700/Sorption Vessel Process Area 400 ventilation blowers and filters, ICV Feed 600/OGTS 1100/Waste Water Treatment Area 500 ventilation blowers and filters, Melt Area 700 and Sorption Vessel Process Area 400 inlet filters, melt station pneumatic transfer blowers and filters, and Feed Area 600 pneumatic transfer blowers and filters. The ventilation systems may comprise one or more different types, sizes, and amounts of blowers and/or filters, dependent on the requirements of the system.

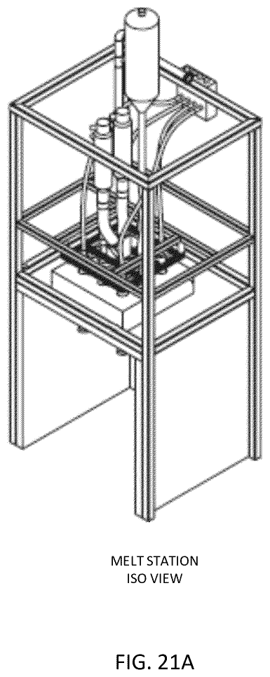

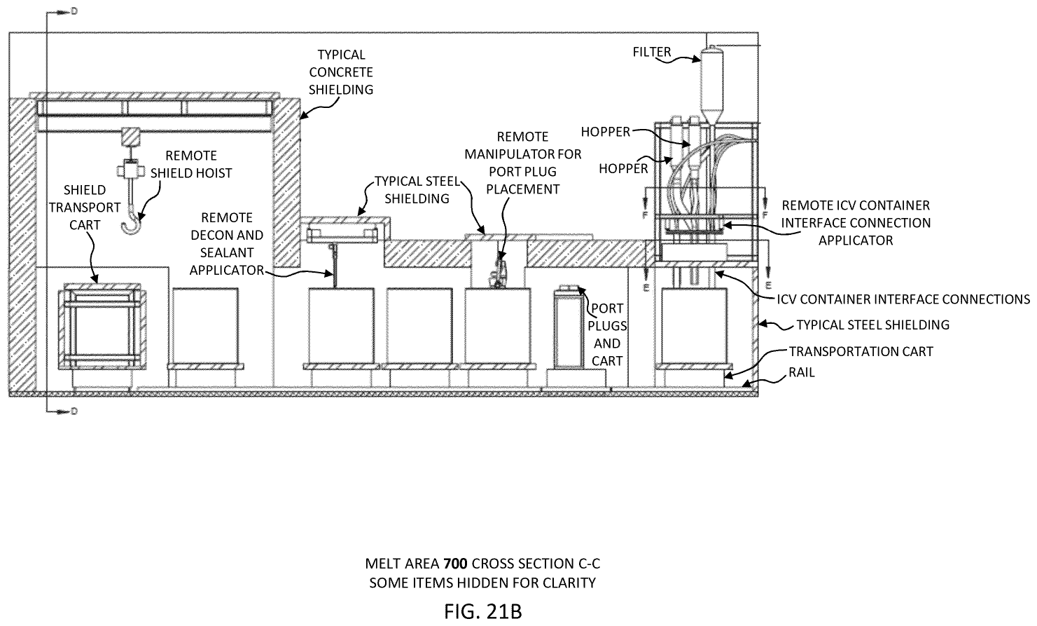

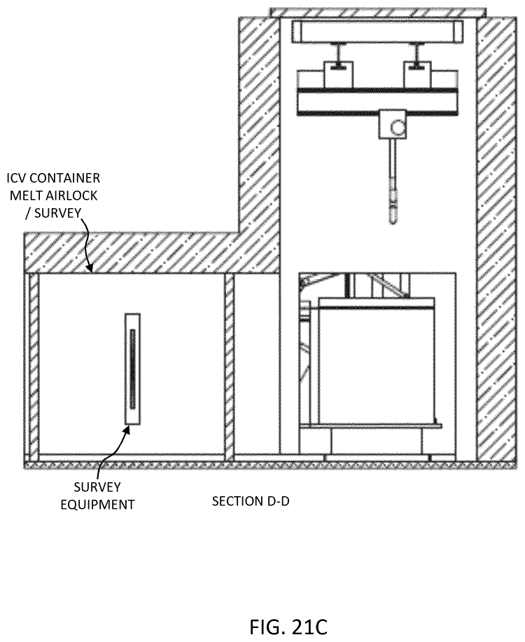

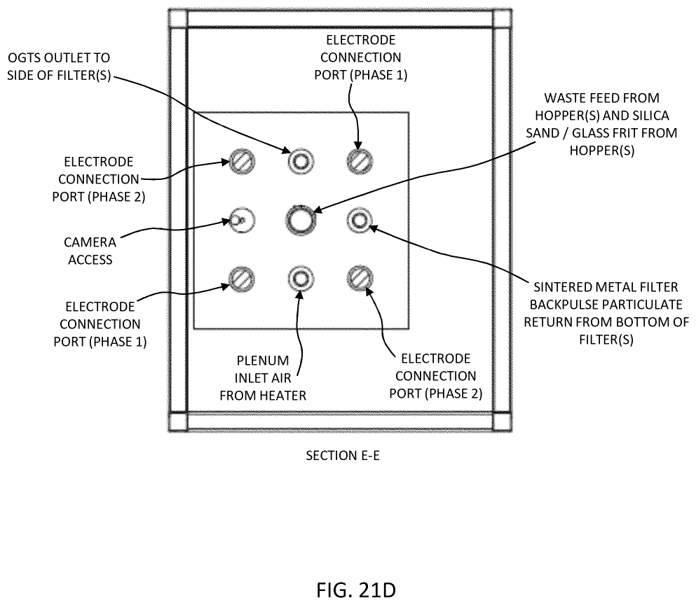

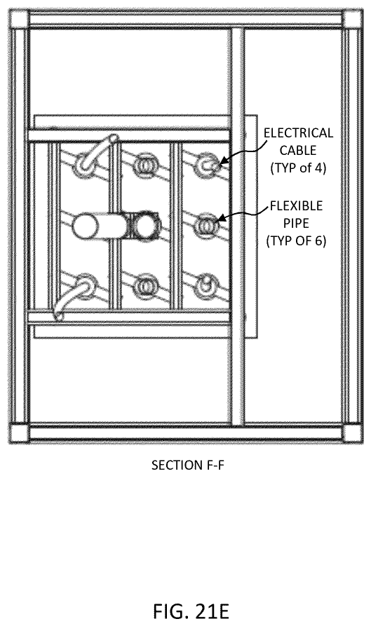

FIGS. 21A through 21E depict various views of an embodiment of a melt station. FIG. 21A depicts an isometric view of an embodiment of a melt station. In some embodiments having more than one melt station, each melt station may be similar or identical. In some embodiments having more than one melt station, each melt station may be sized and designed for different capacities or waste types.

FIG. 21B depicts Melt Area 700 Section C-C (from FIG. 20). The depicted embodiment comprises a shield transport cart, remote shield hoist, remote decontamination and sealant applicator, remote manipulator for port plug placement, port plugs and cart, one or more hoppers, remote ICV container interface connection applicator, ICV container interface connections, transportation cart, and rail. The area may comprise some concrete shielding and steel shielding, in some embodiments. Some items are hidden for clarity. The type, thickness, and locations of shielding may vary depending on the melt application and throughput. In the depicted embodiment, the process would occur from the left to the right. The ICV container may rest on a transportation cart and connect to the Melt Area 700 via ICV container interface connections using remote ICV container interface connection applicator. Materials may be delivered to the ICV container through the one or more hoppers. A remote manipulator may be used to place port plugs from the cart into the ports on the ICV container. The ICV container can proceed through decontamination and sealant applicator where decontamination and sealant materials may be applied remotely. Shields may be placed on the ICV container from the shield transport cart using a remote shield hoist.

FIG. 21C depicts Section D-D of FIG. 21B. The depicted view shows the ICV container melt airlock and survey area as well as survey equipment. FIG. 21D depicts Section E-E of FIG. 21B. FIG. 21D depicts the top of an ICV container. The depicted embodiment comprises two electrode connection ports (phase 1) and two electrode connection ports (phase 2). Other embodiments may utilize differing numbers of electrodes and corresponding electrode connection ports. The depicted embodiment further comprises camera access, OGTS outlet to side of filter(s), sintered metal filter backpulse particulate return from bottom of filter(s), and plenum inlet air from heater. The central port may be used to take in waste feed from one or more hoppers and silica sand/glass frit from one or more hoppers for the melt process. In some embodiments, the configuration of the ports and/or the number of ports may vary. FIG. 21E depicts Section F-F of FIG. 21B. The depicted embodiment shows electrical cables and flexible pipes used to connect to the ICV container.

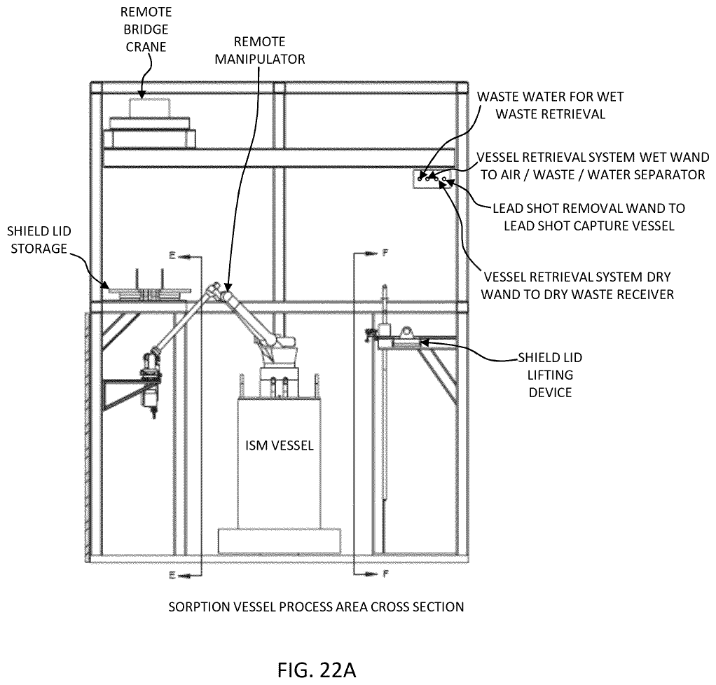

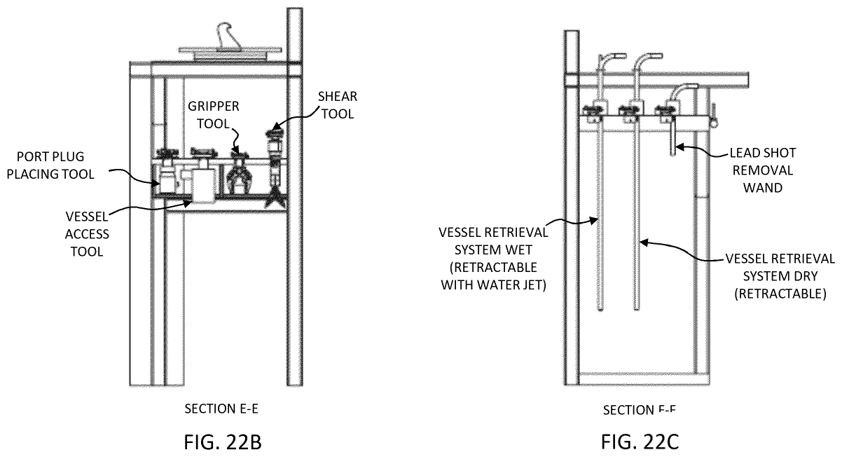

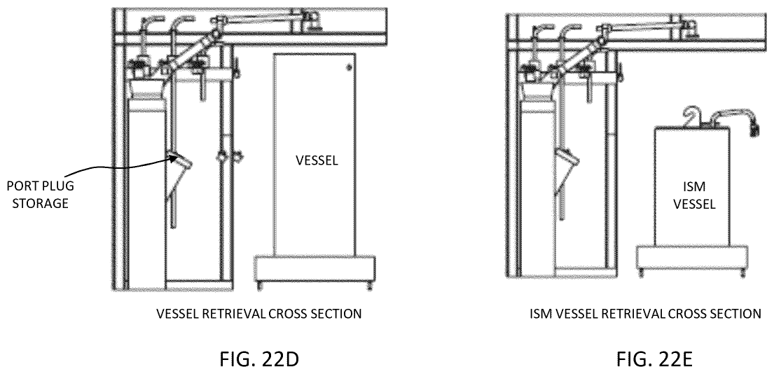

FIG. 22A depicts a cross-section of an embodiment of a Sorption Vessel Process Area 400. The depicted embodiment comprises a remote bridge crane, a remote manipulator, shield storage lid, ISM vessel, and shield lid lifting device. It further comprises waste water for wet waste retrieval, vessel retrieval system wet wand to air/waste/water separator, lead shot removal wand to lead shot capture vessel, and vessel retrieval system dry wand to dry waste receiver for the different types of waste retrieval that may be required to remove waste from the vessels.

FIG. 22B depicts Section E-E of FIG. 22A. The depicted embodiment comprises a vessel access tool, a port plug placing tool, a gripper tool, and a shear tool. Some embodiments may comprise more or fewer different tools and types of tools depending the application. FIG. 22C depicts Section F-F of FIG. 22A. The depicted embodiment comprises lead shot removal wand, vessel retrieval system wet (retractable with water jet, in some embodiments), and vessel retrieval system dry (retractable, in some embodiments). FIG. 22D depicts an embodiment of vessel retrieval cross section comprising port plug storage and vessel. FIG. 22E depicts an embodiment of ISM vessel retrieval cross section comprising an ISM vessel.

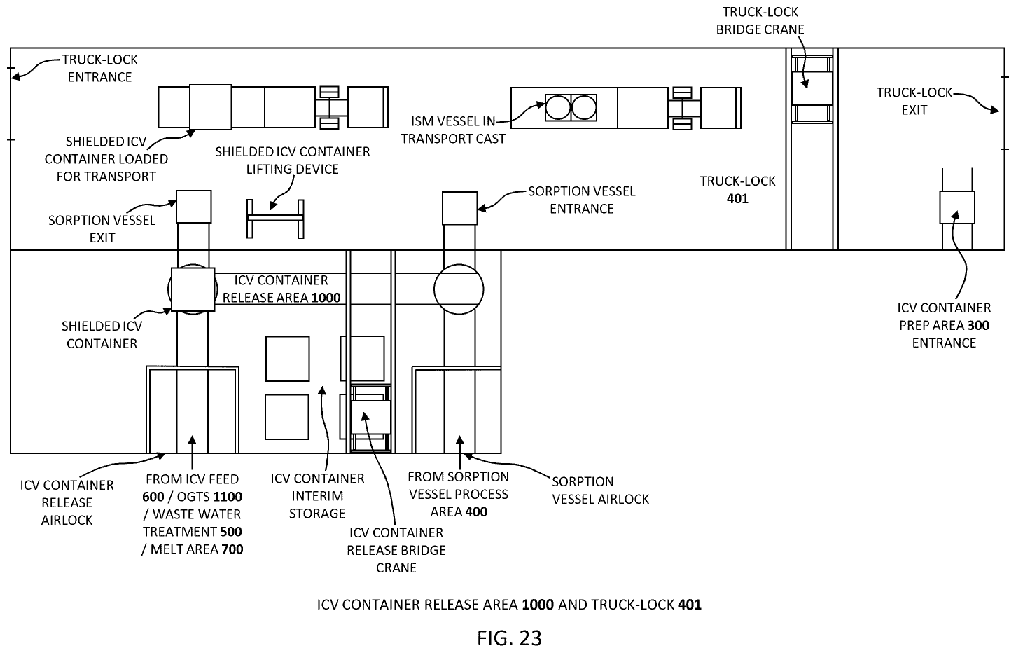

FIG. 23 depicts an embodiment of an ICV Container Release Area 1000 and Truck-Lock 401. The depicted Truck-Lock 401 area comprises a truck-lock entrance and a truck-lock exit. The depicted Truck-Lock 401 area comprises two entrances to, and one exit from, other areas in the facility: ICV Container Preparation Area 300 entrance, sorption vessel entrance, and sorption vessel exit. Some embodiments further comprise a truck-lock bridge crane and/or a shielded ICV container lifting device. Trucks may be used to transport ISM vessels in transport casts and shielded ICV containers loaded for transport. The depicted ICV Container Release Area 1000 comprises sorption vessel airlock and ICV container release airlock. Processed and shielded ICV containers proceed from the ICV Feed 600/OGTS 1100/Waste Water Treatment 500/Melt Area 700 into the ICV container release airlock through the sorption vessel exit into Truck-Lock 401 for transport. ICV containers may be temporarily stored in ICV container interim storage. In the depicted embodiment, the ICV Container Release Area 1000 comprises an ICV container release bridge crane.

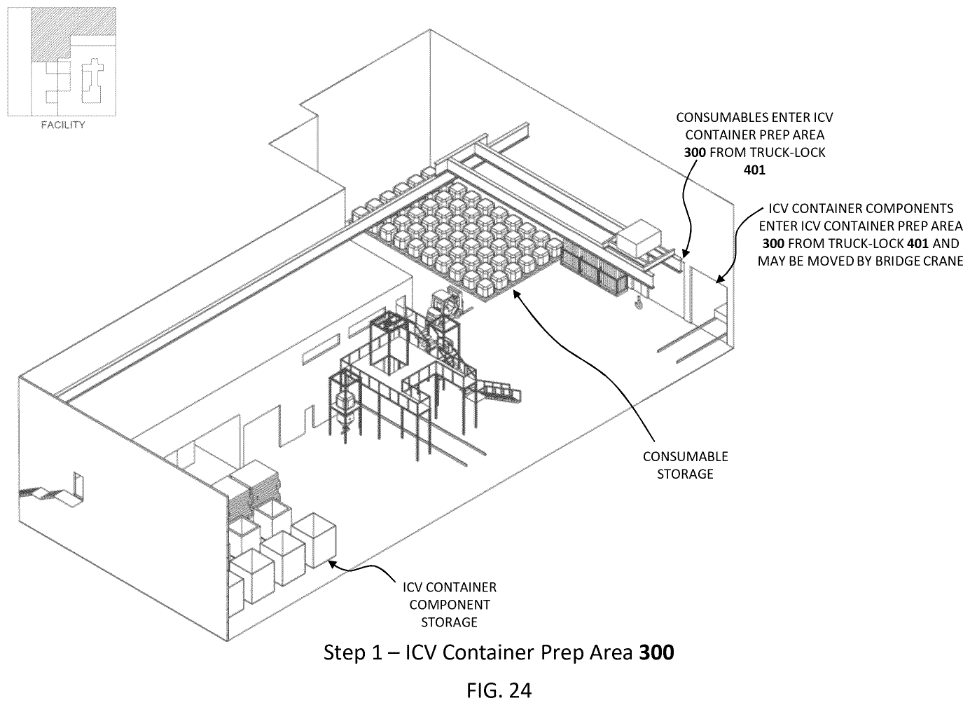

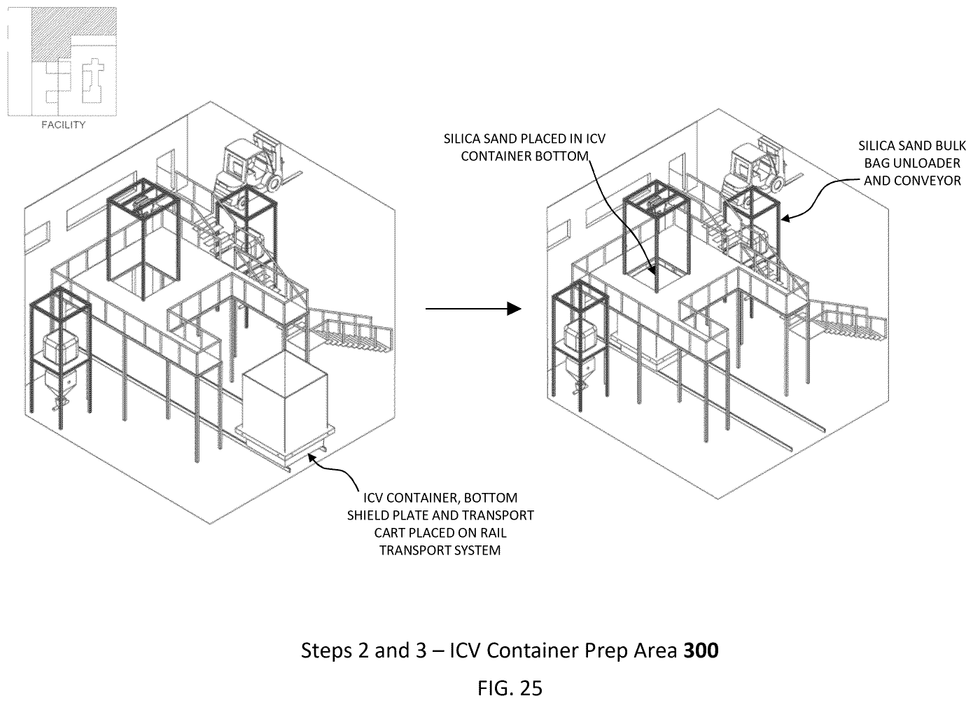

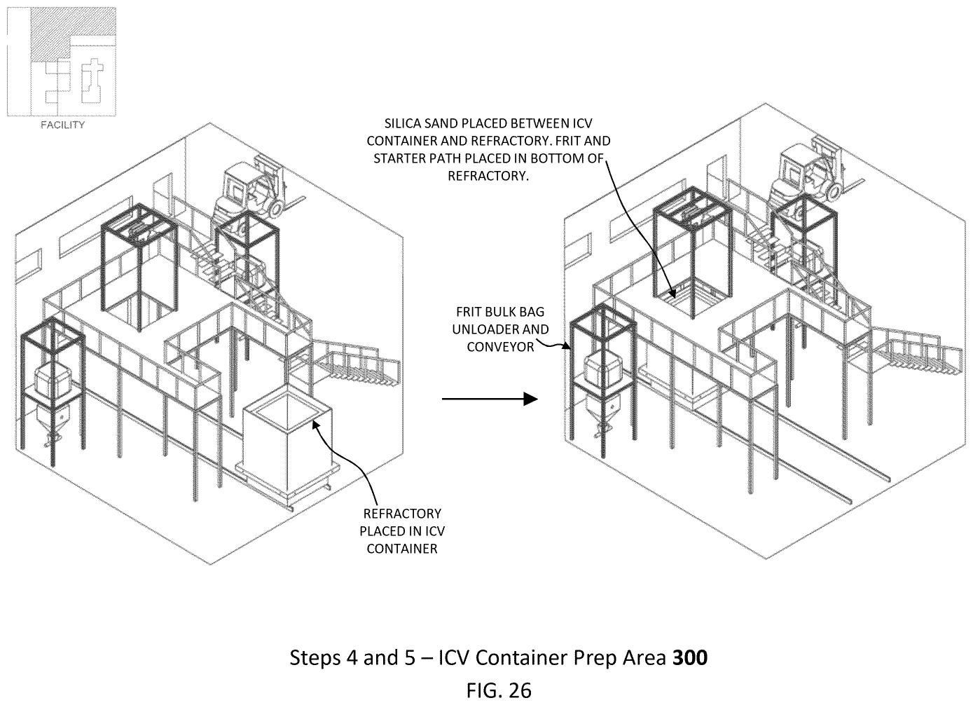

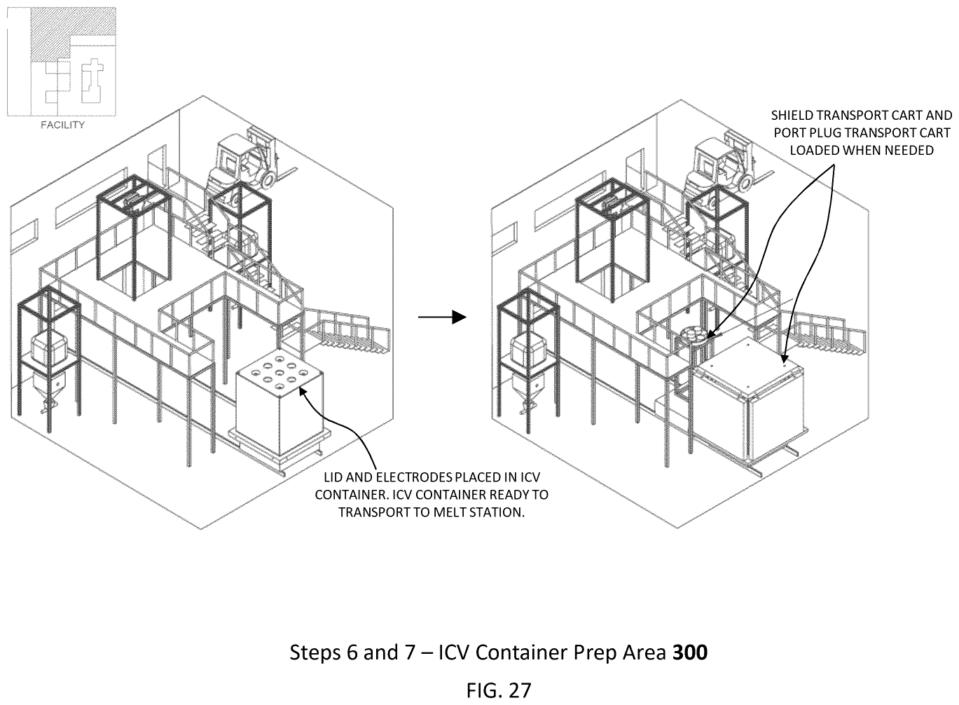

FIGS. 24 through 27 depicts exemplary process steps in the ICV Container Preparation Area 300. FIG. 24 depicts Step 1. In Step 1, consumables and ICV container components enter ICV Container Preparation Area 300 from Truck-Lock 401. In some embodiments, one or more of the components and containers may be transported using a bridge crane and/or forklift. Within the ICV Container Preparation Area 300 there is a consumable storage area and an ICV container component storage area. FIG. 25 depicts Steps 2 and 3. In Step 2, the ICV container, bottom shield plate, and transport cart are placed on the rail transport system. In Step 3, silica sand is placed in the ICV container bottom using silica sand bulk bag unloader and conveyor. FIG. 26 depicts Steps 4 and 5. Step 4 comprises placing the refractory in the ICV container. In Step 5, silica sand is placed between ICV container and refractory and frit and starter path are place in the bottom of the refractory using the frit bulk bag unloader and conveyor. FIG. 27 depicts Steps 6 and 7. In Step 6, the lid and electrodes are placed in the ICV container and the ICV container is ready for transport to the melt station(s). In Step 7, the shield transport cart and the port plug transport cart are loaded when needed.

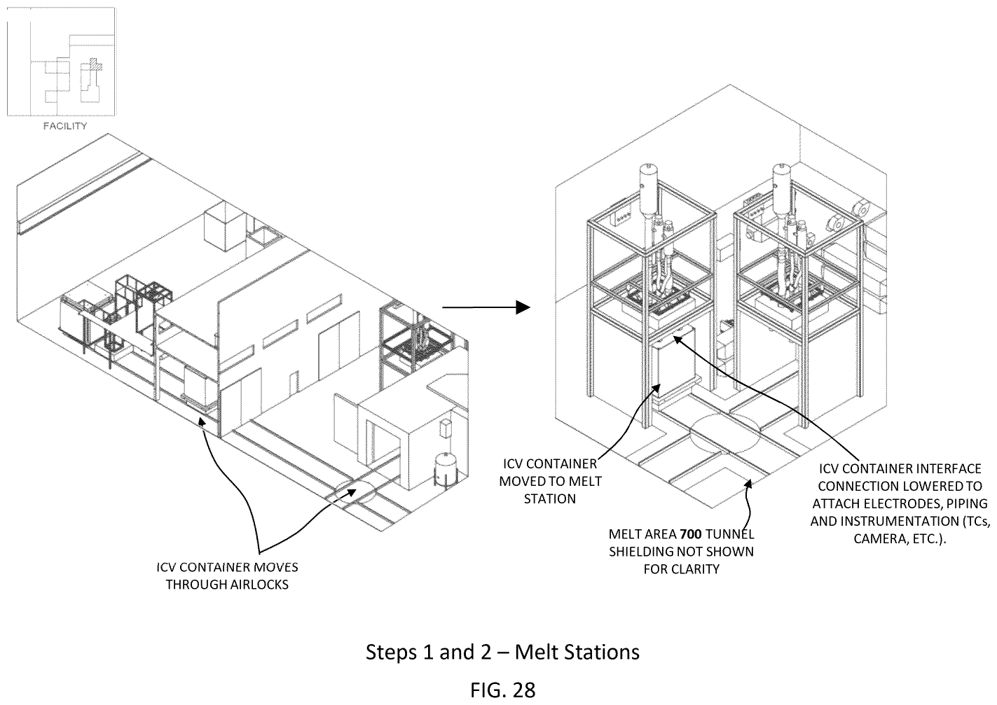

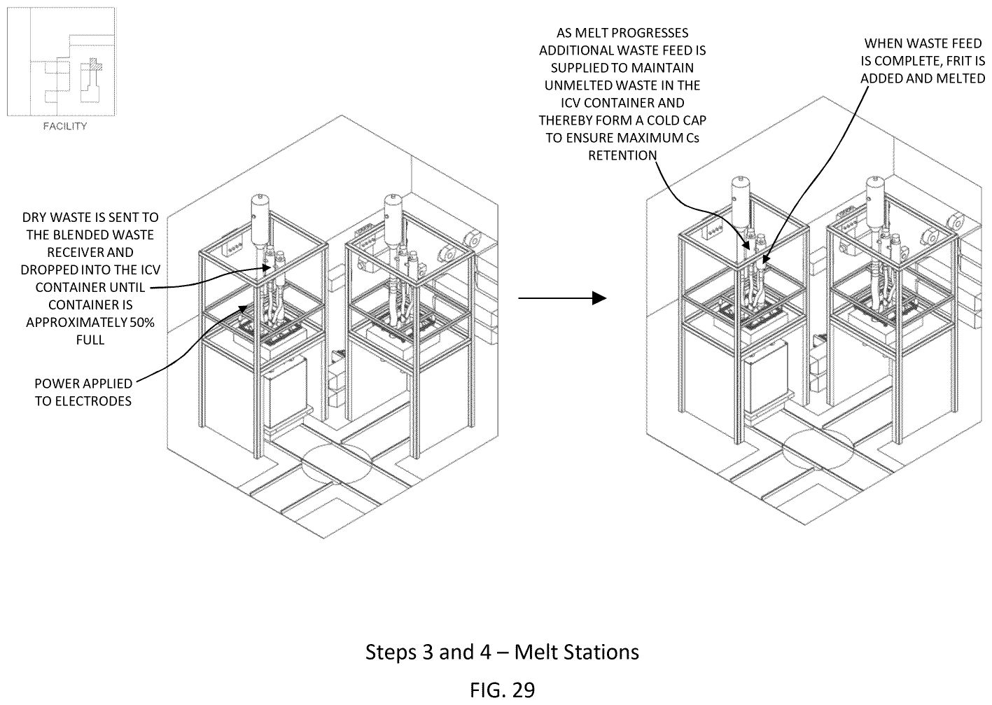

FIGS. 28 through 30 depict exemplary process steps for the one or more melt stations. FIG. 28 depicts Steps 1 and 2. In Step 1, the ICV container moves through the airlocks. In Step 2, the ICV container is moved to a melt station. The ICV container interface connection will be lowered to attach electrodes, piping, and instrumentation which may include one or more thermocouples, camera, and other sensors which are described in more detail under the Sensors heading. In the depicted embodiment, the Melt Area 700 tunnel is not shown for clarity. FIG. 29 depicts Steps 3 and 4. In Step 3, the dry waste is sent to the blended waste receiver and dropped into the ICV container until the container is approximately 50% full, in some embodiments. Power is also applied to the electrodes. In Step 4, as the melt progress, additional waste feed is supplied. In some embodiments, the waste is added to maintain unmelted waste in the ICV container and thereby form a cold cap to ensure maximum cesium (Cs) retention. In some embodiments, cesium (Cs) retention is improved by managing the feed pile (cold cap) above the molten surface. This process creates an insulating layer above the melt surface and controls both Cs retention and processing rate. The cold cap increases retention of volatile radionuclides (e.g., Cs) within the glass product by minimizing volatilization into the off-gas system. In addition, the clean glass frit that is lastly added onto the waste feed material provides a final insulating layer on top of the last Cs feed addition. After it has been processed, the remaining glass frit, which has no Cs component, can be melted without concern for Cs volatility. In some embodiments, a plenum camera may be used to monitor the cold cap.

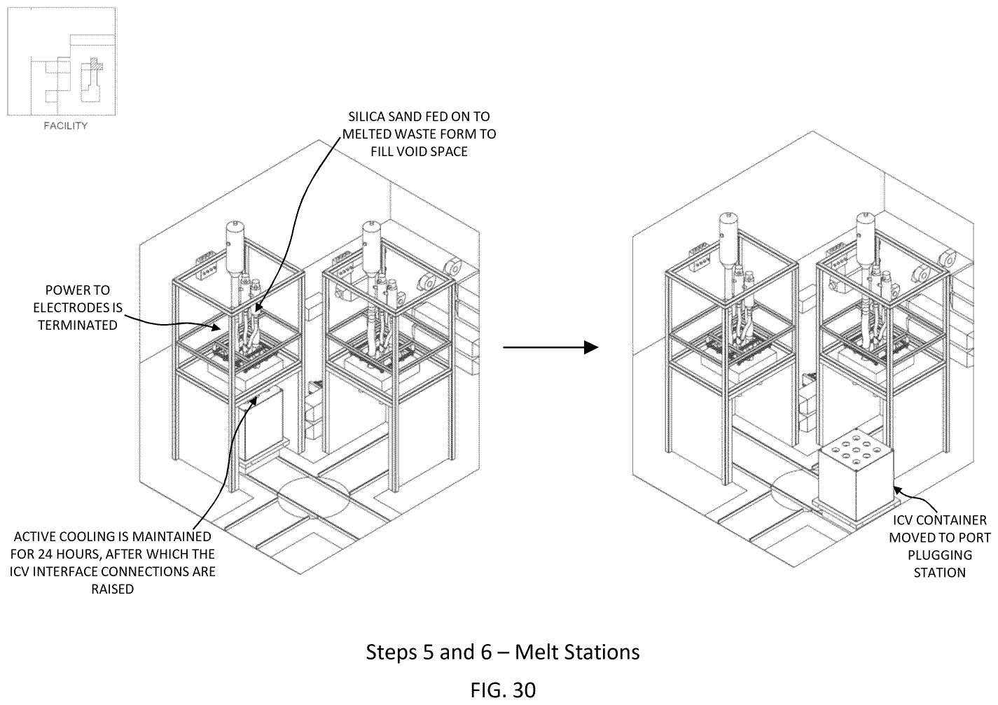

When the waste feed is complete, frit is added and melted. FIG. 30 depicts Steps 5 and 6. In Step 5, power to the electrodes is terminated and silica sand is fed on to the melted waste form to fill void space. In some embodiments, active cooling is maintained for 24 hours, after which the ICV interface connections are raised. In Step 6, the ICV container is moved to the port plugging station.

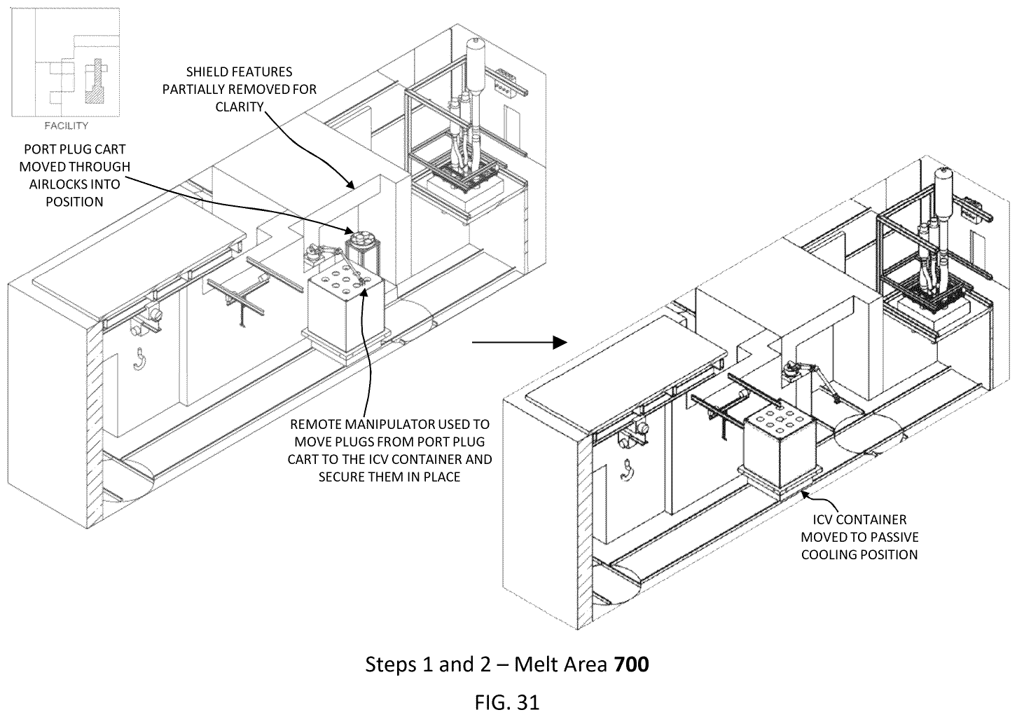

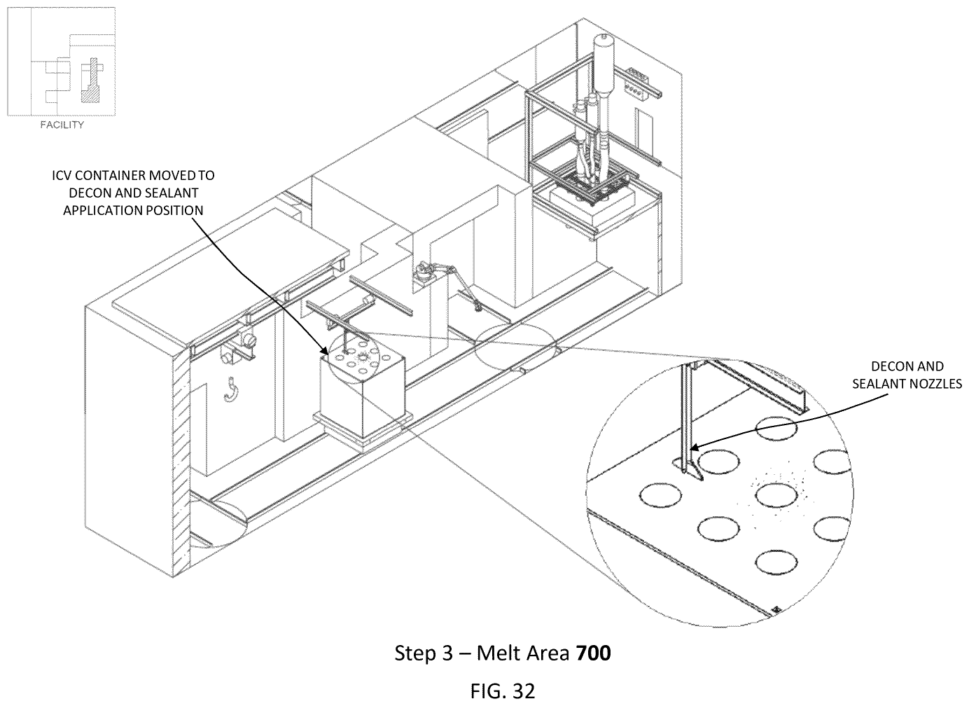

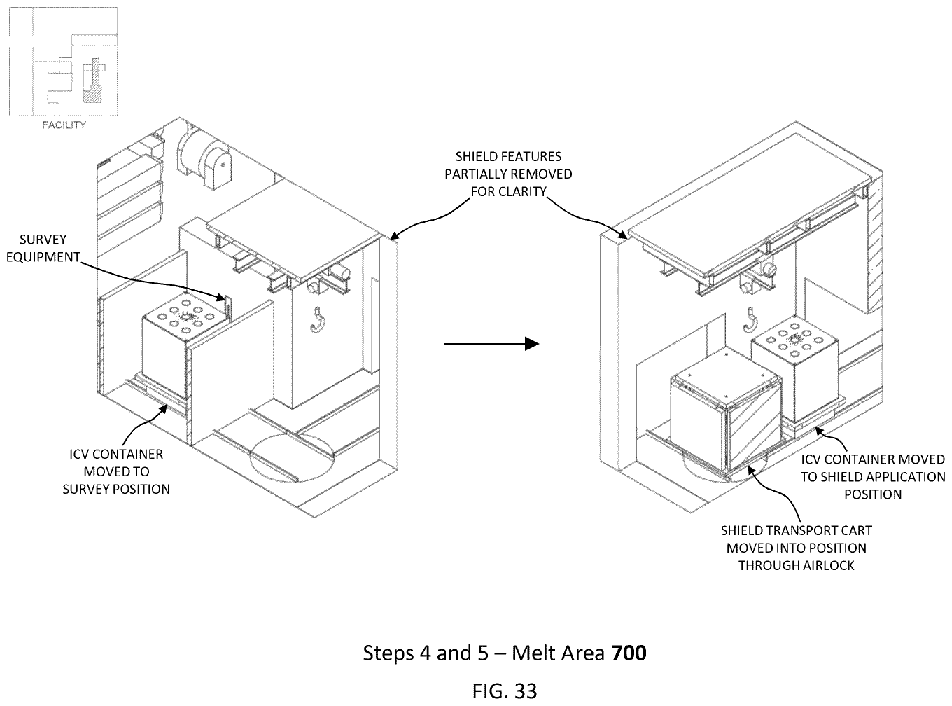

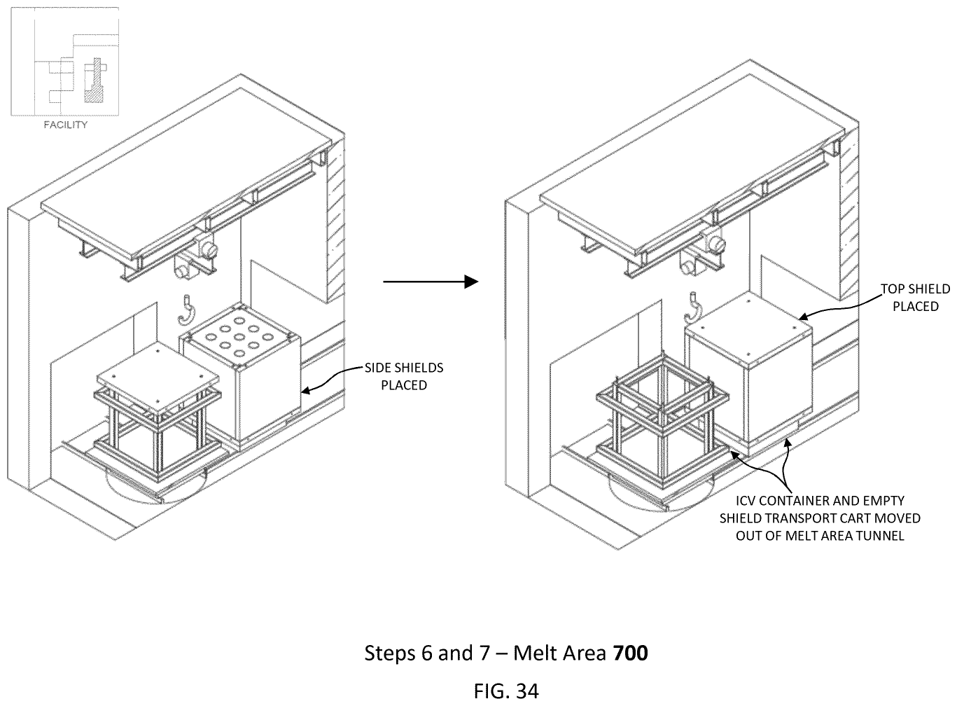

FIGS. 31 through 34 depict exemplary process steps in the Melt Area 700. FIG. 31 depicts Steps 1 and 2. In the depicted embodiment, shield features are partially removed for clarity. In Step 1, the port plug cart is moved through the airlocks into position and the remote manipulator is used to move plugs from the port plug cart to the ICV container and they are secured in place. In Step 2, the ICV container is moved to the passive cooling position. FIG. 32 depicts Step 3. In Step 3, the ICV container is moved to the decontamination and sealant application position where decontamination and sealant nozzles may be used to apply decontaminants and sealants to the ICV container. FIG. 33 depicts Steps 4 and 5. Shield features are partially removed for clarity. In Step 4, the ICV Container is moved into the survey position where it can be surveyed by survey equipment. In Step 5, the ICV container is moved to the shield application position and the shield transport cart is moved into position through an airlock. FIG. 34 depicts Steps 6 and 7. In Step 6, the side shields are placed on the ICV container. In Step 7, the top shield is placed and the ICV container and empty shield transport cart is moved out of the melt area tunnel.

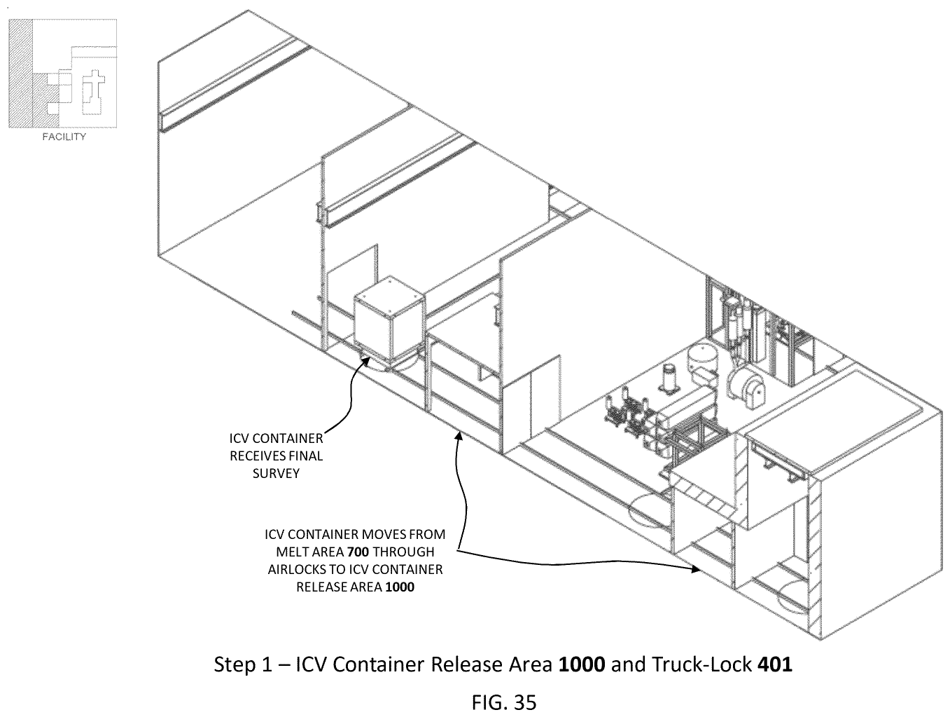

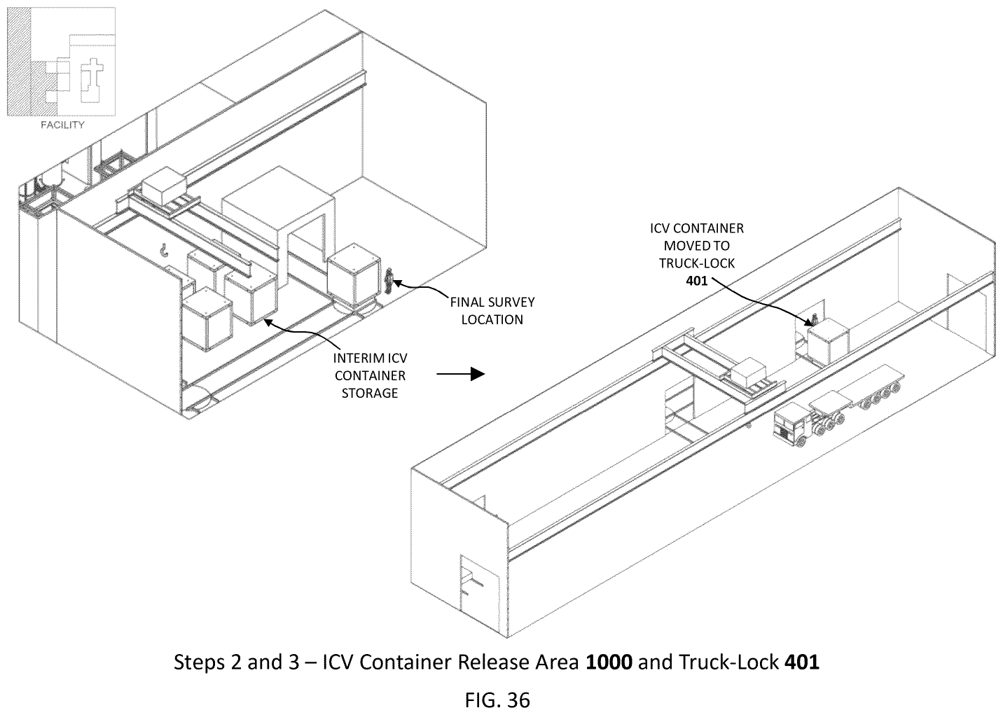

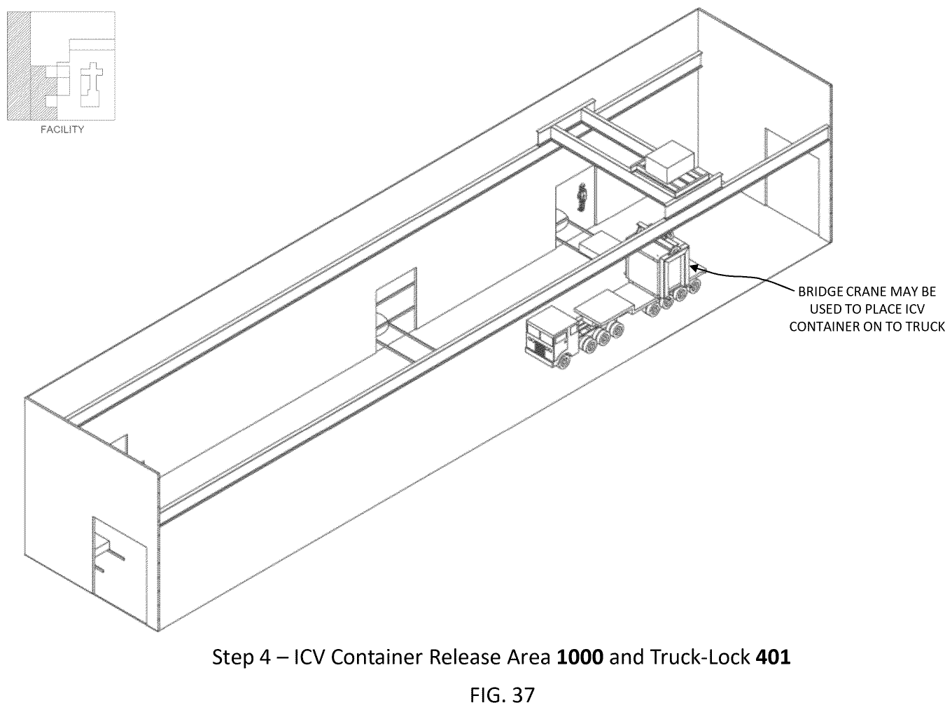

FIGS. 35 through 37 depict exemplary process steps in the ICV Container Release Area 1000 and Truck-Lock 401. FIG. 35 depicts Step 1. In Step 1, the ICV container receives a final survey and the ICV container moves from the Melt Area 700 through airlocks to the ICV Container Release Area 1000. FIG. 36 depicts Steps 2 and 3. In Step 2, the ICV container proceeds through interim ICV container storage to the final survey location for a final survey. In Step 3, the ICV container is moved to Truck-Lock 401. FIG. 37 depicts Step 4. In Step 4, the ICV container is placed onto a truck for transport. In some embodiments, a bridge crane is used to move the ICV container(s).

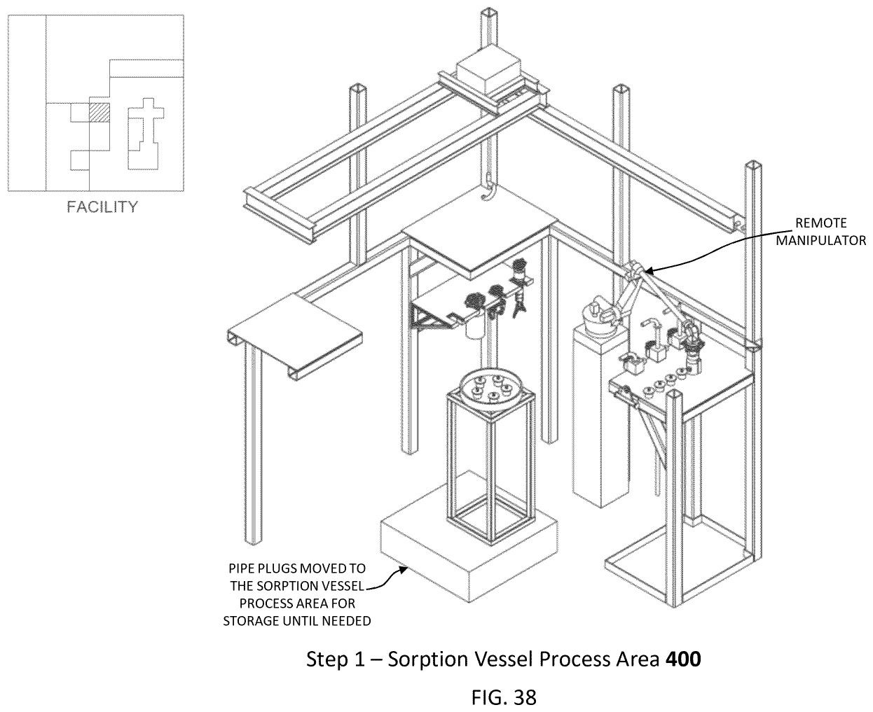

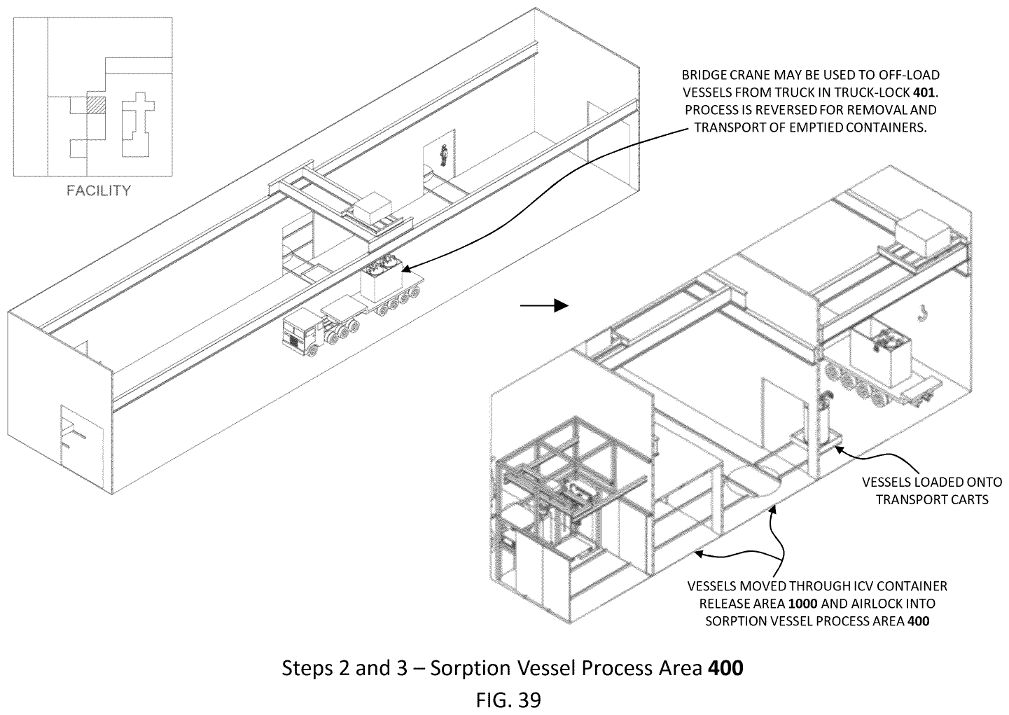

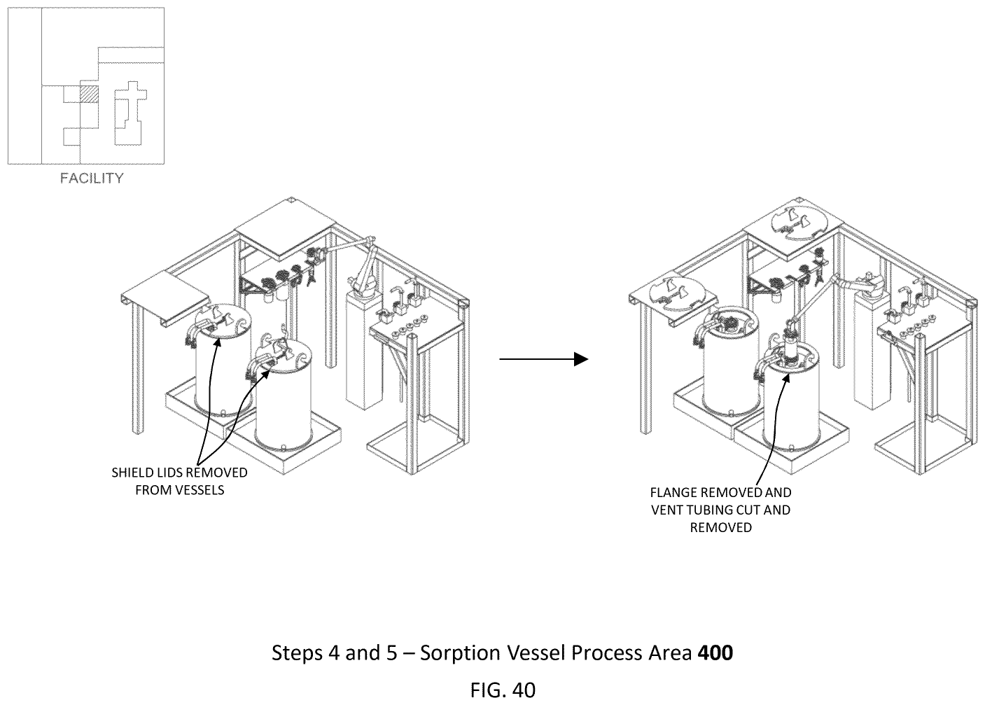

FIGS. 38 through 44 depict exemplary process steps in the Sorption Vessel Process Area 400. FIG. 38 depicts Step 1. In Step 1, pipe plugs are moved to the Sorption Vessel Process Area 400 for storage until needed. The Sorption Vessel Process Area 400 comprises a remote manipulator in some embodiments. FIG. 39 depicts Steps 2 and 3. In Step 2, vessels may be offloaded from a truck in Truck-Lock 401. The process is reversed for the transport of emptied containers. In some embodiments, the vessels may be moved using a bridge crane. In Step 2, vessels are loaded onto transport carts and then moved through the ICV Container Release Area 1000 and airlock into the Sorption Vessel Process Area 400. FIG. 40 depicts Steps 4 and 5. In Step 4, shield lids are removed from vessels. In some embodiments, the lids are placed on shelves. In Step 5, the flange is removed and vent tubing is cut and removed, when applicable.

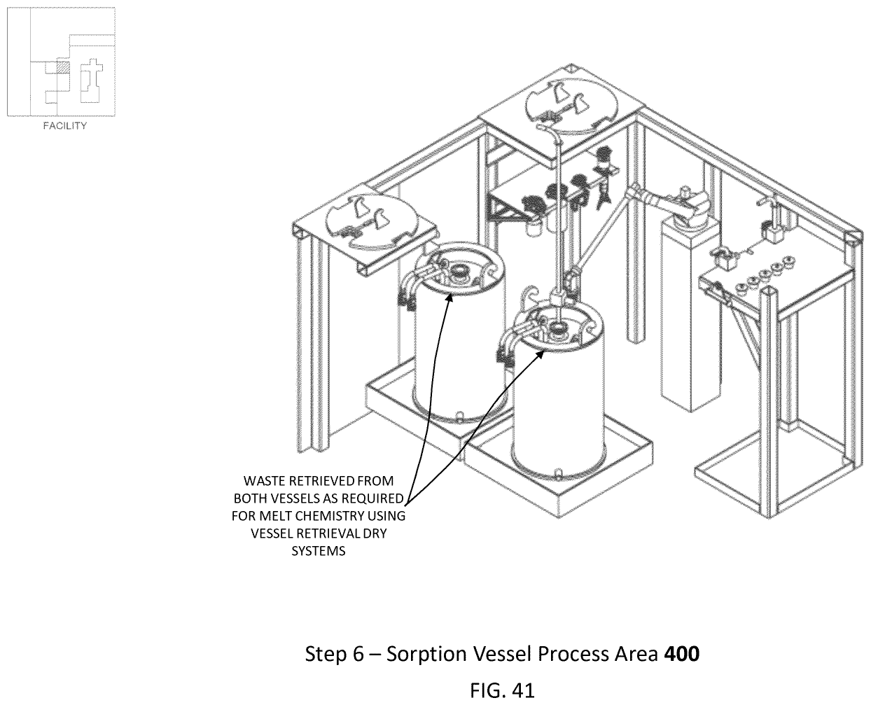

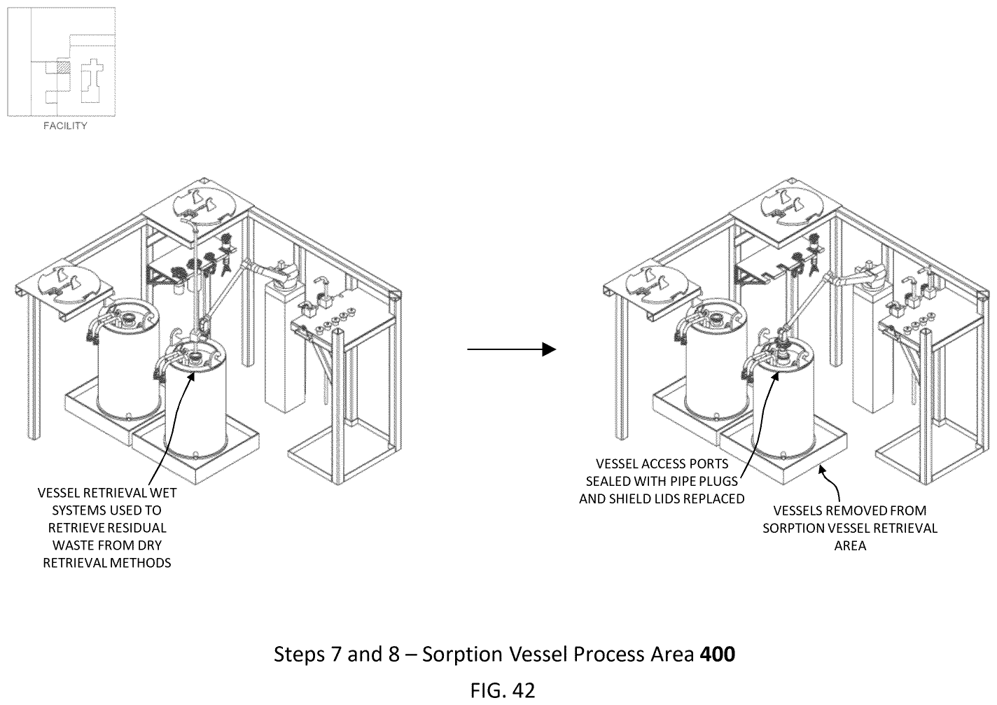

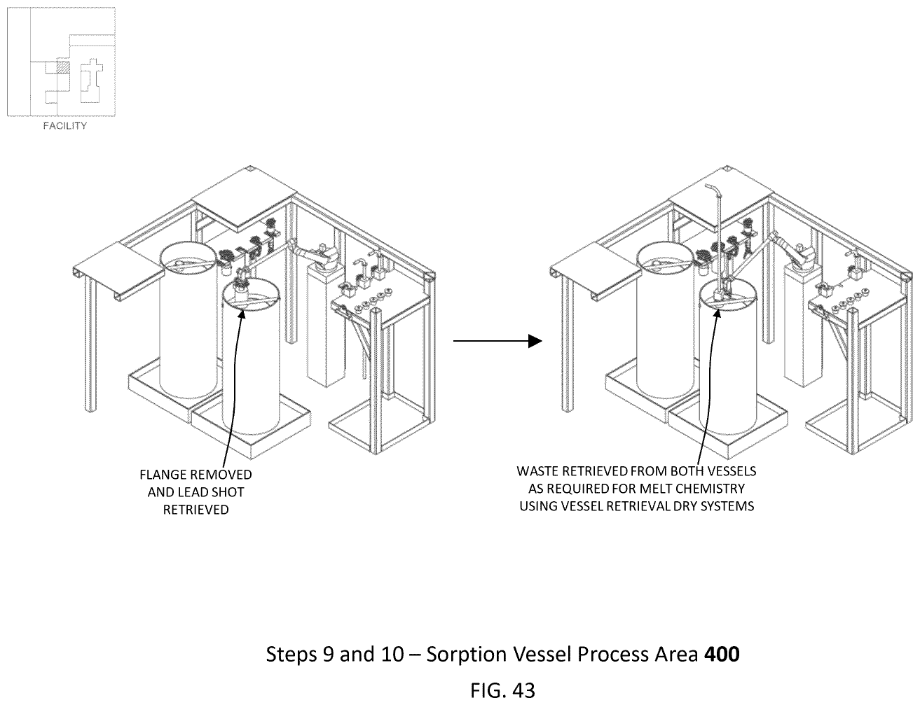

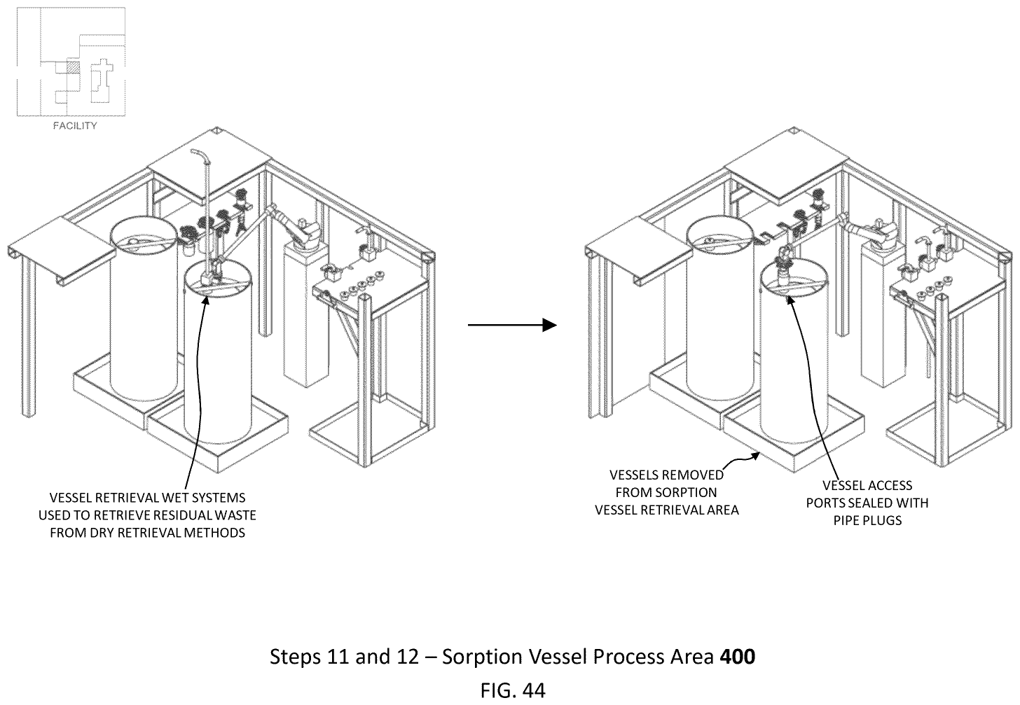

FIG. 41 depicts Step 6. In Step 6, waste is retrieved from the vessels as required for melt chemistry using vessel retrieval dry systems. FIG. 42 depicts Steps 7 and 8. In Step 7, vessel retrieval wet systems are used to retrieve residual waste from dry retrieval methods. In Step 8, vessel access ports are sealed with pipe plugs and shield lids are replaced. Vessels are removed from sorption vessel retrieval area. FIG. 43 depicts Steps 9 and 10. In Step 9, the flange is removed and lead shot is retrieved. In Step 10, waste is retrieved from vessels as required for melt chemistry using vessel retrieval dry systems. FIG. 44 depicts Steps 11 and 12. In Step 11, vessel retrieval wet systems used to retrieve residual waste from dry retrieval methods. In Step 12, vessels are removed from sorption vessel retrieval area and vessel access ports are sealed with pipe plugs.

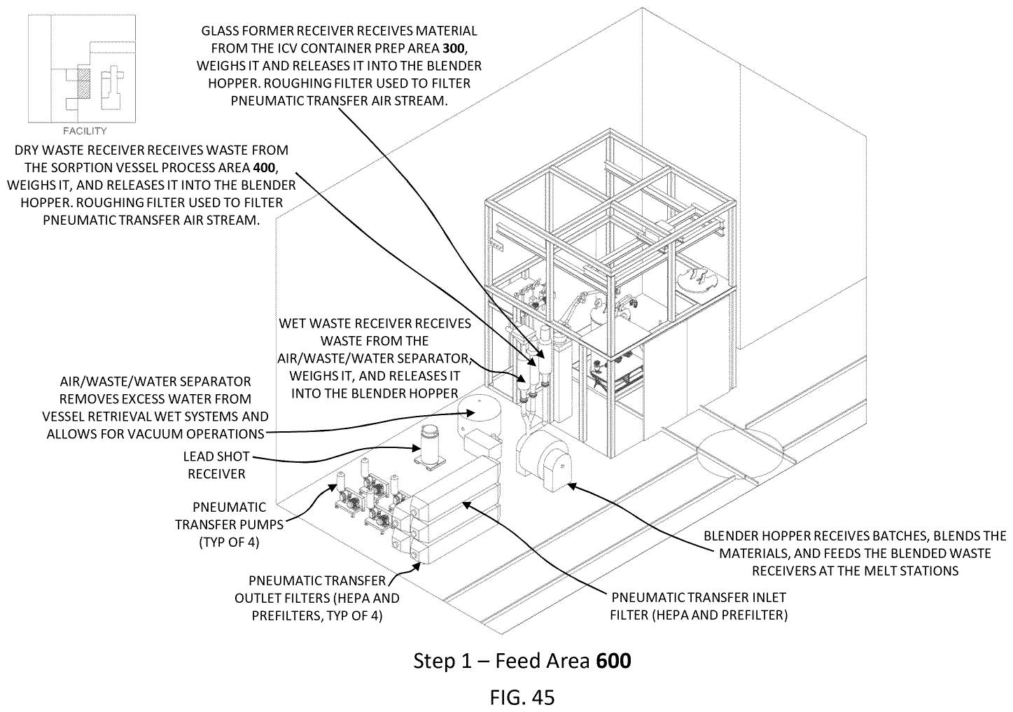

FIG. 45 depicts an exemplary process step in the Feed Area 600. The depicted embodiment comprises a lead shot retriever, pneumatic transfer pumps, pneumatic transfer outlet filters (HEPA and/or prefilter(s), in some embodiments), and pneumatic transfer inlet filter (HEPA and/or prefilter(s), in some embodiments). Glass former receiver receives material from the ICV Container Preparation Area 300, weighs is and releases it into the blender hopper. The dry waste receiver receives waste from the Sorption Vessel Process Area 400, weighs it, and releases it into the blender hopper. The wet waste receiver receives waste from the air/waste/water separator, weighs it, and releases it into the blender hopper. The air/waste/water separator removes excess water from vessel retrieval wet systems and allows for vacuum operations. The blender hopper receives batches, blends the materials, and feeds the blended waste receivers at the melt station(s). One or more roughing filters may be used to filter pneumatic transfer air stream at one or more locations in the system.

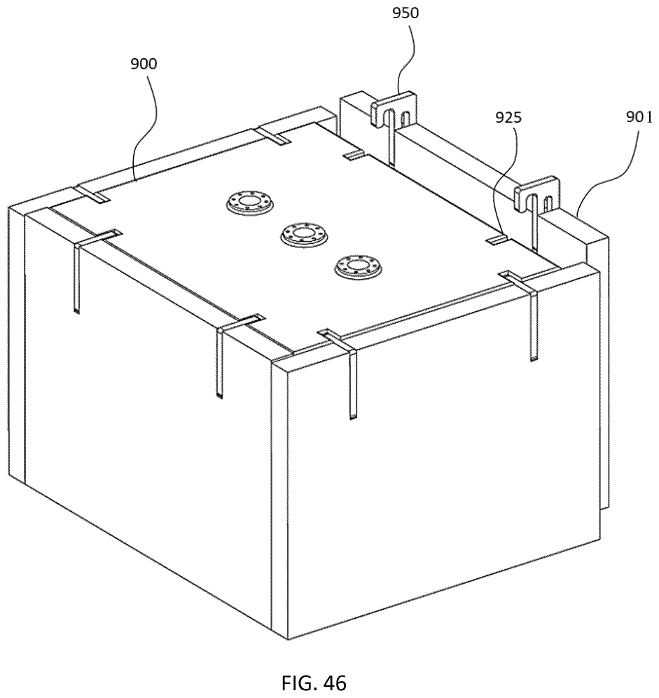

FIG. 46 depicts a modified ICV container embodiment 900 with shield mounts 925 and shield panels 901. Each container 900 may comprise one or more shield mounting points 925 on each side. In the depicted embodiment, each container 400 comprises two shield mounting points 925 on each side of the top of the container 900 for a total of eight shield mounting points 925 per container 900. The type, geometry, quantity, and location of the shield mounting points 925 may vary between embodiments. Shield mounts 950 are shaped to engage with the shield mounting points 925 on the container 900. In the depicted embodiment, a single container 900 is shielded on all sides. In some embodiments, a shield may also be used as a lid on the top of the container 900.

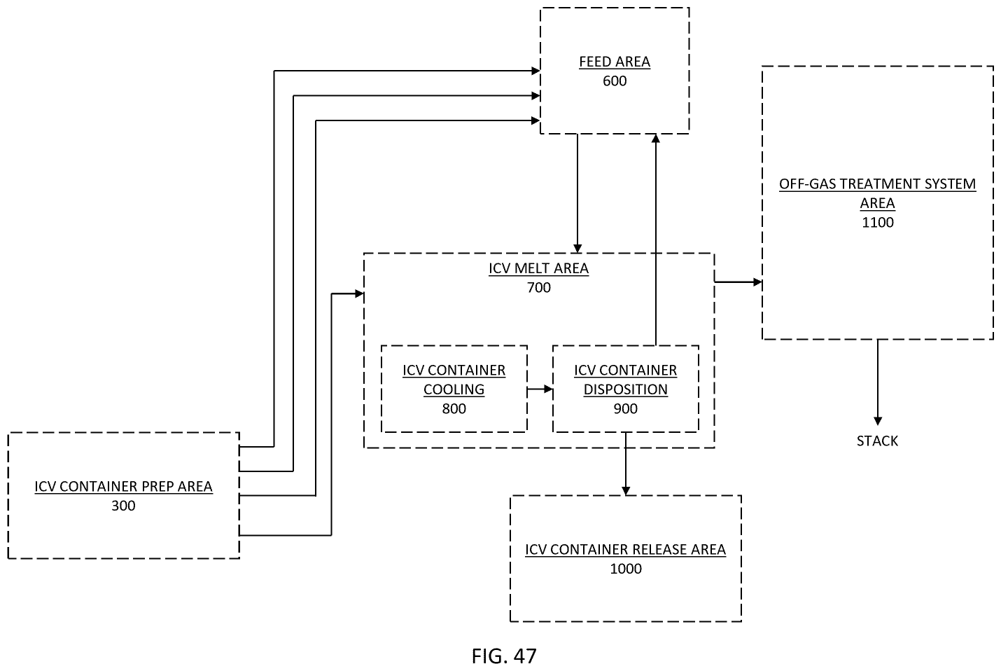

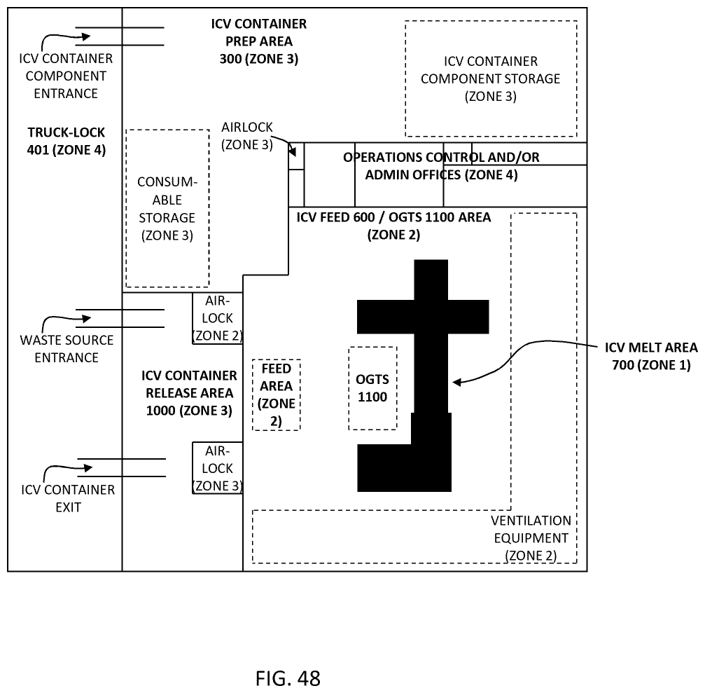

FIGS. 47 and 48 depicts a variation of the ICV process for other waste types. In some embodiments, for waste types such as asbestos or other non-nuclear waste, the Waste Water Treatment step and the Sorption Vessel Processing step may be skipped. In these embodiments, the waste may be brought directly in without requiring waste specific pre-processing areas. In some embodiments, rather than using a waste specific pre-processing area, a temporary storage area may be used for the waste prior to processing or waste may be brought in as needed. FIG. 47 is the same as FIG. 2 except the Sorption Vessel Process Area 400, Waste Water Treatment Area 500, and the Secondary Processing Area and associated process lines are removed. The process would proceed as discussed in FIGS. 3 and 6-10 with process lines from FIGS. 4 and 5 removed. FIG. 11 would not comprise the Secondary Waste 1101 area and associated process lines. Depending on the waste type, FIG. 9 may not require one or more of decontamination 86, surface contamination sealant 88 steps, and/or shielding 92 in some embodiments. FIG. 48 is the same as FIG. 17A except that the Sorption Vessel Process Area and the Waste Water Treatment areas are removed.

### Sensors

One or more sensors and instruments may be used to monitor and control system properties throughout the process. The positions and types of sensors and/or instruments may be dependent upon the scale of the process as well as the chemical properties of the off-gas, among other design considerations. Types of sensors may comprise one or more of contact sensors, non-contact sensors, capacitive sensors, inductive sensors, 3D imagers, fiber optic cable, cameras, thermal imagers, thermometers, pressure sensors, radiation detectors, LIDAR, microphones, among others. In some embodiments, one or more infrared (IR) cameras, with or without radiation shielding, may be used in the system.

Some embodiments may comprise one or more imaging sensors. The one or more imaging sensors may comprise one or more of 3D imaging, 2D range sensor, camera (such as an IR camera or radiation shielded IR camera, in some embodiments), thermal imager, and radiation detector, among others. One or more imaging sensors may be used to provide inspection and monitoring capabilities for remote operators. Signals from one or more imaging sensors may be displayed in real-time, recorded for later review, and/or recorded for operational records. Any one or more of the cameras may be one of fixed or pan-tilt-zoom types. An operator may select and manage desired camera views for operations, while controlling the cameras with associated control features such as the pan, tilt, zoom (PTZ), focus, and lights. In an embodiment, proper visual coverage of operations may be made possible by a camera system through adequate camera coverage, determined by camera quantity and location.

In some embodiments, sensors are added merely for tracking of the properties of the materials throughout the process. In some embodiments sensor data is used to control the operation of the system. Some embodiments may utilize sensor fusion algorithms to analyze data retrieved from one or more sensors of one or more different types. In some embodiments, the sensor data will automatically be analyzed and automatically effect changes in the control system for the process requiring little to no input from a human operator. In some embodiments, the sensor data and or analysis is displayed for a human operator to perform manual adjustments. In some embodiments, fiber optic cable is placed in the container with the blended waste material prior to heating. The fiber optic cable may use Raleigh backscatter to determine at least one of the temperatures of the melt material, depth of the melt activity, or progress of the melt activity.

In some embodiments, appropriate sensors may be used to monitor process conditions at one or more key locations to identify issues early, including process flow, pressure, and temperature, as well as activity levels (dose) at one or more key locations.

In some embodiments, a thermal imaging (infrared) system may be used to monitor the ICV container plenum. In some embodiments, the one or more imaging systems used may further comprise lens cleansing means to accommodate high humidity conditions that might occur, so that the image(s) are not affected. In some embodiments, a plenum inlet air heater may be utilized to overcome some of this potential issue.

### Control

In some embodiments, the control system may capture, store, and trend key process and facility data including but not limited to ICV and off-gas temperatures, pressures, and flow rates. In some embodiments, data may be processed on-site in near real-time. In some embodiments, data and/or processed information may be transmitted to a remote location for long-term storage. In some embodiments, the control system may have a Human Machine Interface (HMI) to control relevant plant processes.

In some embodiments, one or more remote manipulators may be used to perform operations in the facility remotely. In some embodiments, one or more of silica sand, glass formers, graphite, glass frit, waste, and blended waste may be automatically metered at a controlled rate. The controlled rate may be a regular rate or automatically adjusted based on input from one or more sensors and/or imagers in the system.

### Other Process Embodiments and Further Descriptions

Various filter types are contemplated including, but not limited to, HEPA, SMF, HEMA, and HEGA. In some embodiments, one or more HEPA filters are capable of removing 99.7% of particles with diameters 0.3 μm or greater. Various valve types are contemplated. Valves may vary from the depicted process diagrams for differing flow rates and volumes and other design considerations. Additional valves, such as check valves, may be positioned throughout the system to prevent fluids from traveling in the wrong direction. Other valves, including automatic motor operated valves or redundant valves, may be included a various points in the process to provide increased factor of safety.

In some embodiments, provision for redundant processing may be made in one or more areas or processes in the system. Redundancy minimizes disruption to processing in the event of equipment malfunction may allow for parallel processing during normal operations. Example redundant processing equipment may include one or more of ICV melter station, ICV melter power supply, ICV feed and hoppers, off-gas filtration, and off-gas treatment fan, among others.

### Facility and Process Shielding Embodiments

General Facility shielding may be required between Zone 1 and 2 areas to accommodate expected dose rates from the waste and final glass product. In some embodiments, concrete walls are capable of shielding completed containers (undergoing cooling) in the Melter Process Area to dose rates suitable for continuous human occupation in the adjacent facility space. In some embodiments, steel walls surrounding the melt station reduce dose to a similar level of protection.

Feed piping between the Zone 1 Vessel Process Area and the Zone 1 Melt Station may also have relatively high dose and may require localized shielding, in some embodiments. Based on ICV container shielding requirements, it is expected that these process lines may require lead shielding, in some embodiments. The thickness of lead shielding may vary based upon activity level of the waste or melted waste. Commercial pneumatic transfer systems have proven non-stick surface treatments and remote pipe cleanout techniques that may be utilized to prevent buildup of feed materials and their associated source term.

Piping between the ICV container off-gas connection and the inlet to the SMF has the potential for buildup of particulate that can contain Cs particles, in some embodiments. Periodic water wash-down of the SMF filter “candles,” SMF interior walls, and SMF to ICV container piping section may be performed using built-in water spray nozzles. One or more localized radiation detectors may be used indicate when cleaning is required. In some embodiments, the wash-down rinseate gravity feeds directly onto the surface of an ICV container blended feed pile prior to vitrification. In some embodiments, slurry waste feeds without difficulty and additional water fed to the surface of the feed pile poses no operational difficulties.

In some embodiments, the highest facility dose is expected at the ICV container surface after completion of processing due to concentration of waste during vitrification.

In some embodiments, the Operations and Control Room is designated as a Zone 4 Radiation and Contamination Zone since there is no expectation of contamination or radiation other than natural background levels.

In some embodiments, the facility may be designed to withstand seismic, flood, wind, and fire conditions without catastrophic damage and maintaining containment.

In some embodiments, ventilation may cascade through negative pressure confinement zones with the highest contamination potential area being the most negative.

In some embodiments, the effective dose for workers is below 1 mSv/week in areas where workers constantly and regularly enter. Overpacks, temporary shielding, or other actions may be used to meet a maximum accumulated dose of 1 mSv/wk.

### Utility Requirements

In some embodiments, electrical service is the primary plant utility, providing power for each of the major systems including waste feeding, ventilation, off-gas treatment, ICV melt power, pumps, lighting, and other miscellaneous equipment. The melt transformer is sized to provide the maximum voltage and current that would reasonably be expected, based on specific waste and processing criteria. In some embodiments, backup power will be available in case of outage to maintain key system processes for containment and ventilation.

In some embodiments, plant water service is provided to the facility via standard supply lines. This is distributed to main process areas such as the blender hoppers for moisture addition, the Sintered Metal Filter (SMF) for internal wash-down as needed, the off-gas system wet scrubber, and for makeup water to the waste water treatment tank. Water may be used in other areas such as employee and cleaning facilities. Total nominal facility maximum flow rate is calculated based on maximum design capacity.

In some embodiments, plant air is provided to the facility to supply various process equipment including pneumatic transport, back-pulsing of filters and receivers, various instrumentation, and for general pressurized air service. The overall maximum facility usage is calculated based on maximum design capacity.

### Plant Efficiency and Throughput Embodiments

In some embodiments, two main activities drive the processing rate through the facility: 1) the time required for retrieval of waste from waste vessels, and 2) the calculated melt duration. The quantity of waste determines the number of vessels that need to be retrieved, emptied, and processed during one melt. In some embodiments, the facility may include two or more melt stations in parallel which may increase facility throughput. For instance, in some embodiments having two melt stations and utilizing 10 MT ICV containers, parallel processing may allow an ICV container to be transported from the facility every 3 days even though total waste receipt and melting time for a single container is 4.5 days.

### Cesium Distribution in the OGTS

In some embodiments, most of the Cs (not captured in glass) remains entrained in the off-gas and is captured on the particulate filters. In some embodiments, a small amount of this off-gas Cs (1% or less) may be captured on the internal off-gas system surfaces and does not reach the off-gas filters. Some embodiments may incorporate a relatively short and large diameter pipe that connects to an opening on the melter hood. This vertical pipe may allow the off-gas leaving the melter to travel more slowly than the minimum entrainment velocity for very fine powders, or less than 10 m/s. In some embodiments, the lower flow and vertical configuration are expected to further reduce the amount of Cs and particulate entering the off-gas system.

The melter off-gas enters the SMF that is located directly above the melter. The SMF has a HEPA efficiency of 99.97% and can backpulse and recycle Cs-laden particulate. It can also be internally washed with water, along with the inlet and recycle pipe. In addition, the ability to recycle and water wash may eliminate the concern for Cs buildup on the SMF, off-gas, and recycle pipe interiors, and minimize or eliminate Cs (source term) buildup issues.

### Restart of an Interrupted Melt

It is possible to restart a melt that has been interrupted for an extended period due to loss of external electrical supply or other equipment malfunction. The ability to successfully restart a solidified melt is required, in some embodiments. Glass may no longer conduct electricity after cooling below approximately 700° C. In some embodiments, the ICV container contents will remain above temperature for an extended period without power applied, however at some point after removal of power, it will solidify and no longer conduct electricity and allow joule heating to completely process a full ICV container.

In some embodiments, to restart an interrupted melt that has cooled, the glass frit hopper and feed system is used to first deposit glass frit and then graphite flake onto an interrupted melt surface. Since the frit loading hopper is in the Zone 3 ICV Preparation area, graphite flake (already used in starter path preparation, in some embodiments) can be added via the frit hopper immediately after a layer of frit has been deposited onto the surface of the melt.

### Silica Sand Handling System Embodiments

Silica sand is delivered in flexible bulk containers (supersacks), in some embodiments. In some embodiments, the supersacks may be lifted by forklift and placed into the Bulk Bag Unloaders with loss-weight capability. In some embodiments, there are two silica sand handling systems, one for silica sand that is used during ICV container preparation and the other which is used for filling the ICV container void space after processing in the Melt Station.

In some embodiments, the silica sand that is utilized for ICV container preparation is conveyed from the hopper by a chain drag type conveyor into a chute with a directional discharge trunk located over the ICV container. The chain drag conveyor inlet may be connected directly to the bottom of the Bulk Bag Unloader. Silica sand is placed between the Refractory Panels and ICV container on the bottom and four sides to fill the gap and form an additional freeze plane and thermal insulation layer. Dust management is provided by the ICV Preparation Area Dust Management system. All components described are located within the ICV Container Preparation Area.

The silica sand that is utilized for ICV Container void space filling may be conveyed from the hopper by a dilute phase pneumatic type conveyor into the silica sand/glass frit receiver, with loss-weight capability in some embodiments, (this is a shared receiver for both silica sand and glass frit streams, in some embodiments). The conveyor subsequently feeds into the ICV Container using the same inlet port as the blended waste receiver, in some embodiments. In some embodiments, the dilute phase pneumatic conveyor is fed by a rotary valve located on the bottom of the sand hopper/bulk bag unloader. Inlet air for the conveyor comes from the ICV Container Preparation Area through an inlet filter. The silica sand/glass frit receiver is in the Feed Area (may be referred to as the Feed Receipt and Blending Area, in some embodiments). The line connecting the hopper and receiver have valves to prevent backflow when the conveyor is not in use. In some embodiments, this receiver has an internal filter with air backpulse that discharges particulate back into the receiver itself. The outlet air passes first through a local single bag-in/bag-out type HEPA filter and then to vacuum pump, both located in the Feed Area. A bypass around vacuum pump allows the conveyance system to remain at a negative pressure when not in use. The vacuum pump discharges into the Feed Area Dust Management system, in some embodiments.

### Glass Frit and Glass Former Handling System Embodiments

Pre-blended glass frit and glass formers are delivered in supersacks, in some embodiments. The supersacks may be lifted by forklift and placed into the glass frit and glass former hoppers/bulk bag unloaders, with loss-weight capability in some embodiments. In some embodiments, there are two glass frit handling systems, one for glass frit that is used during ICV container preparation and the other which is sent to the ICV container in the Melt Station through silica sand/glass frit receiver. The glass former handling system is used for blending with waste in the blender hopper located in the Feed Area.

The glass frit is ground glass that has been formulated to support melt initiation, melt restart, and as a final top-off batch added at the end of melt processing. The glass frit utilized for ICV container preparation is conveyed from the hopper by a chain drag type conveyor into a chute with a directional discharge trunk located over the ICV container, in some embodiments. The chain drag conveyor inlet is connected directly to the bottom of the glass frit bulk bag unloader, in some embodiments. Glass frit is placed in a layer at the bottom of the melt zone below and above the graphite starter path installed between the electrodes. Dust management is provided by the ICV Preparation Area Dust Management system. All components described are located within the ICV Container Preparation Area.

The glass frit that is added on top of the feed mixture at the end of waste feed processing is conveyed from the hopper by a dilute phase pneumatic type conveyor into the silica sand/glass frit receiver, with loss-weight capability in some embodiments (note this is a shared receiver for both silica sand and glass frit streams). The conveyor subsequently feeds into the ICV container using the same inlet port as the blended waste receiver, in some embodiments. The dilute phase pneumatic conveyor is fed by a rotary valve located on the bottom of the glass frit bulk bag unloader, in some embodiments. Inlet air for the conveyor comes from the ICV container Preparation Area through an inlet filter. The silica sand/glass frit receiver is in the Feed Area. The line connecting the hopper and receiver have valves to prevent backflow when the conveyor is not in use. In some embodiments, this receiver has an internal filter with air backpulse that discharges particulate back into the receiver itself. The outlet air passes first through a local single bag-in/bag-out type HEPA filter and then to vacuum pump, both located in the Feed Area, in some embodiments. A bypass around vacuum pump allows the conveyance system to remain at a negative pressure when not in use. The vacuum pump discharges into the Feed Area Dust Management system.

The glass formers that are mixed with feed to produce the appropriate glass recipe are fed to blender hopper. They are conveyed from the hopper by a dilute phase pneumatic type conveyor into the glass former receiver, with loss-weight capability in some embodiments. The conveyor subsequently feeds into the blender hopper. The dilute phase pneumatic conveyor is fed by a rotary valve located on the bottom of the glass former bulk bag unloader, in some embodiments. Inlet air for the conveyor comes from the ICV Container Preparation Area through an inlet filter. The glass former receiver is in the Feed Area. The line connecting the hopper and receiver have valves to prevent backflow when the conveyor is not in use. This receiver has an internal filter with air backpulse that discharges particulate back into the hopper itself, in some embodiments. The outlet air passes first through a local single bag-in/bag-out type HEPA filter and then to vacuum pump, both located in the Feed Area, in some embodiments. A bypass around vacuum pump allows the conveyance system to remain at a negative pressure when not in use. The vacuum pump discharges into the Feed Area Dust Management system.

### Dust Management—ICV Container Preparation Area Embodiments

In some embodiments, the ICV Container Preparation Area Dust Management system is for non-contaminated materials only. It may be connected to the sand bulk bag unloader and the glass frit bulk bag unloader used during ICV Container Preparation, keeping them at a negative pressure relative to the area. Local dust collection trunks provide further dust remediation as needed during ICV container preparation. A minimum flow branch keeps the flow within the allowable band required by the filters and blower. Inflows connect to a common plenum in the ICV Container Preparation Area. Downstream, the system consists of a backpulsing roughing filter followed by a single prefilter/HEPA filter and fan which exhausts to the stack. All components described are located within the ICV Container Preparation Area.

### Sorption Vessel Access—Remote Manipulator Embodiments

To facilitate extraction of difficult to remove waste, dry and wet retrieval systems may be incorporated into the Sorption Vessel Process Area. Dry vacuum retrieval will generally be attempted first with the intent to remove all of the contained waste and verified by post-retrieval visual (remote camera) inspection, in some embodiments. If additional waste remains, wet retrieval using a water sluicing tool and/or vacuum may be employed to dislodge and retrieve the remaining waste.

In some embodiments, a remote manipulator is used for waste vessel access and may maneuver in XYZ directions with rotation for waste vessel access tooling, dry waste retrieval tool, and wet waste removal tool. For spent sorption vessels, the retrieval tools may be used to reinstall the vessel shield cover, access the waste area through the top flange, and install a plug after the waste has been removed. A bypass around vacuum pump allows the conveyance system to remain at a negative pressure when not in use. The vacuum pump discharges into the Feed Area Dust Management system.

The tooling has a common interface with the remote manipulator end effector to allow for remote changeout, in some embodiments. Actions may be pre-programmed and automated along with the ability for manual operation, in some embodiments. All components described are located within the Sorption Vessel Process Area.

### Dry Waste Removal Embodiments

Once a spent sorption vessel has been accessed using the waste access tools located in the Sorption Vessel Process Area, the spent sorption vessel may be positioned by the remote manipulator as required to remove vessel waste. The dry waste retrieval tool is a hollow rigid tube with end features to enable dislodging of caked waste, sine some embodiments. The dry waste removal tool may be connected to the pneumatic conveyance system and may include a radiation tolerant imaging system to facilitate positioning and verify waste removal. The waste is conveyed by a dilute phase pneumatic type conveyor into the dry waste receiver, with loss-weight capability in some embodiments. The conveyor subsequently feeds into the blender hopper, both located in the Feed Area. Additionally, the dry waste receiver is attached to the decontamination tool located in the ICV Container Disposition Area, in some embodiments. The dry waste receiver has an internal filter with air backpulse that discharges particulate back into the receiver itself, in some embodiments. Inlet air for the pneumatic conveyor comes from the Sorption Vessel Process Area vessel shroud via bag in/bag out single pre-filter single HEPA filter and is used around the vessel opening to contain any dust. In some embodiments, the outlet air passes first through a local single bag-in/bag-out type HEPA filter and then to vacuum pump, both located in the Feed Area. A bypass around vacuum pump allows the conveyance system to remain at a negative pressure when not in use. The vacuum pump discharges into the Feed Area Dust Management system.

### Wet Waste Removal Embodiments

If a spent sorption vessel has been processed in dry waste removal and some waste remains the spent sorption vessel may be positioned by the remote manipulator as required to remove remaining vessel waste. In some embodiments, the wet waste retrieval tool is a hollow rigid tube with nozzle features for introduction of sluice water. The wet waste retrieval tool is connected to the air/waste/water separator and includes a radiation tolerant imaging system to facilitate positioning and verify waste removal, in some embodiments. Sluice water is provided by feed pump located in the Waste Water Treatment Area. In some embodiments, the waste is conveyed by a dilute phase pneumatic type conveyor into the air/waste/water separator. The retrieval process operates in a batch mode governed by the fill/empty volume of the air/waste/water separator, in some embodiments. Separated waste goes to the conveyor (chain drag type, in some embodiments) and subsequently to the wet waste hopper, with loss-weight capability in some embodiments, which feeds into the blender hopper. Separated air passes first through a local single bag-in/bag-out type HEPA filter and then to vacuum pump. The air/waste water separator, conveyor, and wet waste hopper are in the ICV Feed/Sorption Vessel Process Area.

Separated water goes to water tank, located in the Waste Water Treatment Area, and is cycled through an ion exchange vessel for radionuclide removal for re-use during the next wet retrieval, in some embodiments. Inlet air for the conveyor comes from the wet waste retrieval tool shroud, which is used around the vessel opening to contain any mist. A bypass around vacuum pump allows the conveyance system to remain at a negative pressure when not in use. The vacuum pump discharges into the Feed Area Dust Management system.

### Waste and Glass Former Blending and Feeding Embodiments

The blender hopper receives material from the glass former receiver, dry waste receiver, and wet waste hopper, blends received materials to achieve a homogenous mixture according to a prescribed recipe and adjusts moisture content to achieve nominally 10 wt % (in some embodiments), feed system evaluation. The blended waste is conveyed from the blender hopper by a conveyor (dilute phase pneumatic type, in some embodiments) into the one or more blended waste receiver located above the one or more Melt Station, each with loss-weight capability, in some embodiments. A diverter may direct the blended waste into the appropriate receiver as needed to feed directly into the selected ICV container. The dilute phase pneumatic conveyor is fed by a rotary valve located on the outlet of the blender hopper, in some embodiments. Inlet air for the conveyor comes from the Feed Area through an inlet filter. This receiver may have an internal filter with air backpulse that discharges particulate back into the hopper itself. The outlet air passes first through a local single bag-in/bag-out type HEPA filter and then to a vacuum pump. The blended waste exits the blended waste receiver and feeds the ICV container at the Melt station by means of a rotary valve and gate valve system, in some embodiments. All equipment is in the ICV Melt/Feed Areas. A bypass around the vacuum pump allows the conveyance system to remain at a negative pressure when not in use. The vacuum pump discharges into the Feed Area Dust Management System.

### Dust Management—Feed Area Embodiments

The Feed Area Dust Management system is for materials which have the potential to be contaminated. It is connected to one or more of the glass former receiver, dry waste receiver, wet waste hopper, blender hopper, blended waste receivers, silica sand/glass frit receivers, water tank, and chemistry adjustment tank, keeping them at a negative pressure relative to the area. A minimum flow branch may keep the flow within the allowable band required by the filters. Inflows for the blended waste conveyor (pneumatic, in some embodiments) and minimum flow branch go through a bag-in/bag-out single prefilter/HEPA filter. All connections are routed to a common plenum, in some embodiments. Downstream, the system may comprise a redundant bag-in/bag-out single prefilter/dual HEPA filter and/or redundant fans which exhaust to the stack. All components described are located within the ICV Feed/OGTS/Waste Water Treatment Area.

### ICV Container Preparation Embodiments

In some embodiments, the ICV container is designed to be stackable and able to withstand hydraulic and thermal loads of molten glass and the weight of the total contents of the cast refractory, silica sand, glass, and top-off materials. The ICV container is compatible with the Removable Shield Panels [ref. U.S. Pat. No. 10,311,989 B2] and can be stacked for storage with the outermost metal shell providing structural support. The next inward silica sand layer on the sides and bottom provides support for the cast refractory layer. Molten glass directly contacts the inside surface of the cast refractory, and the cast refractory and silica sand layers are designed to serve as thermal freeze planes to prevent molten glass reaching the outer steel container, should a crack develop in the refractory layer.

All components of the ICV container may be assembled in the ICV Container Preparation Area. In some embodiments, the ICV container is assembled on a transport cart. An ICV container is prepared for use by first installing base thermocouples and a base silica sand and refractory support layer. Base and side wall refractory panels are then installed and joined using a refractory grout material at each of the seams. Side wall thermocouples and silica sand are then added to the annular layer between the refractory panels and steel side walls. Glass frit and starter path material are then added before the ICV lid is secured to the ICV container. Lid installation is followed by installation of electrodes and the in-melt thermocouple well.

The space inside the cast refractory is referred to as the ICV Treatment Zone. Fixed electrodes protrude up through the metal lid and interface with electric contactors in the Melt Station. The electrodes extend to near the bottom of the ICV Treatment Zone. Thermocouples are used to measure process temperatures throughout the ICV container.

The ICV container metal lid may comprise penetrations to accommodate one or more of the following: electrodes, feed from blended waste receivers and silica sand/glass frit receivers, process inlet air from filters, process off-gas to SMFs, particulate from SMFs backpulse, in-melt camera, thermocouple wire pass-through, temperature monitoring, and pressure monitoring.

### Melt Station Embodiments

The Melt Station is where the VPC ICV process occurs. In some embodiments, there are two or more Melt Stations located within the Melt Area. The interfacing systems may be designed such that one Melt Station can be processing waste while another Melt Station is being prepared for the next melt. Two or more Melt Station processes may be coordinated to achieve maximum facility throughput.

A prepared ICV container may be delivered on a transport cart to the internal ventilation Zone I side of the Melt Station. The Melt Station hood provides a process ventilation seal to the ICV Treatment Zone and contains all Zone II to Zone I-penetrating interfaces. The ventilation seal may be established remotely and isolates the ICV container plenum process ventilation area from the surrounding Zone I and Zone II ventilation areas.

The Zone II to Zone I penetrating interfaces include the silica sand/glass frit receiver, blended waste receiver, SMF and inlet HEPA filter, camera, and transformer, in some embodiments. One or more interfaces may be connected remotely.

Once all interfacing connections are made, blended feed may be added to the ICV container from the blended waste receiver to establish a starting volume of waste to process. Power is supplied from the transformer to start the melt. Additional blended feed may be added to maintain a suitable cold cap. One or more cameras and/or other imagers allow one or more operators (in the control room, in some embodiments) to observe the ICV Treatment Zone during the melt. After the designated amount of total blended feed has been added, glass frit may be added to the ICV container from the silica sand/glass frit receiver to maintain the cold cap through final processing of the blended feed. The remaining glass frit layer is then processed until all material has been vitrified. Electrode power is then removed and the ICV container remains in place until it has cooled to a designated temperature. Silica sand is added, if necessary, from the silica sand/glass frit receiver to fill any remaining void space. All interfaces are disconnected remotely and the ICV container is moved to the ICV Container Cooling Area.

### Facility Ventilation Embodiments

The Facility Ventilation system maintains cascading negative pressure differential between zones as appropriate to control the spread of contamination, in some embodiments. In some embodiments, pressure differential zones are as follows:

Zone I—Areas which are Normally Contaminated.
Inside equipment which processes vessel waste directly or indirectly
Inside OGTS
ICV Melt Area
Sorption Vessel Process Area
   Zone II—Areas which are Potentially Contaminated.
Inside equipment located in Zone II Areas which does not process vessel waste directly or indirectly
ICV Container Melt Airlocks
Sorption Vessel Airlock
ICV Feed/OGTS/Waste Water Treatment Area
Waste Water Treatment Area
   Zone III—Areas which are Normally Clean.
Inside bulk bag unloaders for silica sand, glass formers, and glass frit
ICV Container Preparation Airlock
ICV Container Preparation Area
Operator Control Room and Offices
ICV Container Release Area
ICV Container Release Airlock
   Zone IV—Areas which are Always Clean.
Truck-Lock

The facility ventilation system comprises one or more of an air handling unit to condition incoming air, dampers, and other control equipment to maintain pressure differentials between zones. One set of redundant bag-in/bag-out single pre-filter/single HEPA filters with redundant fans is used for Zone II general outflow to stack, in some embodiments. A second similar setup of redundant bag-in/bag-out single pre-filter/single HEPA filters with redundant Fans is used for Zone I general outflow to stack, in some embodiments. Inlet air for the Zone I is provided from Zone II through a redundant bag-in/bag-out single pre-filter/HEPA filter, in some embodiments. Minor amounts of air may pass through the airlocks.

The operator control room ventilation may be limited to the control room located in the ICV Container Preparation Area and is considered Zone III, in some embodiments. This system recycles air within the control room and does not pull fresh air from outside the facility, but rather from the larger ICV Container Preparation Area. The system consists of an air handling unit with integral fan, in some embodiments.

The exhaust stack receives flow streams from one or more of Zone I Facility Ventilation, Zone II Facility Ventilation, Dust Control-Non-Rad, dust control-Rad, and OGTS systems. The stack has provisions for regulatory and exhaust flow monitoring, in some embodiments. The stack design may provide for appropriate height and diameter to maintain adequate gas velocity and minimize disturbances to local air conditions.

### Off-Gas Treatment System (OGTS) Embodiments

The OGTS refers to the system associated with the VPC process when the ICV container is at the Melt Station. In some embodiments, redundant inlet air bag-in/bag-out single pre-filter/single HEPA filters supply heated air from the ICV Melt/Feed Area to a heater which feeds both the ICV container and the process air stream between the ICV container and the SMFs. Each of these streams are individually controlled with flow control valves. The streams may be controlled to maintain desired ICV container plenum sweep air, ICV container plenum vacuum, and to regulate humidity upstream of the SMFs.

The SMFs may utilize air backpulse to clean individual filter elements. The backpulse may be segmented and sequenced in order to minimize the effect on ICV container negative pressure and to maintain the filter as operational during cleaning cycles. The filter is located above the ICV container such that particulate dislodged from the backpulse may gravity feed back into the ICV container to be incorporated into the glass matrix.

The clean side outlets from the SMFs may be combined and directed to the wet scrubber. In some embodiments, the wet scrubber may be a packed bed type. The wet scrubber may use high-efficiency packed media and counter-current flow to maximize contact between the scrubbing liquid and off-gas, in some embodiments. The wet scrubber may be operated using a slightly caustic solution to mitigate any halogenated gases that may be generated. An integral high efficiency mist eliminator reduces carryover of droplets as the off-gas exits the scrubber and enters the heater, in some embodiments. Water from this wet scrubber may be treated using the Waste Water Treatment System. The heater may be used to raise the temperature of the off-gas stream sufficiently to eliminate any condensation from forming in the downstream redundant bag-in/bag-out single pre-Filter/dual HEPA filter. The filter outlet passes through one of two redundant fans, in some embodiments, and out of the stack. All OGTS components except the stack and stack monitoring equipment are located within the ICV Melt/Feed/OGTS Area.

### ICV Container Transport Embodiments

The re-usable transport carts support the ICV container and shielding and provides movement throughout the VPC facility on a two-rail track system, in some embodiments. In some embodiments, the transport cart has self-contained electric-powered wheels and follows a pre-programmed sequence along a track system. The track system comprises straight rails and turntables as well as proximity sensors for accurate positioning of the transport cart, in some embodiments. The bottom shield lifting plate may be installed between the ICV container and transport cart and has lift points to lift the ICV container and removable shields assembly off of the transport cart and onto a truck for transport to the storage location outside of the VPC facility.

After the bottom shield lifting plate, ICV container, and removable shields assembly is lifted off the transport cart, the transport cart is returned to the ICV Container Preparation Area. The bottom shield lifting plate and a portion of the removable shields may be returned to the VPC facility ICV container Preparation Area after the ICV container has been transported to storage. Decontamination of equipment may be performed as needed at key steps to ensure cross-contamination does not occur at any stage of the process.

### Waste Water Treatment Embodiments

Waste Water Treatment includes equipment to treat wet scrubber water as well as to provide water used in wet waste retrieval in the Sorption Vessel Process Area. Water from the wet scrubber may be pumped to the pH adjustment tank and treated as needed. Chemicals may be added to an actively mixed pH adjustment tank and then the water may be pumped using an ion exchange feed pump through the ion exchange vessel and can be directed either to the water tank or wet scrubber as needed. A small stream of water may be siphoned off as secondary waste to prevent buildup of contaminants, such as dissolved solids, in the system.

Water from the air/waste/water separator may be received in the water tank and pumped back to the wet waste retrieval tools using the wet retrieval feed pump to provide a recycled sluice water loop for vessel waste removal, in some embodiments. When the activity level of the water rises and needs to be treated, water from the water tank may be pumped by the ion exchange feed pump through the ion exchange vessel and back to the water tank. Water treatment through the ion exchange vessel may occur separately for each process, i.e. wet scrubber water treatment may be suspended while water from the water tank is being processed. All components described are located within the Waste Water Treatment Area.

### In-Situ Vitrification Processes

In some embodiments, many of the systems and methods described above can be applied to in-situ vitrification processes. In-situ vitrification comprises the vitrification of polluted soils, radioactive wastes, hazardous wastes, and landfilled wastes in place using technology such as VPC In-Situ Vitrification (ISV)™. In ISV, two or more electrodes are positioned beneath the ground surface in the area to be treated. In some embodiments, the two or more electrodes are oriented vertically. Electrical power is applied to the two or more electrodes generating a joule effect which increases the temperature of the wastes and/or soils until they reach melting temperature and melt. Melting temperature may vary between embodiments based on the composition of the material(s) to be treated. In some embodiments, the molten mass spreads downwards as the material(s) to be treated become denser and form molten glass. In some embodiments, two or more melting zones may be combined to form a single bed zone. In some embodiments, vitrification results in the complete incorporation of the various wastes contained in the subsoil (containers, objects, wastes, and/or debris) to form a homogeneous block of glass or a two-phase compound glass-metal phase in the presence of metals.

The convective currents present during melting due to the thermal gradients between the molten mass and the surrounding soil ensure the homogeneity of the final glass. The process is completed when the electrodes reach the intended target depth that coincides with the determined base, below the waste zone, in some embodiments. In some embodiments, the in-situ melt may be carried out from the bottom up. Bottom-up melting ensures that trapped gases can escape upward and into an off-gas treatment system without being passed through molten glass. In some embodiments, two or more subsurface bottom-up melts may be joined to form a single melt once they have been established. The end result of the process is a dense glass monolith with high-performance chemical durability. Organic wastes are destroyed in the molten mass by thermal processes and radionuclides and toxic metals are directly incorporated into the glass matrix, which gives it a high leaching performance.

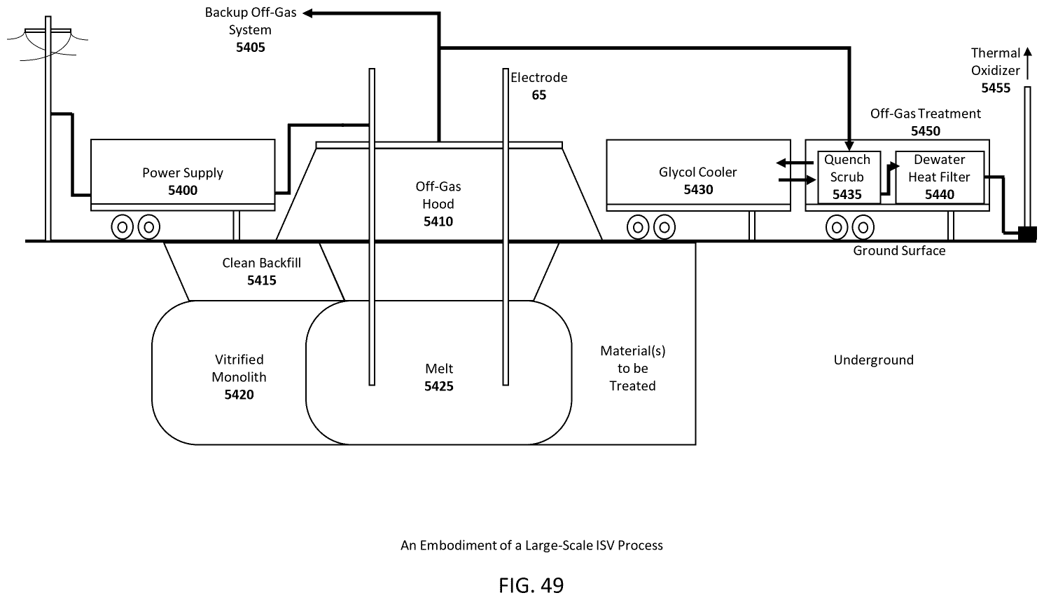

An embodiment of a large-scale ISV process is depicted in FIG. 49. In the depicted embodiment, power supply 5400 supplies power to the two or more electrodes 65. The two or more electrodes 65 extend into the melt 5425. As the system proceeds along a melt path vitrified monolith 5420, which is the glass product containing entrained contaminants after the melt, is left behind. Clean backfill 5415 is placed over the vitrified monolith 5420. Ahead of the melt, there may still be more material(s) to be treated, depending on the size of the melt area as well as the size of the processing equipment. Process gases are captured in the off-gas hood 5410 and processed either in the off-gas treatment system 5450 or the backup off-gas treatment system 5405. In the depicted embodiment, the off-gas treatment system 5450 comprises a first quench scrub 5435 step then to a dewater heat filter 5440. In some embodiments, gases travel back and forth between a glycol cooler 5430 and the quench scrub 5435 step. Gases may proceed from the off-gas treatment system 5450 to a thermal oxidizer 5455 where they may then be released to the environment. In the depicted embodiment, the power supply 5400, glycol cooler 5430, and the off-gas treatment system 5450 are mobile systems that may be moved, removed, or added as needed. In some embodiments, the off-gas hood 5410 may be equipped with means to move along a melt path or to another melt location. In some embodiments, the entire system is mobile to be easily transported and set up at different locations.

In some embodiments, the two or more electrodes are powered by a transformer. In some embodiments, the transformer is at least one of 300 kVA dry and fan cooled. The transformer receives an incoming three-phase voltage connected in a triangle and transforms it into a two-phase power supply with a phase separation of ninety (90) degrees. This two-phase output design allows a homogeneous supply of a square section area, allowing for fairly precise geometric control of the fusion parameters. In some embodiments, the transformer is equipped with several secondary outlets and a silicon-controlled rectifier (SCR) digital voltage controller. This allows the transformer to precisely adjust to the load impedance of the molten mass, allowing precise voltage control as the amperage increases with the mass. e of molten glass.

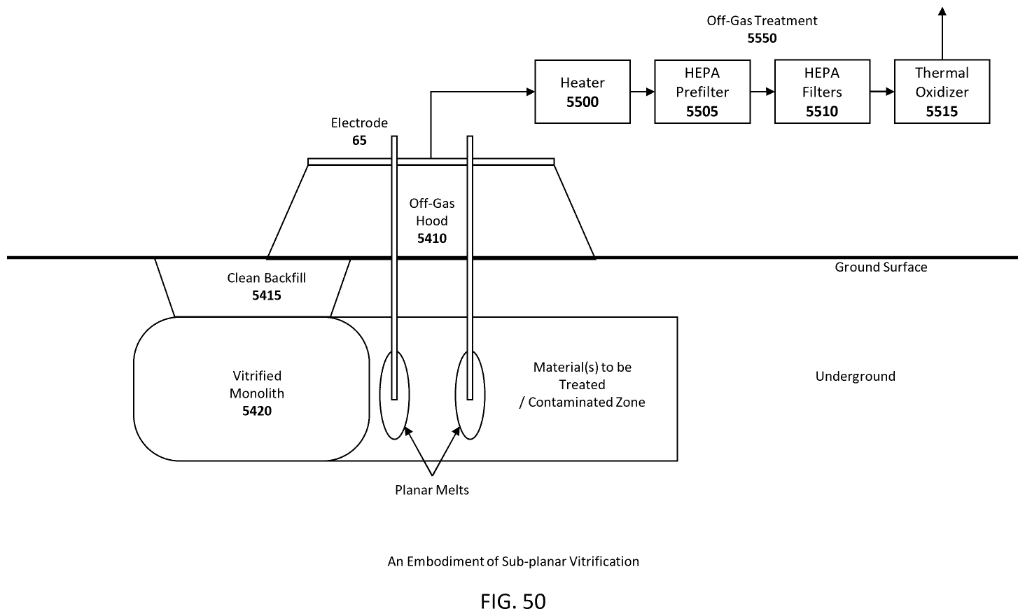

FIG. 50 depicts an embodiment of Subsurface Planar Vitrification (SPV™). SPV is similar to the large-scale vitrification process depicted in FIG. 49, further comprising placement of a starter path between two or more electrodes 65 which reduces steam excursions. The two or more electrodes 65 extend through the off-gas hood 5410 and into the material(s) to be treated. Planar melting occurs at the bases of the two or more electrodes 65 and is initiated after injection of a starter path between each pair of electrodes. As the system proceeds along a melt path vitrified monolith 5420, which is the glass product containing entrained contaminants after the melt, is left behind. Clean backfill 5415 is placed over the vitrified monolith 5420. Off-gases gathered in the off-gas hood 5410 proceed to a heater 5500, a prefilter (HEPA, in some embodiments) 5505, one or more filters (HEPA, in some embodiments) 5510 and a thermal oxidizer 5515 in the off-gas treatment system 5550.

In some embodiments, the surrounding environment around the process area is equipped with one or more thermocouples or other temperature measurement devices, allowing horizontal and vertical temperature gradients to be recorded and monitored.

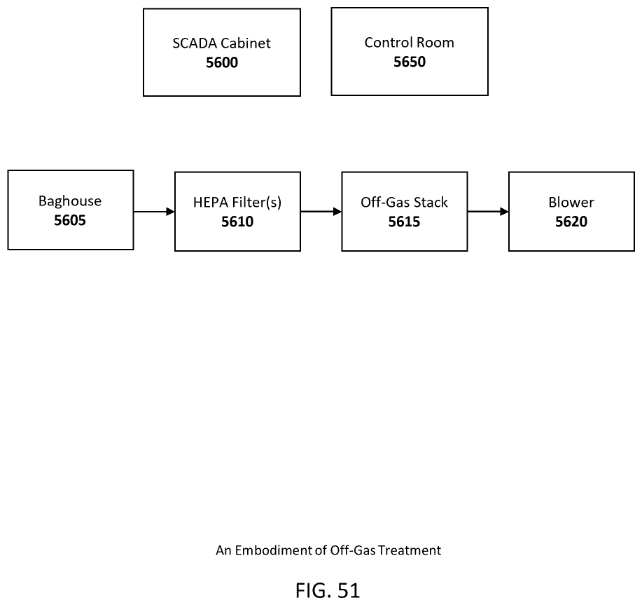

In some embodiments, an off-gas treatment system may be used to treat gases and discharge them into the environment. In some embodiments, the off-gas treatment system is operated at negative pressure. FIG. 51 depicts an embodiment of an off-gas treatment system for ISV. The depicted embodiment comprises a supervision control and data acquisition (SCADA) system cabinet 5600, a control room 5650, a baghouse 5605, one or more filters 5610, which may be HEPA in some embodiments, an off-gas stack 5615, and a blower 5620. These systems may connect to a containment, or off-gas, hood, that covers the area being processed, in some embodiments. The hood may be used to collect and direct emissions from the process into the off-gas treatment system. In some embodiments, negative pressure is maintained in the plenum. In some embodiments, the hood also serves as a platform for supporting the two or more electrodes and associated wiring and instrumentation. In some embodiments, the off-gas treatment system further comprises one or more of the following components: a bag filter, a high-efficiency particulate filter (HEPA), an extractor fan, and a chimney for the evacuation of gaseous effluents without particles in the atmosphere. In some embodiments, a bag filter is primarily used for the removal of dust. In some embodiments, a HEPA filter is used for removal of secondary particles. In some embodiments, an extractor fan is used to keep the hood in depression and evacuates gases.

In some embodiments, the in-situ vitrification system comprises one or more sensors and/or measuring devices for monitoring the process.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims.

### Illustrative Embodiments

The following is a description of various embodiments of the disclosed subject matter. Each embodiment may include one or more of the various features, characteristics, or advantages of the disclosed subject matter. The embodiments are intended to illustrate a few aspects of the disclosed subject matter and should not be considered a comprehensive or exhaustive description of all possible embodiments.

P1. A waste processing system, comprising any combination of one or more of the following: a sorption vessel process area wherein sorption vessels containing spent media are accessed and the spent media is removed; a container preparation area wherein a container is prepared for in container vitrification processes; a feed area wherein one or more of spent media from the sorption vessel process area, recycled waste from one or more system areas, and one or more of glass frit, silica sand, and glass formers, are blended to form blended waste; a melt area wherein blended waste is metered into a prepared container from the container preparation area as power is applied to two or more electrodes resulting in a processed container containing vitrified glass product with entrained contaminants; a container cooling area wherein the processed container is cooled; a container disposition area wherein the processed container is one or more of surveyed, decontaminated, sealed, shielded, and prepared for storage; a container release area wherein the processed container is prepared for transport to storage; an off-gas treatment system area wherein off-gases from one or more system areas is processed; and a waste water treatment area wherein waste water from one or more system areas is processed.

P2. The waste processing system of paragraph P1, further comprising a control room wherein the control room is operable for one or more of controlling operations in the waste processing system and monitoring operations in the waste processing system.

P3. The waste processing system of paragraph P2, further comprising a human machine interface.

P4. The waste processing system of any one of paragraphs P1-P3, wherein the sorption vessel process area comprises one or more of vessel access tooling, a dry waste retrieval system, or a wet waste retrieval system.

P5. The waste processing system of paragraph P4, wherein the vessel access tooling comprises one or more of a shearing tool or a gripper.

P6. The waste processing system of any one of paragraphs P4-P5, wherein the dry waste retrieval system comprises a vacuum wand with edges to aid in removal of spent media.

P7. The waste processing system of any one of paragraphs P1-P6, further comprising one or more sensors.

P8. The waste processing system of paragraph P7, wherein the one or more sensors comprise one or more of contact sensors, non-contact sensors, capacitive sensors, inductive sensors, 3D imager, fiber optic cable, camera, thermal imager, thermometer, pressure sensor, accelerometer, inertial measurement unit (IMU), rotary encoder, radiation detector, LIDAR, or strain sensors.

P9. The waste processing system of paragraph P8, wherein the fiber optic cable is placed in the prepared container with the blended waste and uses Raleigh backscatter to determine at least one of temperatures of a melt, depth of melt activity, or progress of melt activity.

P10. The waste processing system of any one of paragraphs P1-P9, wherein the container preparation area is operably configured to perform any combination of one or more of the following: install one or more of a silica sand layer and a refractory base to the container; install refractory side panels to the container; install a starter path in the container; install one or more of two or more electrodes, one or more thermocouples, one or more sensors, or a lid to the container; and stage the container for the melt area.

P11. A waste processing system, comprising any combination of one or more of the following: a container preparation area wherein a container is prepared for in container vitrification processes; a feed receipt and blending area wherein one or more of asbestos or recycled waste from one or more system areas, and one or more of glass frit, silica sand, or glass formers, are blended to form blended waste; a melt area wherein blended waste is metered into a prepared container as power is applied to two or more electrodes resulting in a processed container containing vitrified glass product with entrained contaminants; a container cooling area wherein the processed container is cooled, and wherein lid openings are sealed using one or more of a permanent disposal cover or one or more process port covers; a container disposition area wherein the processed container is one or more of surveyed, decontaminated, shielded, or prepared for storage; a container release area wherein the processed container is prepared for transport to storage; an off-gas treatment system area wherein off-gases and secondary wastes from one or more system areas is processed; and a water treatment area wherein water from one or more treatment system areas is processed.

P12. The waste processing system of paragraph P11, wherein the blended waste includes asbestos waste and the asbestos waste is at least one of ground, milled, or shredded.

P13. The waste processing system of any one of paragraphs P11-P12, further comprising one or more remote manipulators for performing operations in the one or more system areas remotely.

P14. The waste processing system of any one of paragraphs P11-P13, further comprising a control room wherein the control room is operable for one or more of controlling operations in the waste processing system and monitoring operations in the waste processing system.

P15. The waste processing system of paragraph P14, further comprising a human machine interface.

P16. The waste processing system of any one of paragraphs P11-P15, wherein the container preparation area is operably configured to perform any combination of one or more of the following: install one or more of a silica sand layer or a cast refractory layer, resulting in a refractory lined container; install a starter path in the refractory lined container; install one or more of two or more electrodes, one or more thermocouples, one or more sensors, or a lid to the container; and stage the container for the melt area.

P17. The waste processing system of any one of paragraphs P11-P16, further comprising one or more sensors.

P18. The waste processing system of paragraph P17, wherein the one or more sensors comprise one or more of contact sensors, non-contact sensors, capacitive sensors, inductive sensors, 3D imager, fiber optic cable, camera, thermal imager, thermometer, pressure sensor, accelerometer, inertial measurement unit (IMU), rotary encoder, radiation detector, LIDAR, or strain sensors.

P19. The waste processing system of paragraph P18, wherein the camera is an IR camera, and wherein the IR camera includes one or more of heat or radiation shielding.

P20. The waste processing system of any one of paragraphs P18-P19, wherein the fiber optic cable is placed in the prepared container with the blended waste and uses Raleigh backscatter to determine at least one of temperatures of a melt, depth of melt activity, or progress of melt activity.

### General Terminology and Interpretative Conventions

Any methods described in the claims or specification should not be interpreted to require the steps to be performed in a specific order unless expressly stated otherwise. Also, the methods should be interpreted to provide support to perform the recited steps in any order unless expressly stated otherwise.

Certain features described in the context of separate embodiments can also be implemented in combination in a single embodiment. Conversely, various features that are described in the context of a single embodiment can also be implemented in multiple embodiments separately or in any suitable subcombination. Moreover, although features may be described above in certain combinations and even initially claimed as such, one or more features from a claimed combination can be excised from the combination, and the claimed combination may be directed to a subcombination or variation of a subcombination.

The example configurations described in this document do not represent all the examples that may be implemented or that are within the scope of the claims. The term “example” shall be interpreted to mean “serving as an example, instance, or illustration,” and not “preferred” or “advantageous over other examples.”

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all the items together, or any combination or number of the items.

The phrase “based on” shall be interpreted to refer to an open set of conditions unless unequivocally stated otherwise (e.g., based on only a given condition). For example, a step described as being based on a given condition may be based on the recited condition and one or more unrecited conditions.

The terms have, having, contain, containing, include, including, and characterized by should be interpreted to be synonymous with the terms comprise and comprising—i.e., the terms are inclusive or open-ended and do not exclude additional unrecited subject matter. The use of these terms should also be understood as disclosing and providing support for narrower alternative embodiments where these terms are replaced by “consisting of” or “consisting essentially of.”

Unless otherwise indicated, all numbers or expressions, such as those expressing dimensions, physical characteristics, or the like, used in the specification (other than the claims) are understood to be modified in all instances by the term “approximately.” At the very least, and not as an attempt to limit the application of the doctrine of equivalents to the claims, each numerical parameter recited in the specification or claims which is modified by the term “approximately” should be construed in light of the number of recited significant digits and/or by applying ordinary rounding techniques.

All disclosed ranges are to be understood to encompass and provide support for claims that recite any subranges or any individual values subsumed by each range. For example, a stated range of 1 to 10 should be considered to include and provide support for claims that recite any subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth), which values can be expressed alone or as a minimum value (e.g., at least 5.8) or a maximum value (e.g., no more than 9.9994).

All disclosed numerical values are to be understood as being variable from 0-100% in either direction and thus provide support for claims that recite such values (either alone or as a minimum or a maximum—e.g., at least <value> or no more than <value>) or any ranges or subranges that can be formed by such values. For example, a stated numerical value of 8 should be understood to vary from 0 to 16 (100% in either direction) and provide support for claims that recite the range itself (e.g., 0 to 16), any subrange within the range (e.g., 2 to 12.5) or any individual value within that range expressed individually (e.g., 15.2), as a minimum value (e.g., at least 4.3), or as a maximum value (e.g., no more than 12.4).

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used in this document shall mean” or similar language (e.g., “this term means,” “this term is defined as,” “for the purposes of this disclosure this term shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained in this document should be considered a disclaimer or disavowal of claim scope.

None of the limitations in the claims should be interpreted as invoking 35 U.S.C. 112(f) unless the words “means for” or “step for” are explicitly recited in the claim.

Unless explicitly stated otherwise or otherwise apparent from context, terms such as “processing,” “computing,” “calculating,” “determining,” “displaying,” or the like, refer to the action and processes of an electronic computing device including a processor and memory.

The subject matter recited in the claims is not coextensive with and should not be interpreted to be coextensive with any embodiment, feature, or combination of features described or illustrated in this document. This is true even if only a single embodiment of the feature or combination of features is illustrated and described.

### Drawing Related Terminology and Interpretative Conventions

Reference numbers in the drawings and corresponding description refer to identical or similar elements although such numbers may be referenced in the context of different embodiments.

The drawings are intended to illustrate embodiments that are both drawn to scale and/or not drawn to scale. This means the drawings can be interpreted, for example, as showing: (a) everything drawn to scale, (b) nothing drawn to scale, or (c) one or more features drawn to scale and one or more features not drawn to scale. Accordingly, the drawings can serve to provide support to recite the sizes, proportions, and/or other dimensions of any of the illustrated features either alone or relative to each other. Furthermore, all such sizes, proportions, and/or other dimensions are to be understood as being variable from 0-100% in either direction and thus provide support for claims that recite such values or any ranges or subranges that can be formed by such values.

Spatial or directional terms, such as “left,” “right,” “front,” “back,” or the like, relate to the subject matter as it is shown in the drawings and/or how it is commonly oriented during manufacture, use, or the like. However, it is to be understood that the described subject matter may assume various alternative orientations and, accordingly, such terms are not to be considered as limiting.

### INCORPORATION BY REFERENCE

The entire content of each document listed below is incorporated by reference into this document (the documents below are collectively referred to as the “incorporated documents”). If the same term is used in both this document and one or more of the incorporated documents, then it should be interpreted to have the broadest meaning imparted by any one or combination of these sources unless the term has been explicitly defined to have a different meaning in this document. If there is an inconsistency between any incorporated document and this document, then this document shall govern. The incorporated subject matter should not be used to limit or narrow the scope of the explicitly recited or depicted subject matter.

### PRIORITY PATENT DOCUMENTS INCORPORATED BY REFERENCE

U.S. Prov. App. No. 63/260,267, titled “Systems and Methods for Vitrification Process Control,” filed on 13 Aug. 2021.

### Additional Documents Incorporated by Reference

U.S. Pat. No. 10,486,969 (application Ser. No. 14/294,033), titled “Balanced Closed Loop Continuous Extraction Process for Hydrogen Isotopes,” filed on 2 Jun. 2014, issued on 26 Nov. 2019.
U.S. Pat. No. 10,449,581 (application Ser. No. 15/388,299), titled “System and Method for an Electrode Seal Assembly,” filed on 22 Dec. 2016, issued on 22 Oct. 2019.
U.S. Pat. No. 10,311,989 (application Ser. No. 15/603,222), titled “System for Storage Container with Removable Shield Panels,” filed on 23 May 2017, issued on 4 Jun. 2019.
U.S. Pat. No. 10,290,384 (application Ser. No. 15/012,101), titled “Ion Specific Media Removal from Vessel for Vitrification,” filed on 1 Feb. 2016, issued on 14 May 2019.
U.S. Pat. No. 9,981,868 (application Ser. No. 14/748,535), titled “Mobile Processing System for Hazardous and Radioactive Isotope Removal,” filed on 24 Jun. 2015, issued on 29 May 2018.
U.S. Pat. No. 7,429,239 (application Ser. No. 11/796,263), titled “Methods for Melting of Materials to be Treated,” filed on 27 Apr. 2007, issued on 30 Sep. 2008.
U.S. Pat. No. 7,211,038 (application Ser. No. 10/808,929), titled “Methods for Melting of Materials to be Treated,” filed on 25 Mar. 2004, issued on 1 May 2007.
U.S. Pat. No. 6,941,878 (application Ser. No. 10/605,384), titled “Advanced Vitrification System 2,” filed on 26 Sep. 2003, issued on 13 Sep. 2005.
U.S. Pat. No. 6,558,308 (application Ser. No. 10/063,460), titled “AVS Melting Process,” filed on 25 Apr. 2002, issued on 6 May 2003.
U.S. Pat. No. 6,283,908 (application Ser. No. 09/564,774), titled “Vitrification of Waste with Continuous Filling and Sequential Melting,” filed on 4 May 2000, issued on 4 Sep. 2001.

What is claimed is:

1. A waste processing system, comprising:
a sorption vessel process area wherein sorption vessels containing spent media are accessed and the spent media is removed;
a container preparation area wherein a container is prepared for in container vitrification processes;
a feed area wherein one or more of spent media from the sorption vessel process area, recycled waste from one or more system areas, and one or more of glass frit, silica sand, and glass formers, are blended to form blended waste;
a melt area wherein blended waste is metered into a prepared container from the container preparation area as power is applied to two or more electrodes resulting in a processed container containing vitrified glass product with entrained contaminants;
a container cooling area wherein the processed container is cooled;
a container disposition area wherein the processed container is one or more of surveyed, decontaminated, sealed, shielded, and prepared for storage;
a container release area wherein the processed container is prepared for transport to storage;
an off-gas treatment system area wherein off-gases from one or more system areas is processed; and
a waste water treatment area wherein waste water from one or more system areas is processed.

2. The waste processing system of claim 1, further comprising a control room wherein the control room is operable for one or more of controlling operations in the waste processing system and monitoring operations in the waste processing system.

3. The waste processing system of claim 2, further comprising a human machine interface.

4. The waste processing system of claim 1, wherein the sorption vessel process area comprises one or more of vessel access tooling, a dry waste retrieval system, or a wet waste retrieval system.

5. The waste processing system of claim 4, wherein the vessel access tooling comprises one or more of a shearing tool or a gripper.

6. The waste processing system of claim 4, wherein the dry waste retrieval system comprises a vacuum wand with edges to aid in removal of spent media.

7. The waste processing system of claim 1, further comprising one or more sensors.

8. The waste processing system of claim 7, wherein the one or more sensors comprise one or more of contact sensors, non-contact sensors, capacitive sensors, inductive sensors, 3D imager, fiber optic cable, camera, thermal imager, thermometer, pressure sensor, accelerometer, inertial measurement unit (IMU), rotary encoder, radiation detector, LIDAR, or strain sensors.

9. The waste processing system of claim 8, wherein the fiber optic cable is placed in the prepared container with the blended waste and uses Raleigh backscatter to determine at least one of temperatures of a melt, depth of melt activity, or progress of melt activity.

10. The waste processing system of claim 1, wherein the container preparation area is operably configured to:
install one or more of a silica sand layer and a refractory base to the container;
install refractory side panels to the container;
install a starter path in the container;
install one or more of two or more electrodes, one or more thermocouples, one or more sensors, or a lid to the container; and
stage the container for the melt area.

11. A waste processing system, comprising:
a container preparation area wherein a container is prepared for in container vitrification processes;
a feed receipt and blending area wherein one or more of asbestos or recycled waste from one or more system areas, and one or more of glass frit, silica sand, or glass formers, are blended to form blended waste;
a melt area wherein blended waste is metered into a prepared container as power is applied to two or more electrodes resulting in a processed container containing vitrified glass product with entrained contaminants;
a container cooling area wherein the processed container is cooled, and wherein lid openings are sealed using one or more of a permanent disposal cover or one or more process port covers;
a container disposition area wherein the processed container is one or more of surveyed, decontaminated, shielded, or prepared for storage;
a container release area wherein the processed container is prepared for transport to storage;
an off-gas treatment system area wherein off-gases and secondary wastes from one or more system areas is processed; and
a water treatment area wherein water from one or more treatment system areas is processed.

12. The waste processing system of claim 11, wherein the blended waste includes asbestos waste and the asbestos waste is at least one of ground, milled, or shredded.

13. The waste processing system of claim 11, further comprising one or more remote manipulators for performing operations in the one or more system areas remotely.

14. The waste processing system of claim 11, further comprising a control room wherein the control room is operable for one or more of controlling operations in the waste processing system and monitoring operations in the waste processing system.

15. The waste processing system of claim 14, further comprising a human machine interface.

16. The waste processing system of claim 11, wherein the container preparation area is operably configured to:
install one or more of a silica sand layer or a cast refractory layer, resulting in a refractory lined container;
install a starter path in the refractory lined container;
install one or more of two or more electrodes, one or more thermocouples, one or more sensors, or a lid to the container; and
stage the container for the melt area.

17. The waste processing system of claim 11, further comprising one or more sensors.

18. The waste processing system of claim 17, wherein the one or more sensors comprise one or more of contact sensors, non-contact sensors, capacitive sensors, inductive sensors, 3D imager, fiber optic cable, camera, thermal imager, thermometer, pressure sensor, accelerometer, inertial measurement unit (IMU), rotary encoder, radiation detector, LIDAR, or strain sensors.

19. The waste processing system of claim 18, wherein the camera is an IR camera, and wherein the IR camera includes one or more of heat or radiation shielding.

20. The waste processing system of claim 18, wherein the fiber optic cable is placed in the prepared container with the blended waste and uses Raleigh backscatter to determine at least one of temperatures of a melt, depth of melt activity, or progress of melt activity.
